(19) United States
(12) Patent Application Publication
(10) Pub. No.: US 2016/0101303 A1
(43) Pub. Date: Apr. 14, 2016

(54) NONWOVEN MATERIAL AND DRYER WITH NONWOVEN MATERIAL

(71) Applicant: Owens Corning Intellectual Capital, LLC, Toledo, OH (US)

(72) Inventors: Anthony L. Rockwell, Pickerington, OH (US); Phillip J. Johnson, Louisville, KY (US); Jason Seward, Nashport, OH (US); Jason C. Bragg, Newark, OH (US); Paula Miller, Mt. Washington, KY (US); Jeffrey A. Tilton, Powell, OH (US); William Kunkler, Heath, OH (US)

(21) Appl. No.: 14/970,630

(22) Filed: Dec. 16, 2015

Related U.S. Application Data
(62) Division of application No. 13/902,928, filed on May 27, 2013.
Application No. 13/902,928 is a continuation-in-part of application No. 13/850,511, filed on Mar. 26, 2013.
Application No. 13/850,511 is a division of application No. 13/684,281, filed on Nov. 23, 2012.
(60) Provisional application No. 61/562,713, filed on Nov. 22, 2011.

(51) Int. Cl. A62C 2/06; D06F 58/20

(52) U.S. Cl. CPC A62C 2/065; D06F 58/20

(57) ABSTRACT

A non-woven fabric includes flame retardant fibers and binding material mixed with the flame retardant fibers. The binding material sets a thickness of the fabric. Application of a flame to the fabric causes the binding material to degrade and the flame retardant fibers to expand to prevent a flame from passing through a hole in a wall of an appliance, a building, or an appliance and/or to protect wiring of an appliance, a building, or an appliance.

### RELATED APPLICATIONS

The present application is a continuation-in-part of U.S. Ser. No. 13/850,511, filed Mar. 26, 2013, titled “Nonwoven Material and Dryer with Nonwoven Material”, which is a divisional application of U.S. Ser. No. 13/684,281, filed Nov. 23, 2012, titled “Nonwoven Material and Dryer with Nonwoven Material” and claims the benefit of U.S. Provisional Patent Application Ser. No. 61/562,713, filed Nov. 22, 2012, titled “Dryer”, the entire disclosures of which are incorporated herein by reference in their entirety.

### BACKGROUND

Nonwoven fabric is a fabric-like material made from long fibers, bonded together by chemical, mechanical, heat or solvent treatment. The term is used in the textile industry to denote fabrics, such as felt, which are neither weaved nor knitted. Nonwoven fabrics are broadly defined as sheet or web structures bonded together by entangling fiber or filaments mechanically, thermally or chemically. Nonwoven fabrics are typically flat, porous sheets that are made directly from separate fibers.

Oxidized polyacrylonitrile fibers are used in fire and heat resistant applications. Zoltek advertises that its PYRON® oxidized polyacrylonitrile fibers do not melt, burn or drip when exposed to a 1250° C. flame test for 30 seconds.

Clothes dryers for drying clothes include a horizontal drum that is rotatably mounted in a cabinet. The clothes dryers introduce heated air into the drum for circulation and removal of moisture from the clothes. The clothes dryers are generally constructed utilizing front and rear bulkheads for mounting the drum for rotation and for supporting certain related parts of the dryer. The bulkheads are enclosed by a cabinet fabricated to a rectangular configuration. Heated air utilized in drying is inspired into the drum through one of the bulkheads and is exhausted through one of the bulkheads. For example, heated air may enter the drum through the rear bulkhead and exit through the front bulkhead. Moisture laden air from the drum is discharged into duct work that usually exits at the rear of the dryer. Seals are typically provided between the rotating drum and the front bulkhead and between the rotating drum and the rear bulkhead.

Underwriters Laboratories, Inc. (UL) is an independent product safety certification organization. UL develops standards and test procedures for a variety of different products, including clothes dryers, such as residential electric clothes dryers. UL's standard that applies to residential electric clothes dryers is UL 2158. UL 2158 has recently been revised. All new clothes dryers will have to successfully pass new UL standard 2158 by Mar. 20, 2013. UL's standard that applies to flame ratings for plastic materials is UL 94.

### SUMMARY

The present application discloses, among other inventive concepts, a non-woven fabric. In one exemplary embodiment, the non-woven fabric includes flame retardant fibers and binding material mixed with the flame retardant fibers. The binding material sets a thickness of the fabric. Application of a flame to the fabric causes the binding material to degrade and the flame retardant fibers to expand to prevent a flame from passing through a hole in a wall of an appliance, a building, or an appliance and/or to protect wiring of an appliance, a building, or an appliance.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to provide examples of the principles of this invention.

FIG. 1 is a front perspective view of a clothes dryer;

FIG. 2A is an exploded perspective view of the clothes dryer of FIG. 1;

FIG. 2B is a rear perspective view of a clothes dryer;

FIG. 3A is a schematic illustration of an exemplary embodiment of a clothes dryer;

FIG. 3B is a schematic illustration of an exemplary embodiment of a clothes dryer;

FIG. 3C is a schematic illustration of an exemplary embodiment of a clothes dryer;

FIG. 3D is a schematic illustration of an exemplary embodiment of a clothes dryer;

FIG. 3E is a schematic illustration of an exemplary embodiment of a clothes dryer;

FIG. 3F is a schematic illustration of an exemplary embodiment of a clothes dryer;

FIG. 3G is a schematic illustration of an exemplary embodiment of a clothes dryer;

FIG. 3H is a schematic illustration of an exemplary embodiment of a clothes dryer;

FIG. 4 is a schematic illustration of an exemplary embodiment of a clothes dryer with a source of heat contained within a drum of the dryer;

FIG. 4A is a schematic illustration of the clothes dryer illustrated by FIG. 4 where a front bulkhead seal has been compromised by the source of heat and the dryer includes front and rear rollers that support the drum;

FIG. 5 is a schematic illustration of the dryer shown in FIG. 4 illustrating a front bulkhead seal that is compromised by the source of heat contained within the drum of the dryer;

FIG. 5A is a schematic illustration of an embodiment of a dryer similar to the embodiment of FIG. 5 where the dryer has an expandable rear seal;

FIG. 6 is a schematic illustration similar to FIG. 4 showing an exemplary embodiment of a clothes dryer with a rear seal inside the drum and a source of heat contained within a drum of the dryer;

FIG. 6A is a schematic illustration similar to FIG. 6 illustrating that the clothes dryers disclosed by this application may include front and/or back drum support rollers;

FIG. 7 is a schematic illustration of the dryer shown in FIG. 6 illustrating a front bulkhead seal that is compromised by the source of heat contained within the drum of the dryer;

FIG. 7A is a schematic illustration of an embodiment of a dryer similar to the embodiment of FIG. 7 where the dryer has an expandable rear seal;

FIG. 7B is a schematic illustration similar to FIG. 7, where the dryer has the seal configuration of FIG. 3E;

FIG. 8 is a schematic illustration similar to FIG. 6 except a plastic liner or ring is positioned inside of the drum, between the drum and the front seal member;

FIG. 9 is a schematic illustration of the dryer shown in FIG. 8 illustrating the plastic liner or ring that is compromised by the source of heat contained within the drum of the dryer;

FIG. 9A is a schematic illustration of an embodiment of a dryer similar to the embodiment of FIG. 9 where the dryer has expandable seals;

FIG. 10 is a schematic illustration similar to FIG. 8, except the front seal member includes a flange or tab that extends into a space between the plastic ring and the front bulkhead;

FIG. 11 is a schematic illustration similar to FIG. 8 except the rear seal member includes a flange or tab that extends into a space between the rear bulkhead and the drum;

FIG. 12 is a schematic illustration of the dryer shown in FIG. 11 illustrating the plastic liner or ring that is compromised by the source of heat contained within the drum of the dryer;

FIG. 13 is a schematic illustration of a dryer that is similar to the dryer illustrated by FIG. 8, except the front seal member is at least partially made from an expandable material;

FIG. 14 is a schematic illustration of the dryer shown in FIG. 13 illustrating the plastic liner or ring that is compromised by the source of heat and the front seal member expanded;

FIG. 15 is a schematic illustration similar to FIG. 13, except the front seal member includes a flange or tab that extends into a space between the plastic ring and the front bulkhead;

FIG. 16 is a schematic illustration of the dryer shown in FIG. 15 illustrating the plastic liner or ring that is compromised by the source of heat and the front seal member expanded;

FIG. 17A is a cross-sectional view of an exemplary embodiment of a seal member with a rigid reinforcement and an outer portion;

FIG. 17B is a cross-sectional view similar to FIG. 17A where an outer sealing portion of the seal member has deteriorated or been removed;

FIG. 18A is a cross-sectional view of an exemplary embodiment of a seal member with a spring or spring-like reinforcement and an outer portion;

FIG. 18B is a cross-sectional view similar to FIG. 18A where an outer sealing portion of the seal member has deteriorated or been removed;

FIG. 19A is a cross-sectional view of an exemplary embodiment of a seal member with at least one expandable portion and at least one consumable portion;

FIG. 19B is a cross-sectional view similar to FIG. 19A where the consumable portion of the seal member has deteriorated or been removed and the expandable portion has expanded;

FIG. 20A is a sectional view of an annular seal member in an uninstalled condition;

FIG. 20B is a sectional view of the annular seal member illustrated by FIG. 20 installed on a drum of a dryer;

FIG. 21 is a sectional view of an annular seal member installed on a drum of a dryer;

FIG. 21A is a sectional view of and annular seal member that is similar to the annular seal member illustrated by FIG. 21 that includes a flange or tab that extends into a space between the end of the drum and a bulkhead;

FIG. 22A is a front elevational view of an annular seal member;

FIG. 22B is a side view of the annular seal member illustrated by FIG. 22A;

FIG. 22C is a sectional view of the annular seal member illustrated by FIG. 22A installed between a drum and a bulkhead;

FIG. 23A is a front elevational view of an annular seal member;

FIG. 23B is a side view of the annular seal member illustrated by FIG. 23A;

FIG. 23C is a sectional view taken along the plane indicated by lines 23C-23C in FIG. 23A;

FIG. 23D is a sectional view of the annular seal member illustrated by FIG. 23A installed between a drum and a bulkhead;

FIG. 24A is a front elevational view of an annular seal member;

FIG. 24B is a side view of the annular seal member illustrated by FIG. 24A;

FIG. 24C is a sectional view taken along the plane indicated by lines 24C-24C in FIG. 24A;

FIG. 24D is a sectional view of the annular seal member illustrated by FIG. 24A installed between a drum and a bulkhead;

FIG. 25A is a front elevational view of an annular seal member;

FIG. 25B is a side view of the annular seal member illustrated by FIG. 25A;

FIG. 25C is a sectional view taken along the plane indicated by lines 25C-25C in FIG. 25A;

FIG. 25D is a sectional view of the annular seal member illustrated by FIG. 25A installed between a drum and a bulkhead;

FIG. 26A is a front elevational view of an annular seal member;

FIG. 26B is a side view of the annular seal member illustrated by FIG. 26A;

FIG. 26C is a sectional view taken along the plane indicated by lines 26C-26C in FIG. 26A;

FIG. 26D is a sectional view taken along the plane indicated by lines 26D-26D in FIG. 26A;

FIG. 27A is a front elevational view of an annular seal member;

FIG. 27B is a side view of the annular seal member illustrated by FIG. 27A;

FIG. 27C is a sectional view taken along the plane indicated by lines 27C-27C in FIG. 27A;

FIG. 27D is a sectional view taken along the plane indicated by lines 27D-27D in FIG. 27A;

FIG. 28 is a schematic illustration of an exemplary embodiment of a clothes dryer with a source of heat contained within a drum of the dryer;

FIG. 29 is a schematic illustration of the dryer FIG. 28 with one or more seals that vent when a pressure and/or a temperature inside the dryer rises;

FIG. 30A is a schematic illustration of a material that vents when the material is heated, before the material is heated;

FIG. 30B is a schematic illustration of the illustrated by FIG. 30A after the material is heated;

FIG. 31 is a schematic illustration of the dryer FIG. 28 with one or more vent devices that vent when a pressure and/or a temperature inside the dryer rises;

FIG. 32 is a schematic illustration of an exemplary embodiment of a dryer that includes wiring and electrical components;

FIG. 33 is a schematic illustration of an exemplary embodiment of a dryer that is similar to the dryer illustrated by FIG. 32, except the dryer includes heat shield components that isolate the wiring and the electrical components from the source of heat;

FIG. 34A is a rear perspective view of an exemplary embodiment of a dryer that includes one or more heat shields;

FIG. 34B is a rear perspective view of an exemplary embodiment of a dryer that includes one or more heat shields;

FIG. 34C is a rear perspective view of an exemplary embodiment of a dryer that includes one or more heat shields;

FIG. 34D is a rear perspective view of an exemplary embodiment of a dryer that includes one or more heat shields;

FIG. 34E is a sectional view taken along the plane indicated by lines 34E-34E in FIG. 1;

FIG. 35 is an exploded perspective illustration of an exemplary embodiment of a door assembly for a dryer;

FIG. 35A is a sectional view of the door assembly illustrated by FIG. 35 when assembled;

FIG. 35B is a sectional view taken along the plane indicated by lines 8B-8B in FIG. 35A;

FIG. 36A is an embodiment similar to the embodiment of FIG. 35B where the insulator is an expandable member;

FIG. 36B illustrates the expandable member shown in FIG. 36A, prior to being expanded;

FIG. 37A is an embodiment similar to the embodiment of FIG. 36A showing another configuration of an expandable member;

FIG. 37B illustrates the expandable member shown in FIG. 37A, prior to being expanded;

FIG. 38A illustrates an exemplary embodiment of a mixture of flame retardant fibers and binding fibers having an uncompressed or initial thickness;

FIG. 38B illustrates an exemplary embodiment of a non-woven fabric formed by compressing the mixture of fibers illustrated by FIG. 38A and setting the binding fibers;

FIG. 38C illustrates the non-woven fabric of FIG. 38A in an expanded condition due to degradation of the binding fibers;

FIG. 39 is a schematic illustration of the fabric illustrated by FIG. 38B illustrating that the fabric has a high airflow resistance when the fabric is at an unexpanded or set thickness;

FIG. 40A schematically illustrates the application of a flame to the fabric illustrated by FIG. 38B;

FIG. 40B schematically illustrates degradation of binding fibers due to the application of the flame;

FIG. 40C schematically illustrates that the degradation of the binding fibers causes the fabric to expand and reduce the airflow resistance of the fabric;

FIG. 41A illustrates an exemplary embodiment of a mixture of flame retardant fibers and binding material having an uncompressed thickness;

FIG. 41B illustrates an exemplary embodiment of a non-woven fabric formed by compressing the mixture of fibers illustrated by FIG. 41A and setting the binding material;

FIG. 41C illustrates the non-woven fabric of FIG. 41A in an expanded condition due to degradation of the binding material;

FIG. 42 is a schematic illustration of the fabric illustrated by FIG. 41B illustrating that the fabric that has a high airflow resistance when the fabric is at an unexpanded or initial thickness;

FIG. 43A schematically illustrates the application of a flame to the fabric illustrated by FIG. 41B;

FIG. 43B schematically illustrates degradation of binding material due to the application of the flame;

FIG. 43C schematically illustrates that the degradation of the binding material causes the fabric to expand and reduce the airflow resistance of the material;

FIG. 44 schematically illustrates an exemplary embodiment of flame retardant fibers and loose stitches through the flame retardant fibers such that the flame retardant fibers have an uncompressed thickness;

FIG. 45 illustrates an exemplary embodiment of a non-woven fabric formed by compressing the flame retardant fibers by tightening the stitches schematically illustrated by FIG. 44 to set the thickness of the fabric;

FIG. 46A schematically illustrates the application of a flame to the fabric illustrated by FIG. 44;

FIG. 46B schematically illustrates degradation of stitches due to the application of the flame;

FIG. 46C schematically illustrates that the degradation of the stitches causes the fabric to expand and reduce the airflow resistance of the fabric;

FIG. 47 is a flowchart that illustrates an exemplary embodiment of a method of making a non-woven fiber;

FIG. 48 schematically illustrates depositing a mixture of flame retardant fibers and binding fibers onto a support structure;

FIG. 49 schematically illustrates applying heat to the mixture of flame retardant fibers and binding fibers shown in FIG. 48;

FIG. 50 schematically illustrates heating and compressing the mixture of flame retardant fibers and binding fibers shown in FIG. 48;

FIG. 51 is a schematic illustration of wiring extending through a wall of two adjacent apartments, buildings, or rooms;

FIG. 51A is a schematic illustration of a conduit extending through a wall of two adjacent apartments, buildings, or rooms;

FIG. 52 is a view similar to the view illustrated by FIG. 51 illustrating the wiring wrapped or sleeved with an expanding flame resistant material;

FIG. 52A is a view similar to the view illustrated by FIG. 51A illustrating the conduit wrapped or sleeved with an expanding flame resistant material;

FIG. 53 is a view similar to the view illustrated by FIG. 52 illustrating a flame on one side of the wall;

FIG. 53A is a view similar to the view illustrated by FIG. 52 illustrating a flame on one side of the wall;

FIG. 54 is a view similar to the view illustrated by FIG. 53 illustrating the expanding flame resistant material in an expanded state;

FIG. 54A is a view similar to the view illustrated by FIG. 53 illustrating the expanding flame resistant material in an expanded state;

FIG. 55 is a view similar to the view illustrated by FIG. 51 illustrating heat shields disposed around the wiring;

FIG. 56 is a view taken along the plane indicated by lines 56-56 in FIG. 55;

FIG. 57 is a view similar to the view illustrated by FIG. 55 illustrating a flame on one side of the wall;

FIGS. 58A and 58B are enlarged views taken along the plane indicated by arrows 58-58 in FIG. 57 illustrating the effect of the flame on the heat shield;

FIG. 58C illustrates another exemplary embodiment of a heat shield;

FIG. 59 is a perspective view of an electrical box;

FIG. 60 illustrates an exemplary embodiment of an expanding flame resistant material being installed in an electrical box;

FIG. 61 illustrates an expanding flame resistant material installed in an electrical box;

FIG. 62 schematically illustrates an exemplary embodiment of flame retardant fibers disposed between layers of encapsulating material such that the flame retardant fibers have an uncompressed thickness;

FIG. 63 illustrates an exemplary embodiment of a non-woven fabric formed by compressing the flame retardant fibers by compressing the flame retardant fibers with the encapsulating material schematically illustrated by FIG. 44 to set the thickness of the fabric;

FIG. 64A schematically illustrates the application of a flame to the fabric illustrated by FIG. 63;

FIG. 64B schematically illustrates degradation of encapsulating material due to the application of the flame; and

FIG. 64C schematically illustrates that the degradation of the encapsulating material causes the fabric to expand and reduce the airflow resistance of the fabric.

### DETAILED DESCRIPTION

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members or elements.

In this specification, any reference to UL 2158 means the revised version of UL 2158, which all new clothes dryers will have to successfully pass by Mar. 20, 2013. UL 2158 includes a variety of different safety tests for electric dryers. For example, UL 2158 includes aggressive fire tests that all clothes dryers will have to pass by Mar. 20, 2013. For example, clause 19.6 includes “Load Fire Containment” tests. The “Load Fire Containment” tests include a static load fire test and a dynamic load fire test. In each of these tests, a load that represents a load of laundry is placed into the drum of a dryer and is ignited. This load that is ignited is referred to in this application as a “source of heat 500”. In the static load fire test, the dryer is energized, but not tumbling during the test. In the dynamic load fire test, the dryer is energized, heating and tumbling during the test. In each of the static and dynamic load fire tests, the temperature inside the dryer drum 17 will be elevated well above temperatures ever seen inside the drum during normal operation of the dryer. In this application, the terms “high temperature” and “elevated temperature” mean the temperature inside the drum of a dryer during UL 2158 static and dynamic load fire tests of the dryer. For example, the high temperature or elevated temperature may be 600 degrees F. to 1000 degrees F., such as 600 degrees F. to 800 degrees F., 650 degrees F. to 800 degrees F., 700 degrees F. to 800 degrees F., 750 degrees F. to 850 degrees F., 775 degrees F. to 825 degrees F., or approximately 800 degrees F. The high or elevated temperature may be higher or lower depending on the machine being tested. For example, larger capacity dryers may be provided with a larger test load that is ignited. In these cases, the temperatures observed during the test may be as high as 1000 degrees F.

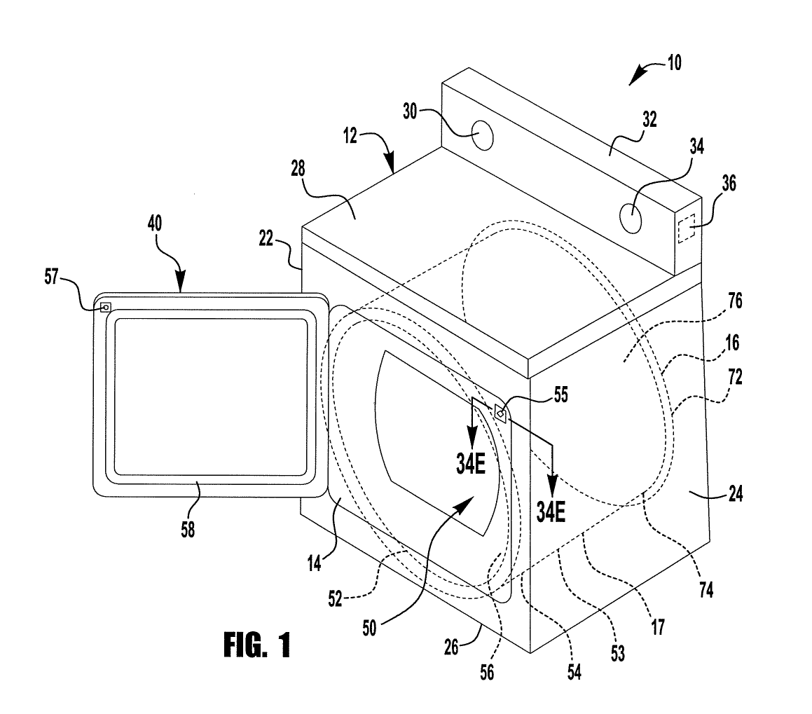

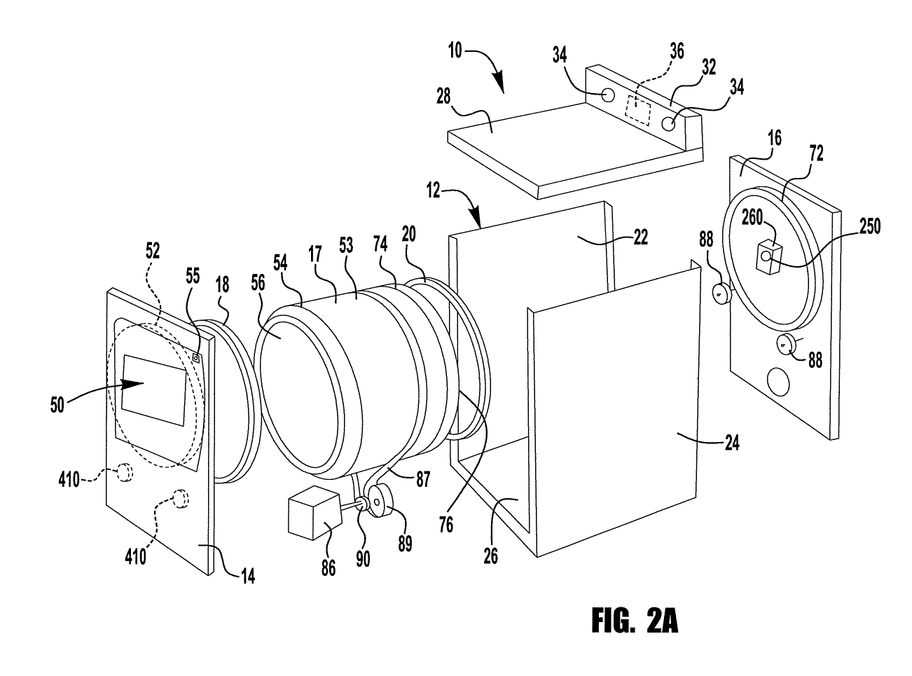

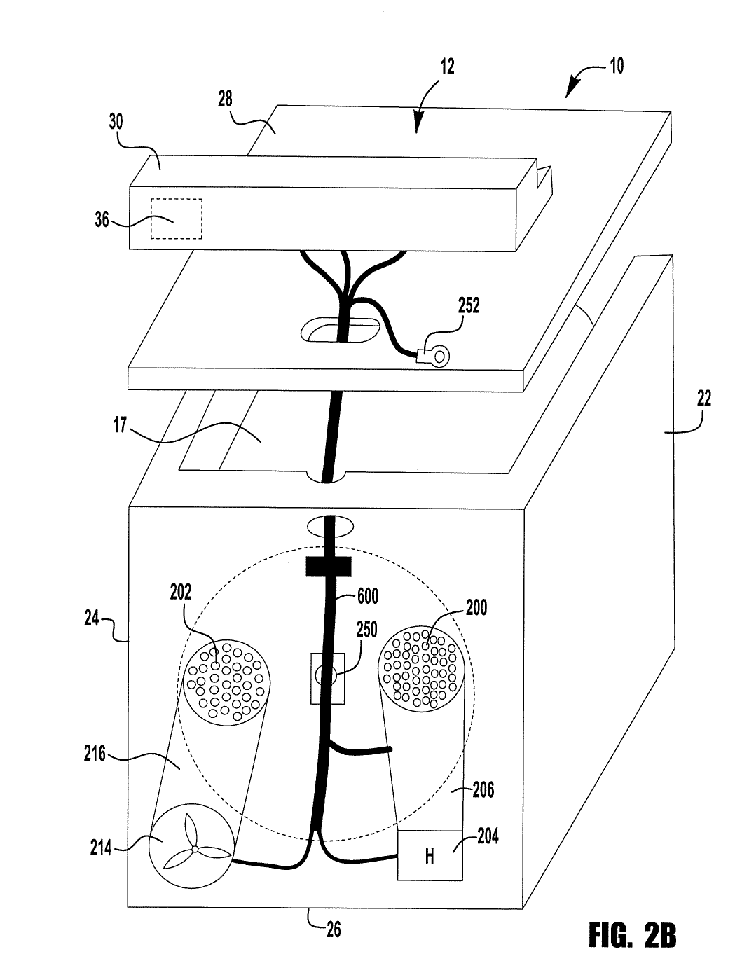

FIGS. 1, 2A, and 2B illustrate an example of an exemplary embodiment of a clothes dryer 10. The clothes dryer 10 can have a wide variety of different configurations. In the example illustrated by FIGS. 1, 2A, and 2B, the clothes dryer 10 includes a cabinet 12, a front bulkhead 14, a rear bulkhead 16, a drum 17, a front seal member 18, and a rear seal member 20. The cabinet 12 can take a wide variety of different forms. In the illustrated embodiment, the cabinet 12 includes a pair of side walls 22, 24, an optional bottom or floor 26 (FIG. 2A), and a top panel 28. The illustrated top panel 28 has a control panel or console 30 along an elevated rear portion 32 of the top panel 28. The control panel or console 30 may be integral with or formed separately from the top panel 28. The control panel or console 30 includes a plurality of controls 34 that operate an electronic control unit 36 to select an automatic series of drying steps. The electronic control unit 36 may be housed in the elevated rear portion 32 of the top panel. However, the electronic control unit 36 may be disposed at any location in the cabinet 12 and may comprise a single or multiple electronic control devices.

The front bulkhead 14 may take a wide variety of different forms. In the exemplary embodiment illustrated by FIGS. 1 and 2, the front bulkhead 14 is mounted to the front of the cabinet 12. The illustrated front bulkhead 14 includes an access opening 50 and a front drum mounting surface 52. The access opening 50 allows clothes to be placed in and removed from the drum 17. Referring to FIGS. 1 and 2A, a first door latch component 55 is mounted to the front bulkhead 14 adjacent to the access opening 50.

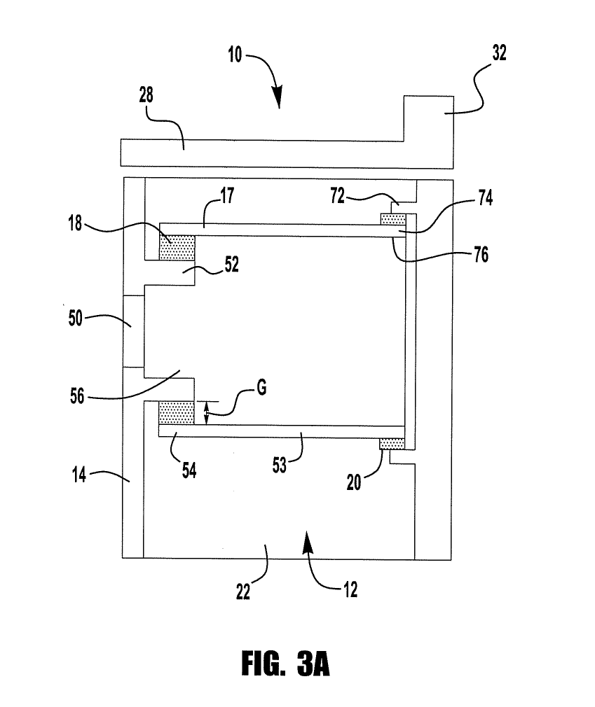

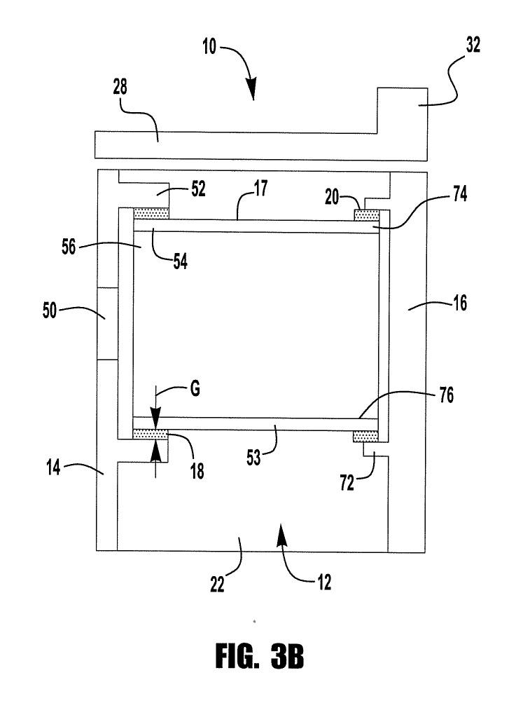

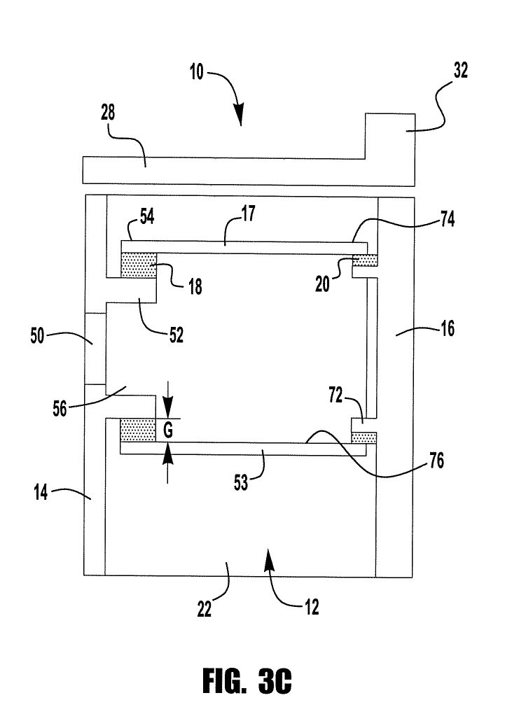

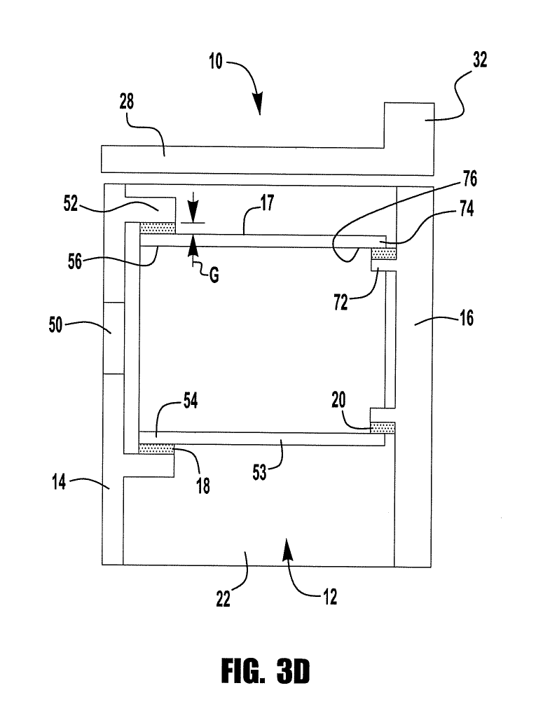

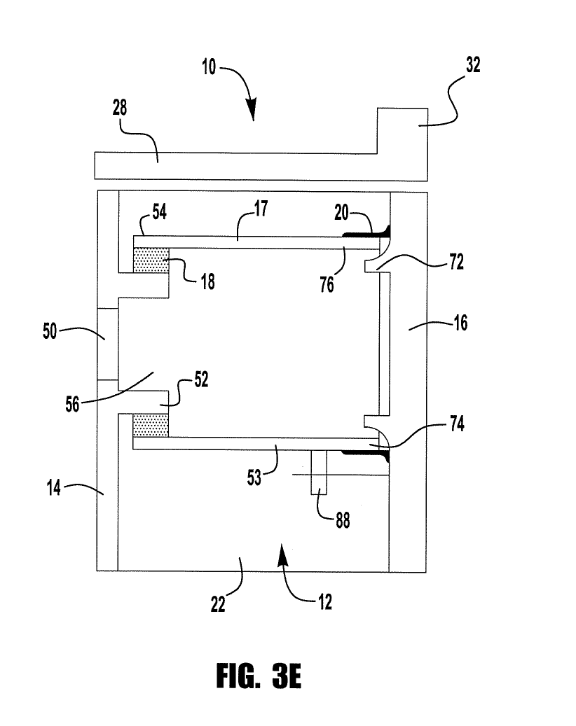

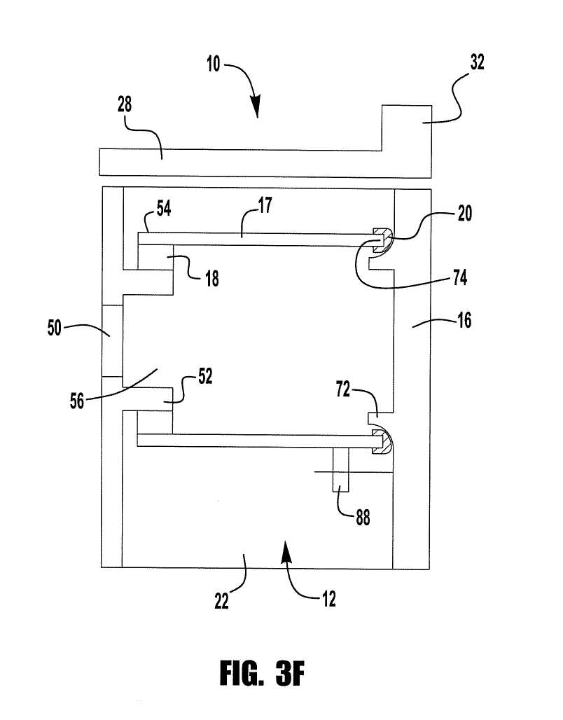

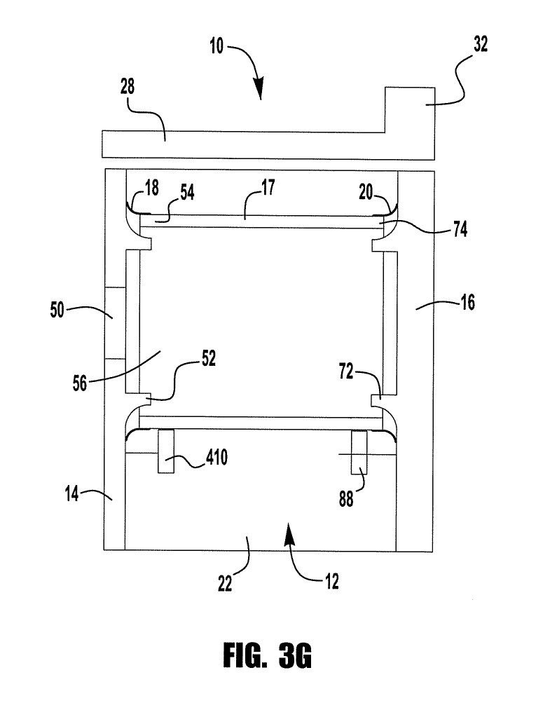

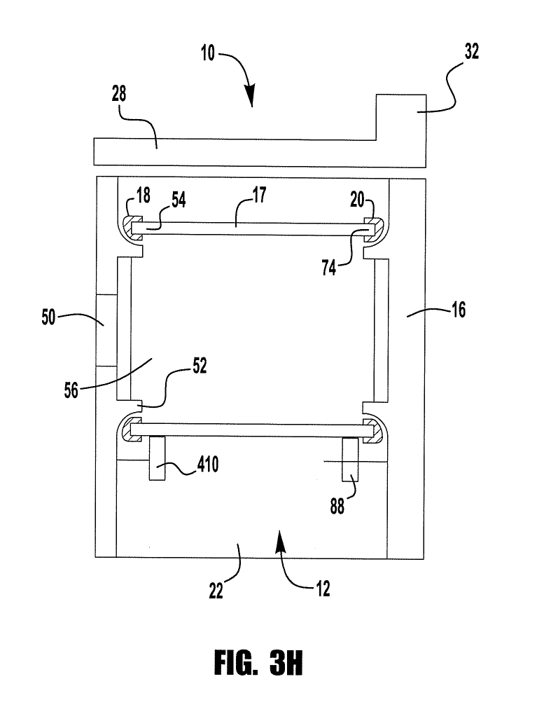

The front drum mounting surface 52 may take a wide variety of different forms. For example, the front drum mounting surface 52 may be a continuous or segmented annular surface that fits around a front end 54 of the drum 17 or within a front opening 56 of the drum. In the examples illustrated by FIGS. 3A and 3C, the front drum mounting surface 52 fits within the front opening 56 of the drum 17. In the examples illustrated by FIGS. 3B and 3D, the drum mounting surface 52 fits around the front end 54 of the drum. In other embodiments, the drum mounting surface 52 includes both a portion that fits within the front opening 56 of the drum 17 and a portion that fits around the front end 54 of the drum. The front drum mounting surface 52 may be any surface or surfaces that allows the drum 17 to be rotatably mounted to the front bulkhead 14. In the examples illustrated by FIGS. 3E and 3H, the drum mounting surface 52 fits within the front end 54 of the drum and the front end of the drum 17 is supported by one or more rollers 410. As such, the mounting surface 52 need not support the drum in the FIGS. 3G and 3H embodiments.

The front bulkhead 14 may include an inlet opening or vent and/or an outlet opening or vent. The inlet opening or vent provides heated air into the drum 17. The outlet opening or vent allows moisture laden air to be removed from the drum. In another embodiment, the front bulkhead does not include an inlet opening or vent or an outlet opening or vent, since they may both be provided at other locations, such as in the rear bulkhead. The inlet opening or vent and the outlet opening or vent are not illustrated, as they are well known in the art and can take a wide variety of different configurations and can be provided at a wide variety of different locations in the dryer. Any arrangement that allows air to flow into and out of the drum 17 can be used as the inlet opening or vent and the outlet opening or vent.

The rear bulkhead 16 may take a wide variety of different forms. In the exemplary embodiment illustrated by FIGS. 1 and 2, the rear bulkhead 16 is mounted to the rear of the cabinet 12. The illustrated rear bulkhead 16 includes a rear drum mounting surface 72. The rear drum mounting surface 72 may take a wide variety of different forms. For example, the rear drum mounting surface 72 may be a continuous or segmented annular surface that fits around a rear end 74 of the drum 17 or within a rear opening 76 of the drum. In the examples illustrated by FIGS. 3A and 3B, the rear drum mounting surface 72 fits around the rear end 74 of the drum 17. In the examples illustrated by FIGS. 3C and 3D, the drum mounting surface 72 fits within the rear opening 56 of the drum 17. In other embodiments, the drum mounting surface 72 includes both a portion that fits within the rear opening 76 of the drum 17 and a portion that fits around the rear end 74 of the drum. The rear drum mounting surface 72 may be any surface or surfaces that allows the drum 17 to be rotatably mounted to the rear bulkhead 14. In the examples illustrated by FIGS. 3E, 3F, 3G, and 3H, the drum mounting surface 72 fits within the rear end 74 of the drum and the rear end of the drum 17 is supported by one or more rollers 88. As such, the mounting surface 72 need not support the drum in the FIGS. 3E, 3F, 3G, and 3H embodiments.

Referring to FIG. 2B, the rear bulkhead 14 may include an inlet opening or vent 200 and/or an outlet opening or vent 202. The inlet opening or vent 200 is connected to a heater 204 by a duct 206. The heater 204 provides heated air through the duct 206 and vent 200 into the drum 17. The outlet opening or vent 202 is connected to a blower 214 by a duct 216. The blower 214 draws heated air from the heater 204 into the drum 17, out the duct 216, and out the blower 214 to an exhaust duct (not shown). As such, the blower 214 draws heated air into the drum 17 and exhausts moisture laden air to be removed from the drum 17. In another embodiment, the rear bulkhead does not include an inlet opening or vent or an outlet opening or vent, since they may both be provided at other locations, such as in the front bulkhead.

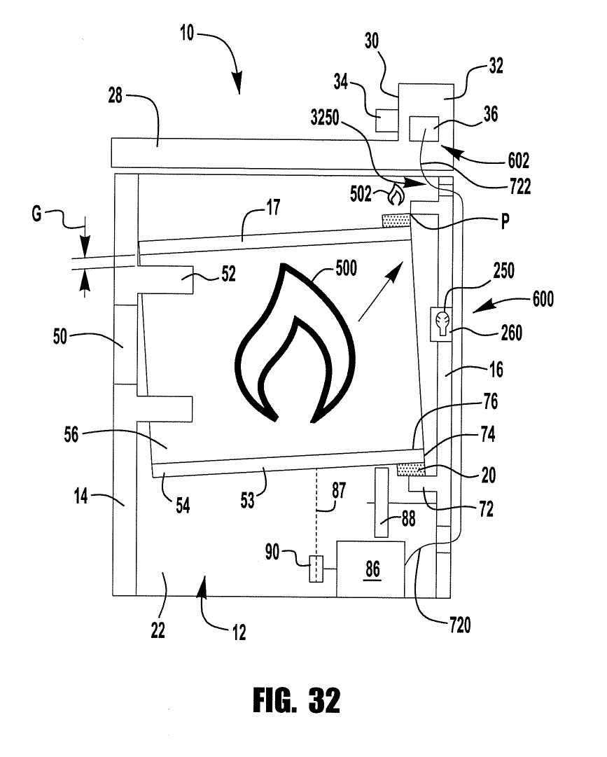

FIG. 2B is a back perspective view of the dryer that shows wiring 600 of the dryer 10. The wiring 600 can take a wide variety of different forms and can be routed in a variety of different ways. In the illustrated embodiment, the wiring 600 is connected to the control unit 36, the heater 204, the blower 214, a light 250 that provides light inside the drum 17, and the cabinet 12 to provide a ground path 252. In the illustrated embodiment, the wiring is routed along the back of the rear bulkhead 16 between the ducts 206, 216. The illustrated wiring 600 is routed from the heater 204 and blower 214, to the light 250, to the top of the rear bulkhead, through the rear bulkhead at the top of the rear bulkhead, through top panel 28 at the rear of the top panel, and to the control panel 30. Referring to FIG. 32, the wiring 600 is disposed in the cabinet 12 above the top, rear portion of the drum 17 (in the area identified by reference character 3250) where the wiring extends from the rear bulkhead 16 to the top panel 18.

The drum 17 can take a wide variety of different forms. The illustrated drum 17 has a generally cylindrical wall 53 with a front end 54 having a front opening 56 and a rear end 74 with a rear opening 76. The drum 17 is rotatably mounted between the front bulkhead 14 and the rear bulkhead 16. In the illustrated embodiments, the drum is horizontally oriented. The drum may be disposed in other orientations in other exemplary embodiments. Referring to FIG. 2A, an electric motor 86 is coupled to a belt 87. A drive pulley 90 is connected to an output shaft of the electric motor 86. A spring loaded idler pulley 89 may be provided to keep the belt 87 in tight engagement with the outer surface of the drum 17 and the drive pulley 90. The electric motor 86 drives the belt 87 to rotate the drum 22. A plurality of rollers 88 that are supported by the rear bulkhead 16 are optionally disposed beneath the drum 17 to provide additional support to the rear end 74 of the drum 17. A plurality of rollers 410 that are supported by the front bulkhead 14 are optionally disposed beneath the drum 17 to provide additional support to the front end 74 of the drum 17. A drum 17 with a full load of wet laundry, such as jeans and towels will have considerable weight. As such, the drum 17, front and rear bulkheads 14, 16, and optional rollers 88, 410 must be configured to support a full load of wet laundry, while allowing the drum to rotate smoothly.

The front seal member 18 can take a wide variety of different forms. Referring to the schematically illustrated examples of FIGS. 3A-3D, the front seal member 18 is positioned between the front end 54 of the drum 17 and the front drum mounting surface 52 to define a sealed radial gap G between the front end 54 of the drum and the front drum mounting surface 52. In the examples illustrated by FIGS. 3A and 3C, the front seal member 18 is disposed around the front drum mounting surface 52 and is disposed inside the inner surface of the front opening 56 of the drum 17. In the examples illustrated by FIGS. 3B and 3D, the front seal member 18 is disposed around the front end 54 of the drum and is disposed inside the drum mounting surface 52. In any of the examples illustrated by FIGS. 3A-3D, the front seal member 18 can be attached to the drum 17 or the front drum mounting surface 52.

Referring to the schematically illustrated examples of FIGS. 3G and 3H, the front seal member 18 is positioned around the front end 54 of the drum 17, which is disposed around the front drum mounting surface 52. The front end 54 of the drum is supported by one or more rollers 410. In the embodiment of FIG. 3G, the front seal member 18 extends forward of the drum 17 and engages the front bulkhead 14 to form a seal between the front bulkhead and the drum. In the embodiment of FIG. 3H, the front seal member 18 wraps around a front edge of the drum 17 and engages the front bulkhead 14 to form a seal between the front bulkhead and the drum. In the example illustrated by FIG. 3G, the front seal member 18 can be attached to the drum 17 or the front bulkhead 14. In the example illustrated by FIG. 3H, the front seal member 18 is attached to the drum 17.

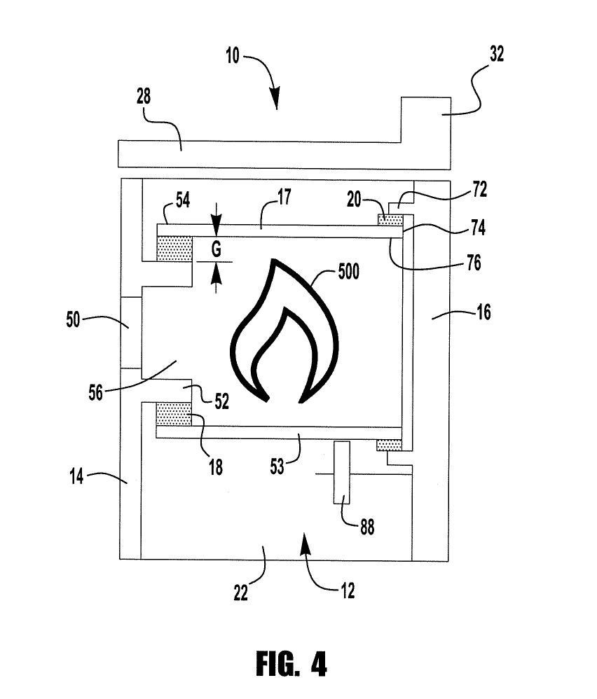

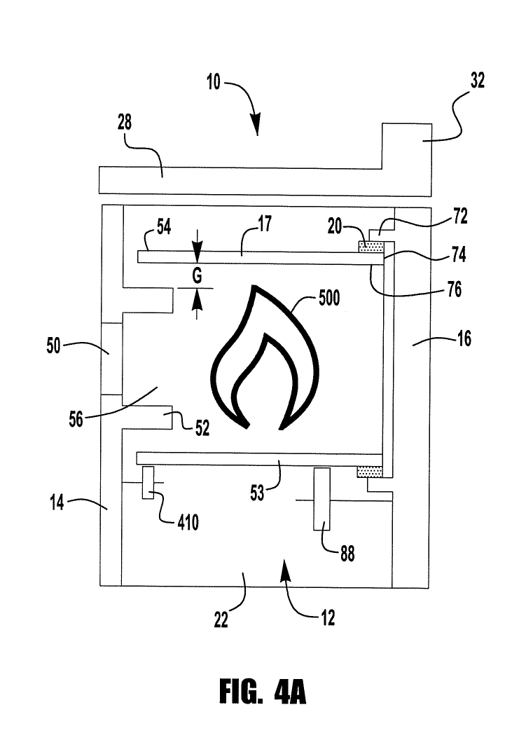

The front seal member 18 can be made from a wide variety of different materials and can have a wide variety of different configurations. In the illustrated embodiment, the front seal member 18 is an annular ring. Referring to FIG. 4, in one exemplary embodiment, the front seal member 18 substantially maintains the size of the radial gap G when exposed to high temperatures. In one exemplary embodiment, the front seal member 18 substantially maintains the size of the radial gap G through UL 2158 static and/or dynamic load fire tests of the dryer. For example, the front seal member 18 may be configured such that the radial gap G decreases by less than 50%, less than 40%, less than 30%, less than 25%, less than 20%, less than 10%, or less than 5% when exposed to high temperatures and/or through UL 2158 static and/or dynamic load fire tests of the dryer. The front seal member 18 may be made from a flame resistant material that maintains its structural integrity and/or that prevents a flame from penetrating the material when exposed to high temperatures and/or through UL 2158 static and/or dynamic load fire tests of the dryer. Examples of suitable materials capable of maintaining the radial gap G when exposed to high temperatures and/or through UL 2158 static and/or dynamic load fire tests of the dryer include, but are not limited to, fire retardant materials, such as fire retardant nylon, melamine fibers, PAN fibers, any of the fibers listed in Table 1 below, blends of PAN fibers and other materials, such as polyester, nylon, bi-component fibers, PET, PET blends, Rayon, any of the materials listed in Table 2 below, and the like, fiberglass, blends of fiberglass and other materials, such as polyester, nylon, bi-component fibers, PET, PET blends, Rayon, any of the materials listed in Table 2 below, and the like, flame resistant cotton shoddy, intamescent material (or other material that swells or expands when heated), blends of intamescent material and other materials, such as polyester, nylon, bi-component fibers, PET, PET blends, Rayon, any of the materials listed in Table 2 below, and the like, and any combination or subcombination of these materials. The PAN fibers and materials referred to herein may be traditional polyacrylonitrile (PAN) fibers or materials. The PAN fibers or materials referred to herein may have a high LOI (Limiting Oxygen Index) LOI. The PAN fibers or materials referred to herein may be oxidized and/or thermally stabilized, so that the PAN fiber or material will not burn. An example of a PAN fiber that is oxidized, thermally stabilized and has a high LOI is PANOX® available from the SGL Group. Any material capable of substantially maintaining the radial gap G when exposed to high temperatures and/or through UL 2158 static and/or dynamic load fire tests can be used.

In one exemplary embodiment, the front seal member 18 is made from or partially made from a material that comprises fibers of at least one of the types listed in Table 1 and at least one sacrificial fiber, material, which may be a powder, resin, or aqueous solution, and/or mechanical fastening technique listed in Table 2. That is, the seal member material or a portion of the seal member material may be made from any combination of one or more of the materials or material types listed in Table 1 with one or more of the materials or material types listed in Table 2.

TABLE 1
Fire Resistant Fibers

FR (Fire Resistant) Viscose
Melamine
Meta-aramids
Modacrylic
Novoloid
Polyimide
RP-46 polyimide resin system
PBO (poly-para-phenylene benzobisoxazole)
PPS (poly-phenyiene sulfide)
Para-aramids
PAI (aromatic polyamideimide)
PAN (polyacrylonitrile)
Oxidixed or Partially Oxidized PAN, including, but not limited to PANOX
and fibers similar to PANOX
PFTE (poly-tertrafluoroethylene)
Ceramic
Zirconia Ceramic
Rockwool
Mineral wool (glass)
Mineral wool (stone)
Glass fiber (all chemical compositions)
Carbon
Silicon carbide
Calcium Silicate
Cellular Glass
Oxidized or Partially oxidized variants of any of the materials listed in this
table
Any of the fibers listed in this table in a non-woven form
Any of the fibers listen in this table in a woven form

TABLE 2
Sacrificial Binding Materials and Methods

Sacrificial Binding & Matrix Fibers
PET (polyester)
PP (polypropylene)
PE (Polyethylene)
PLA (polylactic add)
Nylon
Acrylic
Bicomponent fiber composed of any one or more of the above, ie. coPET,
PE/PET, PP/PET, etc
Intumescents
Any of the fibers listed in this table in a non-woven form
Any of the fibers listed in this table in a woven form
Other Sacrificial Binding Methods (resins)
Urea formaldehyde
Polyurethanes
Melamine
Epoxy
Polyimides
Polycyanurates
Polyester
UV Curable
Vinyl ester
Acrylic
Other Sacrificial Binding Methods (mechanical)
Sewing/quilting
Heat staked
Ultrasonic bonding

In one exemplary embodiment, the seal member 18 is made from fibers that can be exposed to a high temperature for a long duration before drawing of the fibers. This drawing refers to pulling back or shrinking of the fibers due to exposure to the high temperature. If the fiber draws back in response to the application of a flame, a hole could form in the material of the seal member and the flame could pass through the hole. In one exemplary embodiment, the seal member 18 is made from fibers that can be exposed to a 1000° F. or higher temperature for several hours, such as eight or more hours, before drawing of the fibers. One type of fiber that does not draw when exposed to a high temperature for a long period of time is PAN fibers that have been oxidized, so that the PAN fiber will not burn. In one exemplary embodiment, the front seal member 18 or portions of the front seal member 18 are made from the material 3800 described below.

FIGS. 17A, 17B, 18A, and 18B illustrate one exemplary embodiment where the front seal member 18 includes a reinforcement member 80 and an outer sealing material 82. FIGS. 17A, 17B, 18A, and 18B illustrate cross-sections of these embodiments of seal members 18. The reinforcement member 80 maintains the gap G when exposed to high temperatures and/or through UL 2158 static and/or dynamic load fire tests. The sealing material 82 is disposed around or on the reinforcement member 80 and provides a seal between the drum 17 and the front drum mounting surface 52 during normal operation. The reinforcement member 80 may have any configuration that substantially maintains the radial gap G when exposed to high temperatures and/or through UL 2158 static and/or dynamic load fire tests.

In the example illustrated by FIGS. 17A and 17B, the reinforcement member 80 is substantially rigid and maintains its structural integrity when exposed to high temperatures and/or through UL 2158 static and/or dynamic load fire tests. As such, when the seal member 18 is exposed to the heat source 500, the outer sealing material 82 may deteriorate to cause the radial gap G to reduce to the thickness T of the reinforcement member 80 as can be seen by comparing FIGS. 17A and 17B. By appropriately sizing the thickness T of the reinforcement member 80 and the thickness of the outer sealing material 82, the sealing member 18 substantially maintains the radial gap G when exposed to high temperatures and/or through UL 2158 static and/or dynamic load fire tests. Examples of suitable materials for a substantially rigid reinforcement member 80 include, but are not limited to fire retardant materials, such as fire retardant nylon, melamine fibers, fiberglass fibers in a woven or non-woven form, metals (steel, aluminum, etc.), ceramics, any of the materials listed in Table 1, blends of PAN fibers (or any of the materials listed in Table 1) and other materials, such as polyester, nylon, bi-component fibers, PET, PET blends, Rayon, any of the materials listed in Table 2 and the like, fiberglass, blends of fiberglass and other materials, such as polyester, nylon, bi-component fibers, PET, PET blends, Rayon, any of the materials listed in Table 2 and the like, and any combination or subcombination of these materials. In one exemplary embodiment, the reinforcement member 80 or portions of the reinforcement member 18 are made from the material 3800 described below.

In the example illustrated by FIGS. 18A and 18B, the reinforcement member 80 has a spring-type configuration that expands as indicated by double arrow 85 if the sealing material 82 deteriorates due to high temperature to thereby substantially maintain the radial gap G. Examples of suitable materials for a spring-type reinforcement member 80 include, but are not limited to metals, such as spring wire or other spring material. Examples of suitable materials for the sealing material 82 include, but are not limited to fire retardant materials, such as fire retardant nylon, melamine fibers, PAN fibers, any of the materials listed in Table 1, blends of PAN fibers (or any of the materials listed in Table 1) and other materials, such as any of the materials listed in Table 2, fiberglass, blends of fiberglass and other materials, such as any of the materials listed in Table 2, flame resistant cotton shoddy, and intamescent material and non-fire retardant materials, such as polyester, nylon, bi-component fibers, PET, PET blends, Rayon, any of the materials listed in Table 2 and the like. In other embodiments, the sealing material is made from a material that degrades when exposed to high temperatures, such as high density polyester or any of the other materials listed in Table 2.

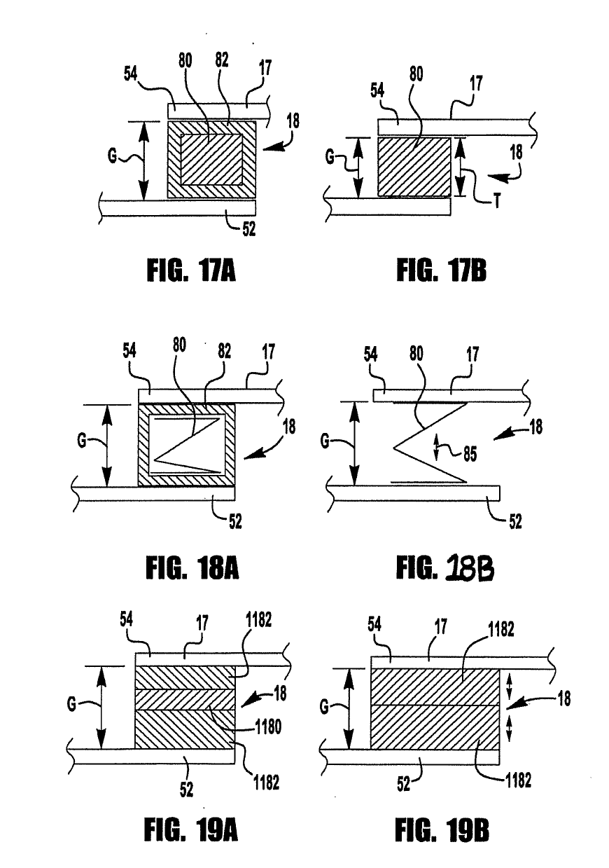

FIGS. 19A and 19B illustrate one exemplary embodiment where the front seal member 18 includes a sacrificial portion 1180 and an expandable portion 1182. In the illustrated embodiment, the sacrificial portion 1180 is sandwiched between two layers of the expandable material. The sacrificial portion 1180 may be made from a material that provides good support for the drum during normal operating temperatures, but may degrade and/or be consumed when heated to an elevated temperature. One acceptable example of an acceptable material for the sacrificial portion 1180 is high density polyester, such as non-woven, high density polyester. However, any material that supports the drum 17 when at normal operating temperatures, but degrades or is consumed when exposed to elevated temperatures, such as 800 degrees F., can be used. The sacrificial portion 1180 can be made from any of the materials listed in Table 2.

The material of the expandable portion 1182 may be selected to minimize friction between the drum 17 and the front seal member 18 and/or the drum 17 and the front bulkhead 14. In an exemplary embodiment, the material of the expandable portion 1182 expands when exposed to elevated temperatures. For example, FIG. 19B illustrates that the expandable portion 1182 expands when the sacrificial portion 1180 is consumed to substantially maintain the radial gap G. In one exemplary embodiment, the expandable portion 1182 expands and maintains it structural integrity and/or prevents flames from passing when exposed to high temperatures and/or the dryer is put through UL 2158 static and/or dynamic load fire tests. Examples of suitable materials of the expandable portion 1182 include, but are not limited to, polyacrylonitrile (PAN), any of the materials listed in Table 1, PAN and nylon blends, PAN and polyester blends, blends of PAN (or any of the materials listed in Table 1) and other materials, such as any of the materials listed in Table 2, intamescent material (or other material that swells or expands when heated), blends of intamescent material and other materials. In one exemplary embodiment, PAN fibers (or any of the fibers listed in Table 1) are air laid and then needled or thermally set with polyester to a more compressed configuration. When exposed to heat, the PAN fibers tend to return to their original air laid, expanded configuration. For example, when thermally set with polyester (or set with any of the materials listed in Table 2), the polyester (or material listed in Table 2) may be consumed to allow the PAN fibers (or material listed in Table 1) to expand to their air laid configuration. In one exemplary embodiment, the expandable material is configured to at least double in thickness when exposed to high temperatures and/or the dryer is put through UL 2158 static and/or dynamic load fire tests. For example, a 3/16″ thick expandable material may expand to a 1″ thickness or more. In one exemplary embodiment, the expandable portion 1182 or portions are made from the material 3800 described below.

Referring to FIG. 4A, in one exemplary embodiment, the front bulkhead 14 includes one or more front support roller(s) 410. In the example illustrated by FIG. 4A, the rear bulkhead 16 also includes one or more support roller(s) 88. However, in other embodiments, only front support roller(s) 410 or only rear support roller(s) 88 may be included. The front support roller(s) 410 and/or the rear support roller (88) are configured to support the drum 17 and allow the drum to rotate. In one exemplary embodiment, the front support roller(s) 410 and/or the rear support roller (88) are made from materials that do not burn or materially degrade when exposed to high temperatures and/or the dryer is put through UL 2158 static and/or dynamic load fire tests. In one embodiment, the roller(s) 410 and/or the rollers (88) my not turn freely when exposed to high temperatures and/or through UL 2158 static and/or dynamic load fire tests, but the rollers still support the weight of the drum 17 and the content of the drum 17. For example, in one exemplary embodiment, the front support rollers 410 substantially maintain the size of the radial gap G when a temperature inside of a fully loaded drum exposed to high temperatures and/or the dryer is put through UL 2158 static and/or dynamic load fire test. For example, the front support rollers may be configured such that the radial gap G decreases by less than 50%, less than 40%, less than 30%, less than 25%, less than 20%, less than 10%, or less than 5% when exposed to high temperatures and/or the dryer is put through UL 2158 static and/or dynamic load fire tests. Examples of suitable roller materials capable of maintaining the radial gap G when exposed to high temperatures and/or through UL 2158 static and/or dynamic load fire tests include, but are not limited to, metals, such as steel and aluminum, ceramics, carbon fiber, high temperature plastics, and the like.

The rear seal member 20 can take a wide variety of different forms. In the illustrated embodiments, the rear seal member 20 is positioned between the rear end 74 of the drum 17 and the rear drum mounting surface 72 to provide a seal between the rear end 74 of the drum and the rear drum mounting surface 72. In the examples illustrated by FIGS. 3A and 3B, the rear seal member 20 is disposed outside the rear end 74 of the drum and inside the drum mounting surface 72. In the examples illustrated by FIGS. 3C and 3D, the rear seal member 20 is disposed around the rear drum mounting surface 72 and inside the inner surface of the rear opening 76 of the drum 17. In any of the examples illustrated by FIGS. 3A-3D, the rear seal member 20 can be attached to the drum 17 or the rear drum mounting surface 72.

Referring to the schematically illustrated examples of FIGS. 3E, 3F, 3G, and 3H, the rear seal member 20 is positioned around the rear end 74 of the drum 17, which is disposed around the rear drum mounting surface 72. The rear end 74 of the drum is supported by one or more rollers 88. In the embodiments of FIGS. 3E and 3G, the rear seal member 20 extends rearward of the drum 17 and engages the rear bulkhead 16 to form a seal between the rear bulkhead and the drum. In the embodiments of FIGS. 3F and 3H, the rear seal member 20 wraps around a rear edge of the drum 17 and engages the rear bulkhead 16 to form a seal between the rear bulkhead and the drum. In the examples illustrated by FIGS. 3E and 3G, the rear seal member 20 can be attached to the drum 17 or the rear bulkhead 16. In the examples illustrated by FIGS. 3F and 3H, the rear seal member 20 is attached to the drum 17.

The rear seal member 20 can be made from a wide variety of different materials and can have a wide variety of different configurations. In the illustrated embodiment, the rear seal member 20 is an annular ring. Referring to FIG. 4, in one exemplary embodiment, the rear seal member maintains the seal between the drum 17 and the rear drum mounting surface 72 and/or prevents flame penetration when exposed to high temperatures and/or the dryer is put through UL 2158 static and/or dynamic load fire tests. The rear seal member 20 may be made from a flame resistant material that maintains sealing when exposed to high temperatures. Examples of suitable materials for the rear seal member 20 include, but are not limited to, fire retardant materials, such as fire retardant nylon, melamine fibers, PAN fibers, any of the materials listed in Table 1, blends of PAN fibers (or any of the fibers listed in Table 1) and other materials, such as polyester, nylon, bi-component fibers, PET, PET blends, Rayon, any of the materials listed in Table 2, and the like fiberglass, which may be non-woven or woven, blends of fiberglass and other materials, such as polyester, nylon, bi-component fibers, PET, PET blends, Rayon, any of the materials listed in Table 2, and the like, flame resistant cotton shoddy, intamescent material (or other material that swells or expands when heated), blends of intamescent material and other materials, such as polyester, nylon, bi-component fibers, PET, PET blends, Rayon, any of the materials listed in Table 2, and the like, and any combination or subcombination of these materials. Any material capable of substantially maintaining the radial gap G when exposed to high temperatures and/or when the dryer is put through UL 2158 static and/or dynamic load fire tests can be used. In one exemplary embodiment, the rear seal 20 or one or more portions of the rear seal are made from the material 3800 described below.

In one exemplary embodiment, the rear seal member 20 is made from or partially made from a material that comprises fibers of at least one of the types listed in Table 1 and at least one sacrificial fiber, material, which may be a powder, resin, or aqueous solution, and/or mechanical fastening technique listed in Table 2. That is, the seal member material or a portion of the seal member material may be made from any combination of one or more of the materials or material types listed in Table 1 with one or more of the materials or material types listed in Table 2.

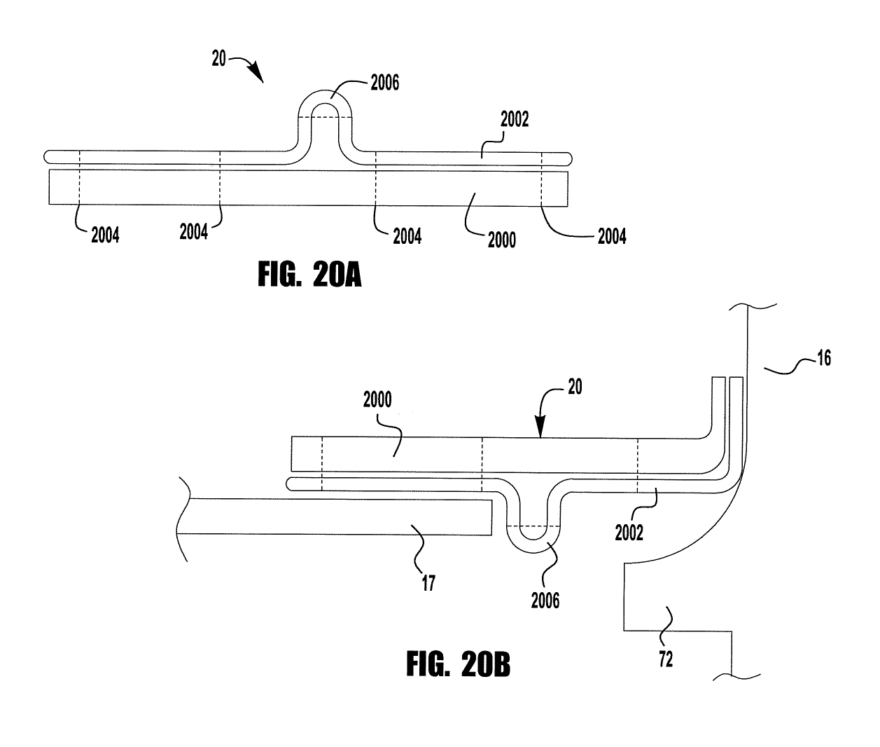

FIGS. 20A and 20B illustrate one of the many possible configurations of the rear seal member 20. FIG. 20A is a cross-sectional view of an annular seal member 20 in an uninstalled condition and FIG. 20B is a cross-sectional view of the annular seal member attached to the annular end of the drum 17 of a dryer. The illustrated rear seal member 20 includes an a base layer 2000 and a sealing layer 2002. However, the seal member could be made from a single layer of material. The base layer 2000 is made from a flexible material that reinforces the sealing layer 2002. The sealing layer 2002 is capable of being connected to the end of the drum 17 as shown in FIG. 20B. For example, the sealing layer 2000 may be glued, thermally bonded, or otherwise attached to the drum 17. The illustrated sealing layer 2002 is optionally wider than the base layer. The sealing layer 2002 may be connected to the base layer at connection points 2004, such as by stitching. In an exemplary embodiment, a loop 2006 of the sealing layer material extends slightly away from the base layer 2000. The optional loop 2006 acts as a positioning aid for the seal 20.

The seal 20 may be attached to the drum 17 as shown in FIG. 20B. The loop 2006 positions the seal 20 on the end of the drum. The seal 20 extends rearward from the drum 17, such that the sealing layer 2002 seals against the rear bulkhead 16, for example at an outside of the rear drum mounting surface.

The base layer 2000 and/or the sealing layer 2002 may be made from a flame resistant material that maintains sealing and/or prevents flame penetration when exposed to high temperatures and/or when the dryer is put through UL 2158 static and/or dynamic load fire tests. Examples of suitable materials for the base layer 2000 and/or the sealing layer 2002 include, but are not limited to, fire retardant materials, such as fire retardant nylon, melamine fibers, PAN fibers, any of the fibers listed in Table 1, blends of PAN fibers (or any of the fibers listed in Table 1) and other materials, such as polyester, nylon, bi-component fibers, PET, PET blends, Rayon, any of the materials listed in Table 2, and the like, fiberglass, blends of fiberglass and other materials, such as polyester, nylon, bi-component fibers, PET, PET blends, Rayon, any of the materials listed in Table 2, and the like, flame resistant cotton shoddy, intamescent material (or other material that swells or expands when heated), blends of intamescent material and other materials, such as polyester, nylon, bi-component fibers, PET, PET blends, Rayon, any of the materials listed in Table 2, and the like, and any combination or subcombination of these materials. In one exemplary embodiment, base layer 2000 and/or the sealing layer 2002 are made from the material 3800 described below.

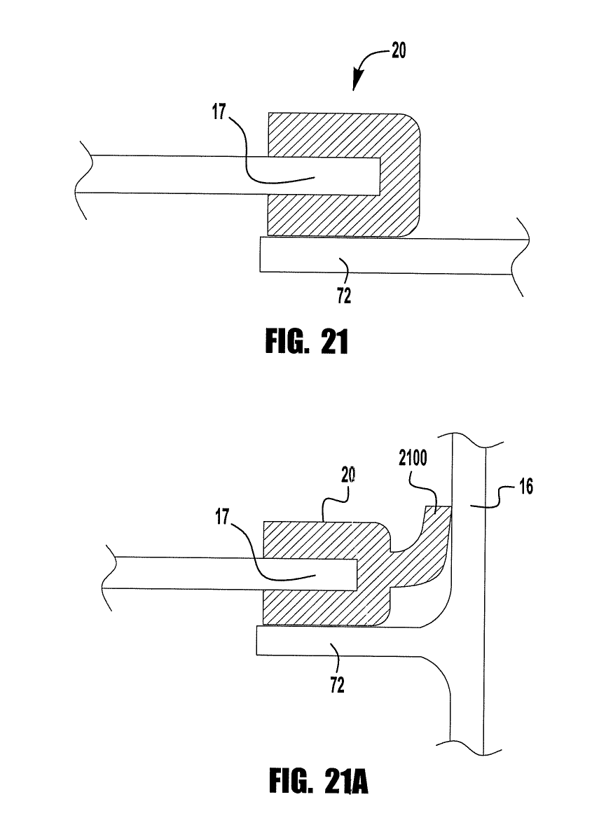

FIG. 21 illustrates another one of the many possible configurations of the rear seal member 20. The seal member is “c” or cup shaped and fits over the end of the drum 17. The illustrated rear seal member 20 is a single layer of material. However, the seal member could be made from two or more layers of material. The seal member 20 may seal against the rear bulkhead in a wide variety of different ways. In the example illustrated by FIG. 21, the support portion 72 of the rear bulkhead is disposed inside the drum 17 and the inner portion of the seal provides a seal there-between. However, any of the configurations disclosed herein can be implemented.

The embodiment of FIG. 21A is similar to the embodiment of FIG. 21, except the rear seal member 20 includes a flange or tab 2100 that extends into a space between the rear bulkhead 16 and the drum 17. The flange or tab 2100 may be formed in a wide variety of different ways. Any manner of forming a flange or tab 2100 can be used. The flange or tab 2100 may be integrally formed with the rest of the seal member or a separate member may form the flange or tab 2100. In an exemplary embodiment, the flange or tab 2100 is made from a material that is able to withstand high temperatures, such as 800 degrees F. and/or prevents flame penetration. The flange or tab 2100 may be made from a material that is capable of withstanding high temperatures, such as 800 degrees F., while the remainder of the rear seal member 20 is made from materials that degrade and/or are consumed when exposed to high temperatures, such as 800 degrees F. If the drum 17 tips forward, the flange or tab 2100 keeps the space between the rear bulkhead 16 and the drum 17 blocked. The flange or tab 2100 may be made from an expandable member. If the drum 17 tips forward, and the flange or tab is exposed to high temperatures, the flange may expand or swell to contain the source of heat 500 in the drum. In one exemplary embodiment, the expandable material is configured to at least double in thickness when exposed to high temperatures and/or the dryer is put through UL 2158 static and/or dynamic load fire tests. For example, a 3/16″ thick expandable material may expand to a 1″ thickness or more. In one exemplary embodiment, the flange or tab 2100 is made from the material 3800 described below.

In one exemplary embodiment, the front seal member 2100 is made from a material that comprises fibers of at least one of the types listed in Table 1 and at least one sacrificial fiber, material, which may be a powder, resin, or aqueous solution, and/or mechanical fastening technique listed in Table 2. That is, the seal member material or a portion of the seal member material may be made from any combination of one or more of the materials or material types listed in Table 1 with one or more of the materials or material types listed in Table 2.

Referring to FIG. 1, a front door 40 is mounted to the front bulkhead 14. The front door 40 can be opened to provide access to the interior of the rotatable drying drum 17 through the access opening 50. The front door 40 can be closed to close the access opening 50. In the illustrated embodiment, the front door includes a second door latch component 57 that mates with the first door latch component 55 to latch the front door closed. Referring to FIG. 1, in one exemplary embodiment, a seal member 58 provides a seal between the front door 40 and the bulkhead 14 when the front door 40 is closed. The seal member 58 prevents airflow out of the drum 17 when the front door 40 is closed. The seal 58 can take a wide variety of different forms. In one exemplary embodiment, the seal 58 is configured to maintain the seal between the front bulkhead 14 and the front door 40 and/or prevents flames from passing between the front bulkhead 14 and the front door when exposed to high temperatures and/or when the dryer is put through UL 2158 static and/or dynamic load fire tests. The seal 58 may be made from a wide variety of different materials and may have a variety of different shapes. Examples of materials that the seal 58 may be made from include, but are not limited to, fire retardant materials, such as fire retardant nylon, melamine fibers, PAN fibers, any of the materials listed in Table 1, blends of PAN fibers (or any of the materials listed in Table 1) and other materials, such as polyester, nylon, bi-component fibers, PET, PET blends, Rayon, any of the materials listed in Table 2, and the like, fiberglass, which may be woven or non-woven, blends of fiberglass and other materials, such as polyester, nylon, bi-component fibers, PET, PET blends, Rayon, any of the materials listed in Table 2, and the like, flame resistant cotton shoddy, intamescent material (or other material that swells or expands when heated), blends of intamescent material and other materials, such as polyester, nylon, bi-component fibers, PET, PET blends, Rayon, any of the materials listed in Table 2, and the like, and any combination or subcombination of these materials. In one exemplary embodiment, the seal 58 or one or more portions of the seal are made from the material 3800 described below.

In one exemplary embodiment, the seal 58 is made from a material that comprises fibers of at least one of the types listed in Table 1 and at least one sacrificial fiber, material, which may be a powder, resin, or aqueous solution, and/or mechanical fastening technique listed in Table 2. That is, the seal 58 material or a portion of the seal material may be made from any combination of one or more of the materials or material types listed in Table 1 with one or more of the materials or material types listed in Table 2.

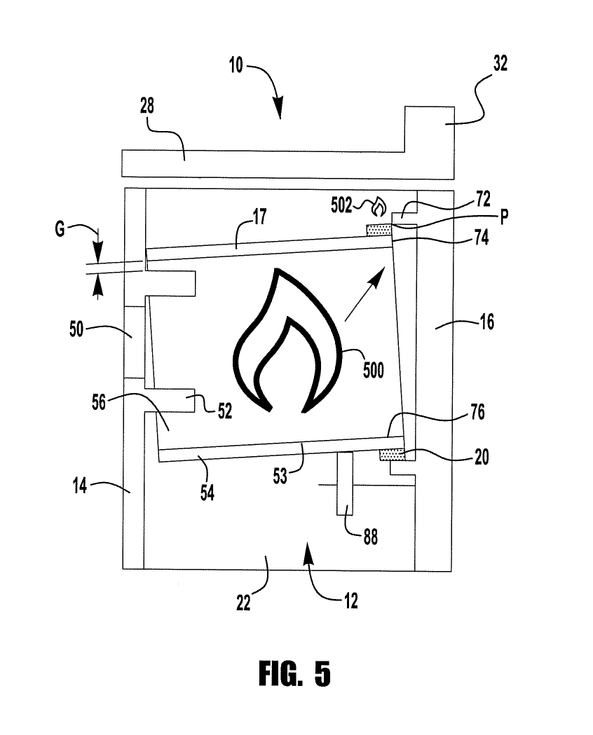

Under some circumstances, a source of heat 500, other than the normal drying heat, may heat the internal volume of the drum. For example, during UL 2158 static and dynamic load fire tests, the temperature inside the drum 17 may reach temperatures as high as 800 degrees, F 1000 degrees F., or even 1500 degrees F. FIGS. 4 and 5 illustrate that if the front seal member 18 is compromised and/or deteriorated by a source of heat 500 contained within the drum 17, the radial gap G may be substantially reduced, causing the drum to tilt forward. For example, the radial gap G may diminish by 50%, 60%, 70%, 80%, 90%, or completely. This tilting forward may occur if the front seal is not configured to maintain its structural integrity when exposed to the source of heat 500 and/or the source of heat is provided within the drum 17 for a prolonged period of time and a front roller 410 capable of withstanding high temperatures is not included. As noted above, in some exemplary embodiments, the front seal member 18 is configured to substantially maintain the radial gap G and thereby prevent the tilting of the drum shown in FIG. 5 when the front seal member 18 is exposed to high temperatures and/or when the dryer is put through UL 2158 static and/or dynamic load fire tests. In other exemplary embodiments, the front seal member 18 is configured to deteriorate when exposed to high temperatures and/or through UL 2158 static and/or dynamic load fire tests.

When the drum 17 tilts forward from the rear bulkhead 16 toward the front bulkhead 14, the seal between the rear drum mounting surface 72 and the rear end 74 of the drum provided by the seal member 20 may break at a top of the drum to provide an exit path P out of the drum 17. The exit path P may allow heat 502 from the source of heat 500 to exit drum 17 and travel into the cabinet 12.

FIG. 5A illustrates an embodiment similar to the embodiment illustrated by FIG. 5, except the rear seal member 20 is made from an expandable material. When the rear seal member is exposed to high temperatures and/or through UL 2158 static and/or dynamic load fire tests, the rear seal member expands. As such, when the drum 17 tilts forward from the rear bulkhead 16 toward the front bulkhead 14, the seal expands or swells and blocks off an exit path P that may otherwise allow heat from the source of heat 500 to exit drum 17 and travel into the cabinet 12. In one exemplary embodiment, the expandable material is configured to at least double in thickness when exposed to high temperatures and/or the dryer is put through UL 2158 static and/or dynamic load fire tests. For example, a 3/16″ thick expandable material may expand to a 1″ thickness or more. In one exemplary embodiment, the rear seal member 20 or a portion of the rear seal member 20 is made from the material 3800 described below. As described below, the material 3800 may be configured such that the airflow resistance of the material decreases when the material expands.

Arrow 3850 is provided in FIG. 5A to illustrate that an airflow resistance of a seal member 20 (or 18 in other embodiments) decreases when a seal member made from the material 3800 expands. This decrease in airflow resistance causes the seal 20 to act as a vent when the seal member 20 is exposed to a source of high heat. The venting action of the seal 20 prevents pressure from building inside the drum when the source of high heat is inside the drum 17. In an exemplary embodiment, while the airflow resistance of the seal 20 made from the material 3800 decreases, the material is also configured to prevent propagation of the flame through the rear real that has expanded to fill the gap. As is explained below, the thermal resistance of the material 3800 increases significantly as the seal 20 expands. As a result, the temperature of the portion of the expanded seal 20 on the outside of the drum is much lower than the temperature of the portion of the expanded seal on the inside of the drum.

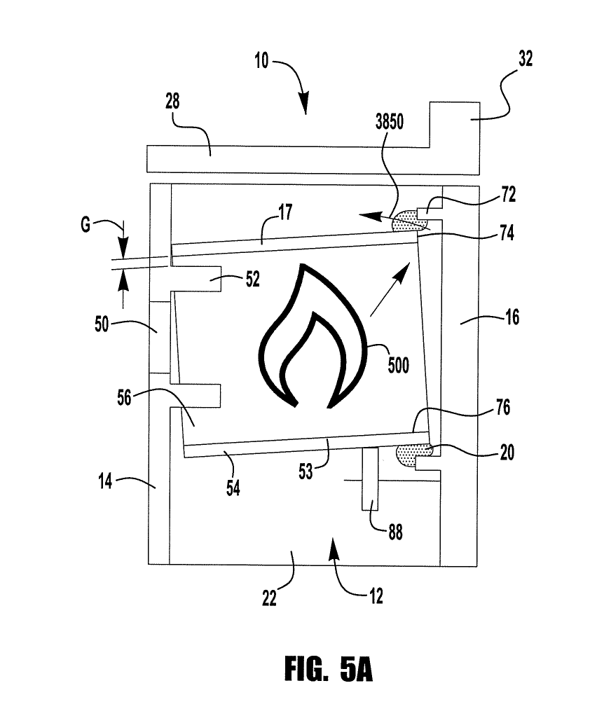

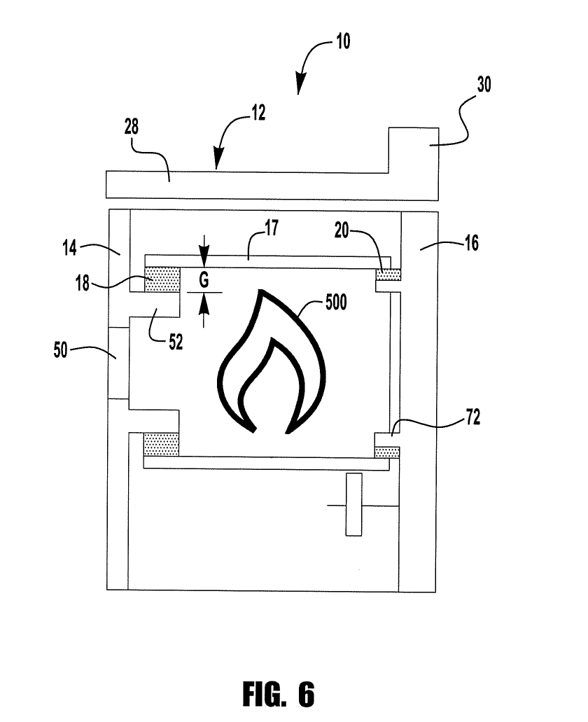

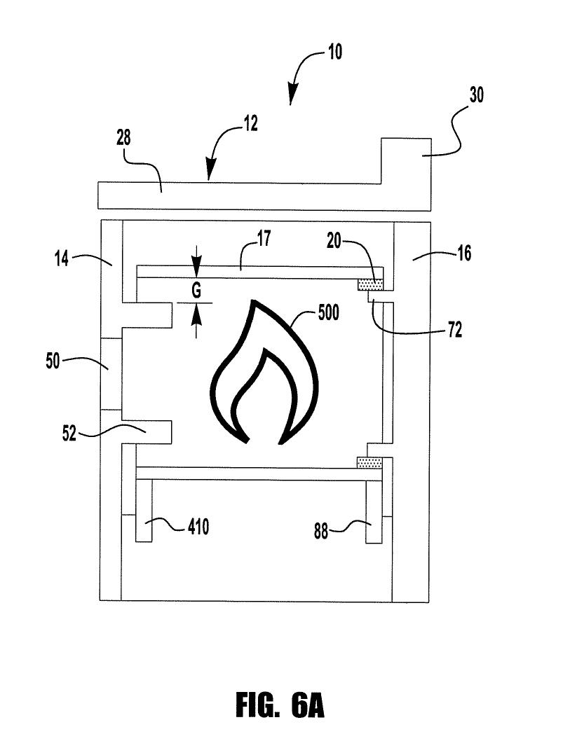

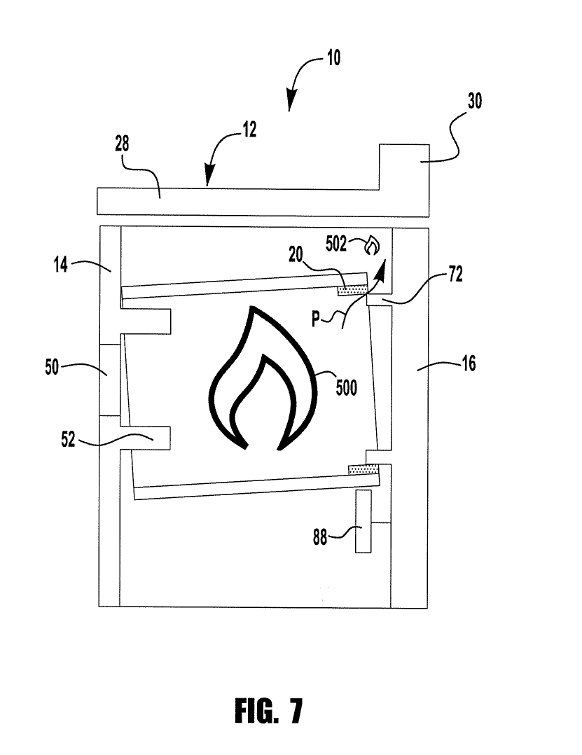

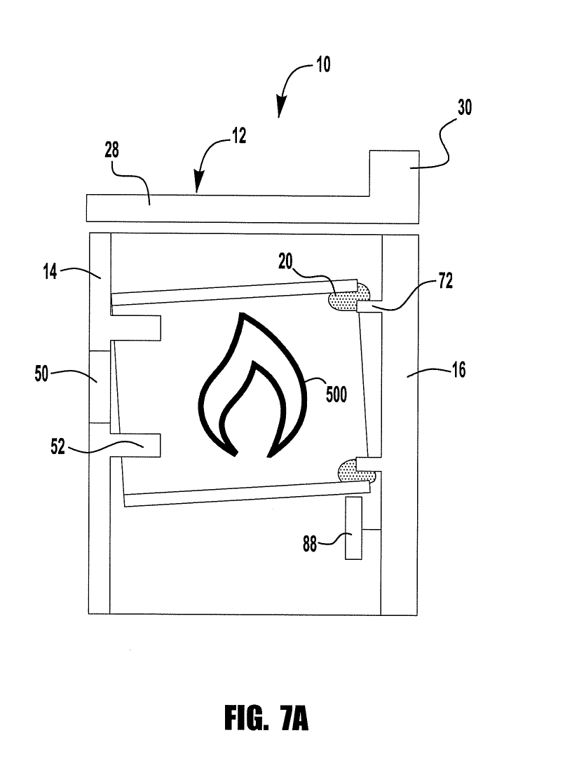

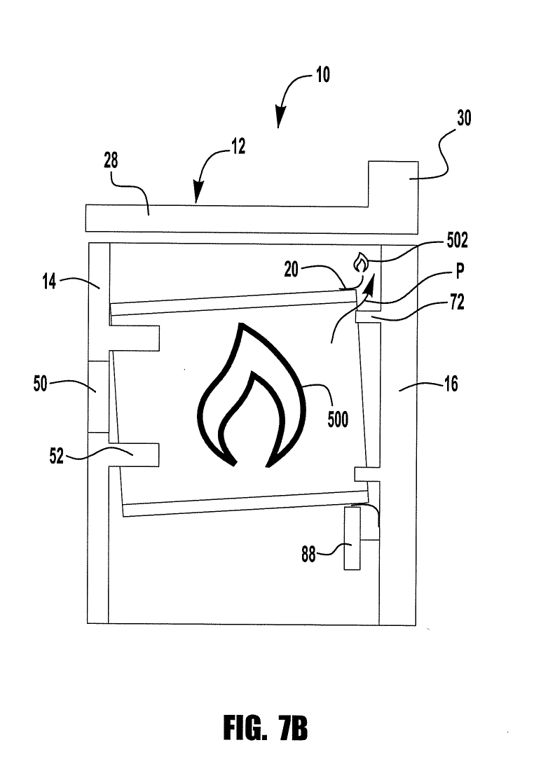

FIGS. 6, 6A, and 7 are similar to FIGS. 4, 4A, and 5 respectively, except the rear seal member 20 is positioned inside of the drum 17 and outside of the rear drum mounting surface 72. FIG. 7B is similar to FIG. 7, except the rear seal 20 has the configuration illustrated by FIG. 3E. FIGS. 7 and 7B illustrate that, like the embodiment illustrated by FIG. 5, if the front seal member 18 is compromised and/or deteriorated by a source of heat 500 contained within the drum 17, the radial gap G may be substantially reduced, causing the drum to tilt forward. For example, the radial gap G may diminish by 50%, 60%, 70%, 80%, 90%, or completely. This tilting forward may occur if the front seal is not configured to maintain its structural integrity when exposed to the source of heat 500, a front roller 410 is not included (see FIG. 6A) and/or the source of heat is provided within the drum 17 for a prolonged period of time. As noted above, in some exemplary embodiments, the front seal member 18 is configured to substantially maintain the radial gap G and thereby prevent the tilting of the drum shown in FIG. 7 when the front seal member 18 is exposed to high temperatures and/or through UL 2158 static and/or dynamic load fire tests. In other exemplary embodiments, the front seal member 18 is configured to deteriorate when exposed to high temperatures and/or through UL 2158 static and/or dynamic load fire tests.

Referring to FIGS. 7 and 7B, when the drum 17 tilts forward from the rear bulkhead 16 toward the front bulkhead 14, the seal between the rear bulkhead 16 and the rear end 74 of the drum provided by the seal member 20 may break at a top of the drum to provide an exit path P out of the drum 17. The exit path P may allow heat 502 from the source of heat 500 to exit drum 17 and travel into the cabinet 12.

FIG. 7A illustrates an embodiment similar to the embodiment illustrated by FIG. 7, except the rear seal member 20 is made from an expandable material. When the rear seal member is exposed to high temperatures and/or through UL 2158 static and/or dynamic load fire tests, the rear seal member expands and/or prevents flame penetration. As such, when the drum 17 tilts forward from the rear bulkhead 16 toward the front bulkhead 14, the seal expands or swells and blocks off an exit path P that may otherwise allow heat from the source of heat 500 to exit drum 17 and travel into the cabinet 12. In one exemplary embodiment, the expandable material is configured to at least double in thickness when exposed to high temperatures and/or the dryer is put through UL 2158 static and/or dynamic load fire tests. For example, a 3/16″ thick expandable material may expand to a 1″ thickness or more. In one exemplary embodiment, the rear seal member 20 or a portion of the rear seal member 20 shown in FIG. 7A is made from the material 3800 described below.

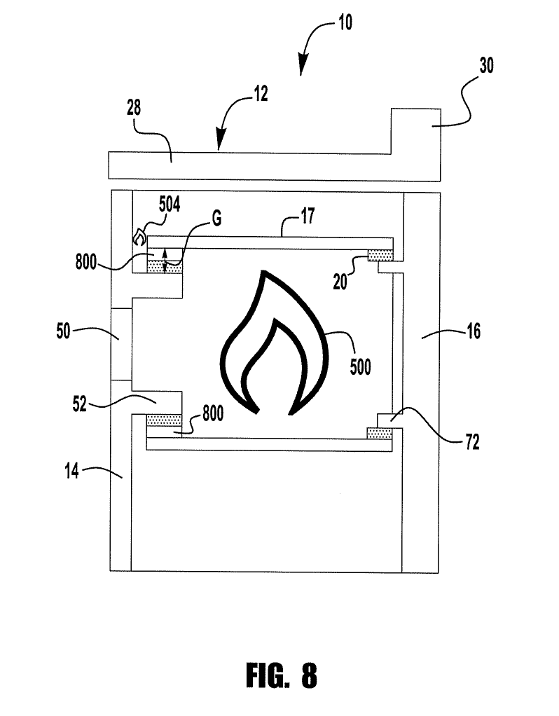

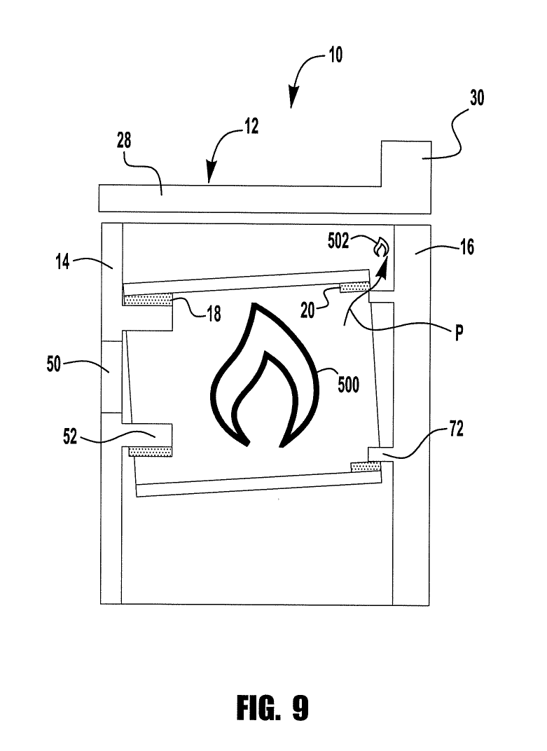

FIGS. 8, and 9 are similar to FIGS. 6 and 7 respectively, except a plastic liner or ring 800 is positioned inside of the drum 17, between the drum 17 and the front seal member 18. The plastic liner or ring 800 may be attached to an inside surface of the drum. The plastic liner or ring 800 reduces friction between the drum 17 and the front seal member 18. In one exemplary embodiment, the plastic liner or ring 800 is made from a material capable of withstanding elevated temperatures. In other embodiments, the plastic liner or ring 800 is made from conventional materials that degrade or are consumed at elevated temperatures, such as 800 degrees F. For example, the plastic liner or ring 800 can be made from a wide variety of different plastics, including but not limited to polybutylene terphthalate (PBT) or polyethylene terphthalate (PET).

FIGS. 8 and 9 illustrate a plastic liner or ring 800 included only at the front end of the drum 17. However, a plastic liner or ring could be included at both the front end and the rear end of the drum 17 or only at the rear end of the drum. Further, while the plastic liner or ring 800 is illustrated as being disposed inside the drum, it should be appreciated that the plastic liner or ring 800 can be placed on the outside of the drum or the plastic liner or ring could be attached to the inside or the outside of one or both of the bulkheads 14, 16.

FIG. 8 illustrates that if the plastic liner or ring 800 is exposed to the source of heat 500, the plastic liner could ignite to provide an additional source of heat 504 in the cabinet at the front of the drum 17. FIG. 9 illustrates that if the plastic liner or ring 800 and/or front seal member 18 is compromised, deteriorated, and/or consumed by a source of heat 500 contained within the drum 17, the radial gap G may be substantially reduced, causing the drum 17 to tilt forward. For example, the radial gap G may diminish by 50%, 60%, 70%, 80%, 90%, or completely. This tilting forward may occur if a front roller 410 that is configured to withstand high temperatures (see FIG. 7A) is not included. In some exemplary embodiments, the front seal member 18 and/or the ring 800 may be configured to substantially maintain the radial gap G and thereby prevent the tilting of the drum shown in FIG. 9. For example, the ring 800 may include one or more portions that are able to withstand high temperatures and thereby substantially maintain the gap G. For example, the ring 800 may have metal portions or be configured similar to the seal embodiments illustrated by FIGS. 17A-19B.

Still referring to FIG. 9, when the drum 17 tilts forward from the rear bulkhead 16 toward the front bulkhead 14, the seal between the rear drum mounting surface 72 and the rear end 74 of the drum provided by the seal member 20 may break at a top of the drum to provide an exit path P out of the drum 17. The exit path P may allow heat 502 from the source of heat 500 to exit drum 17 and travel into the cabinet 12.

FIG. 9A illustrates an embodiment similar to the embodiment illustrated by FIG. 9, except the front seal member 18 and/or the rear seal member 20 are made at least partially from an expandable material. When the front seal member and/or rear seal member is exposed to high temperatures and/or through UL 2158 static and/or dynamic load fire tests, the front and/or rear seal members expand and/or prevents flame penetration. As such, when the drum 17 tilts forward from the rear bulkhead 16 toward the front bulkhead 14, the seals 18 and/or 20 expand or swells and block off any exit paths that may otherwise for at the front and/or rear of the drum 17. In one exemplary embodiment, the expandable material is configured to at least double in thickness when exposed to high temperatures and/or the dryer is put through UL 2158 static and/or dynamic load fire tests. For example, a 3/16″ thick expandable material may expand to a 1″ thickness or more. In one exemplary embodiment, the rear seal member 20 or a portion of the rear seal member illustrated by FIG. 9A is made from the material 3800 described below.

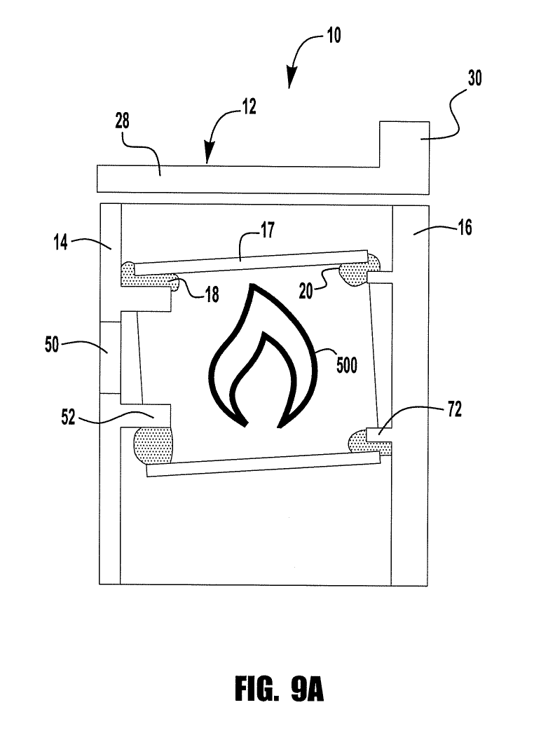

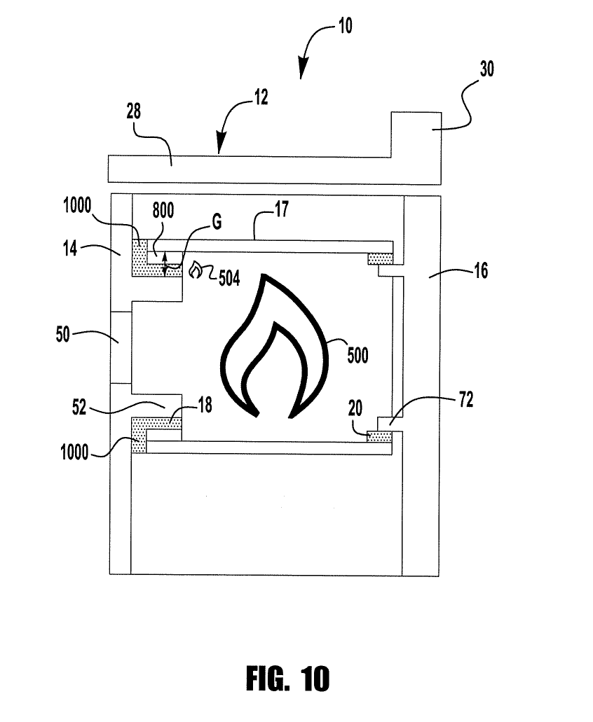

FIG. 10 is similar to FIG. 8 except the front seal member 18 includes a flange or tab 1000 that extends into a space between the plastic ring 800 and the front bulkhead 14. In this illustrated example, the flange or tab 1000 of the front seal member 18 extends past the plastic ring 800 into a space between the front bulkhead 14 and the drum 17. In an exemplary embodiment, the flange or tab 1000 is made from a material that is able to withstand high temperatures, such as 800 degrees F. In one exemplary embodiment, the flange or tab 800 is made from the same material as the rest of the front seal member 18. In another embodiment, the flange or tab 800 is made from a material that is different than the material the rest of the front seal member 18 is made from. For example, the flange or tab 1000 may be made from a material that is capable of withstanding high temperatures, such as 800 degrees F., while the remainder of the front seal member 18 is made from a material that degrades and/or is consumed when exposed to high temperatures, such as 800 degrees F. FIG. 10 illustrates that if the plastic liner or ring 800 ignites, the flange or tab 1000 blocks the additional source of heat 504 from leaving the drum 17 and entering the cabinet 12. In one exemplary embodiment, the flange or tab 1000 is made from the material 3800 described below.

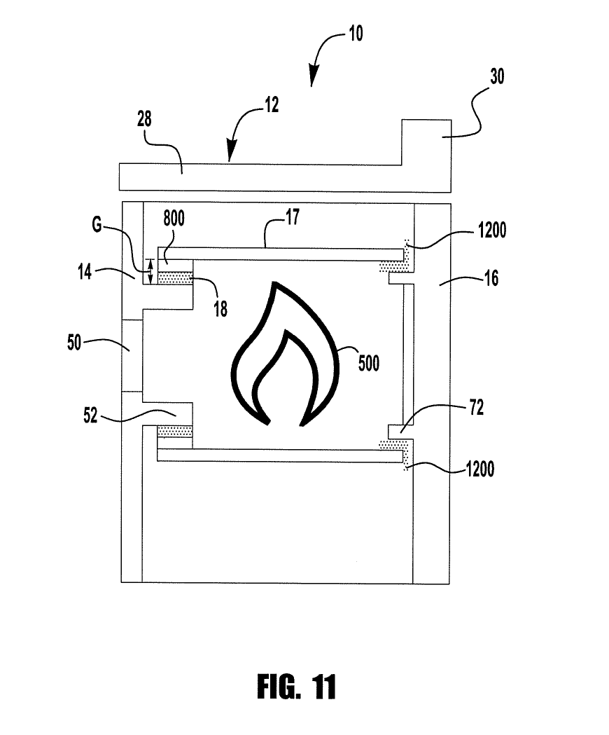

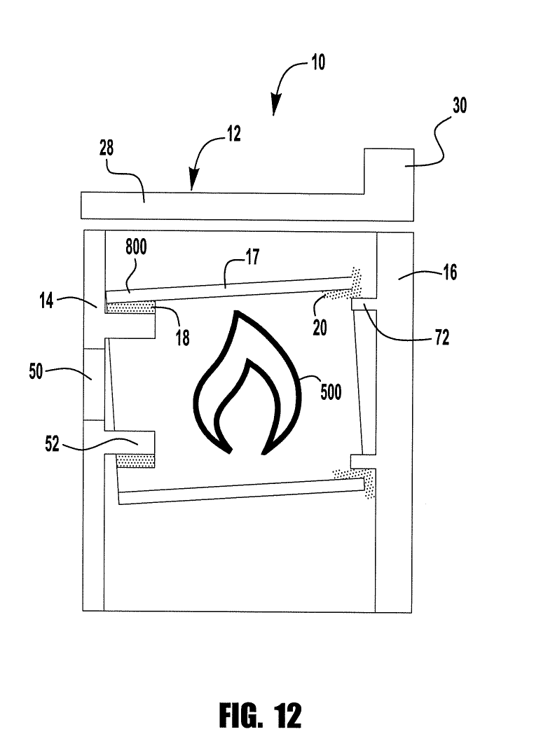

FIGS. 11 and 12 are similar to FIGS. 8 and 9, except the rear seal member 20 includes a flange or tab 1200 that extends into a space between the rear bulkhead 16 and the drum 17. In another embodiment, the front seal member 18 shown in FIG. 10 and the rear seal member shown in FIG. 11 are used in the dryer 10. In an exemplary embodiment, the flange or tab 1200 is made from a material that is able to withstand high temperatures, such as 800 degrees F. In one exemplary embodiment, the flange or tab 1200 is made from the same material as the rest of the rear seal member 20. In another embodiment, the flange or tab 1200 is made from a material that is different than the material the rest of the rear seal member 20 is made from. For example, the flange or tab 1200 may be made from a material that is capable of withstanding high temperatures, such as 800 degrees F., while the remainder of the rear seal member 20 is made from a material that degrades and/or is consumed when exposed to high temperatures, such as 800 degrees F. In one exemplary embodiment, the flange or tab 1000 is made from the material 3800 described below. FIG. 12 illustrates that if the drum 17 tips forward, the flange or tab 1200 prevents the source of heat 500 from escaping into the cabinet 12 at the rear of the drum 17 (i.e. the exit path P shown in FIG. 9 is blocked).

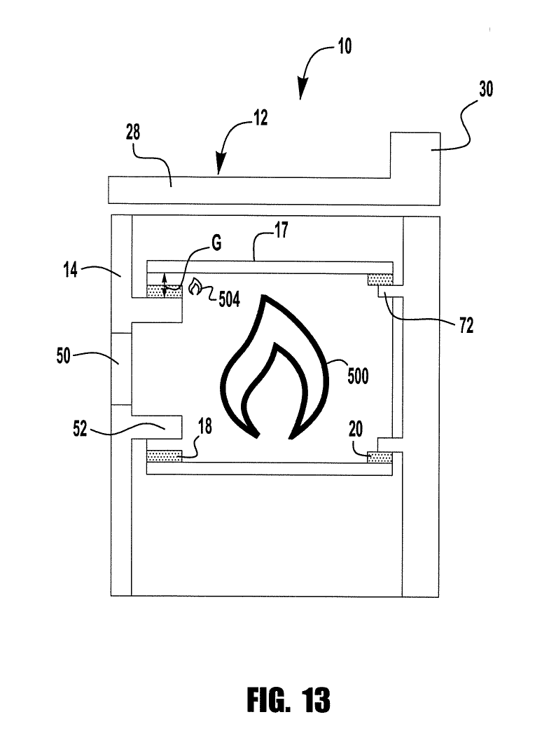

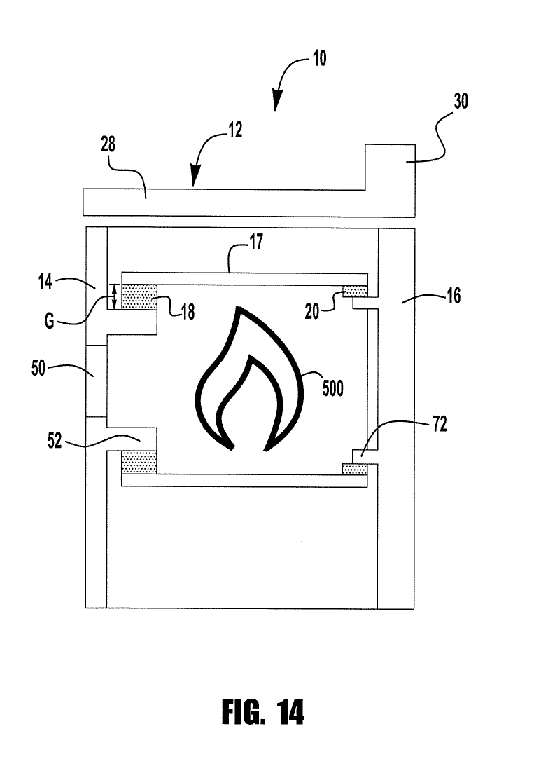

FIGS. 13 and 14 are similar to FIGS. 8 and 9, except the front seal member 18 is at least partially made from an expandable material. If the plastic liner or ring 800 is exposed to the source of heat 500, the plastic liner could ignite and be consumed. In the example illustrated by FIGS. 13 and 14, the front seal member 18 expands to prevent the radial gap G from being substantially reduced, and thereby inhibit the drum 17 from tilting forward. The expanding of the front seal member 18 may also prevent the heat source 500 from escaping the drum 17 and spreading into the cabinet 12, since the expanding front seal member 18 keeps the gap closed. In one exemplary embodiment, the front seal member illustrated by FIGS. 13 and 14 is made from the material 3800 described below.

The front seal member 18 may be configured to expand whenever the plastic liner or ring 800 is removed or only when the front seal member 18 is exposed to elevated temperatures. An expandable front seal member 18 may be made from a variety of different materials. Examples of materials that an expandable front seal member may be made from include, but are not limited to, polyacrylonitrile (PAN), any of the materials listed in Table 1, PAN and nylon blends, PAN and polyester blends, blends of any one or more of the materials listed in Table 1 with any one or more of the materials listed in Table 2, intamescent material, and blends of intamescent material and other materials, such as any of the materials listed in Tables 1 and 2. In one exemplary embodiment, PAN fibers are air laid and then needled or thermally set with polyester to a more compressed configuration. When exposed to heat, the PAN fibers tend to return to their original air laid, expanded configuration. For example, when thermally set with polyester, the polyester may be consumed to allow the pan fibers to expand to their air laid configuration. The front seal member 18 may be configured to expand in a wide variety of different ways. For example, the front seal member 18 may be configured to have the form illustrated by FIG. 17A or FIG. 19A. In one exemplary embodiment, the expandable material is configured to at least double in thickness when exposed to high temperatures and/or the dryer is put through UL 2158 static and/or dynamic load fire tests. For example, a 3/16″ thick expandable material may expand to a 1″ thickness or more while preventing flame penetration. In one exemplary embodiment, the expandable portion of the seals 18 illustrated by FIGS. 17A and 19A are made from the material 3800 described below.

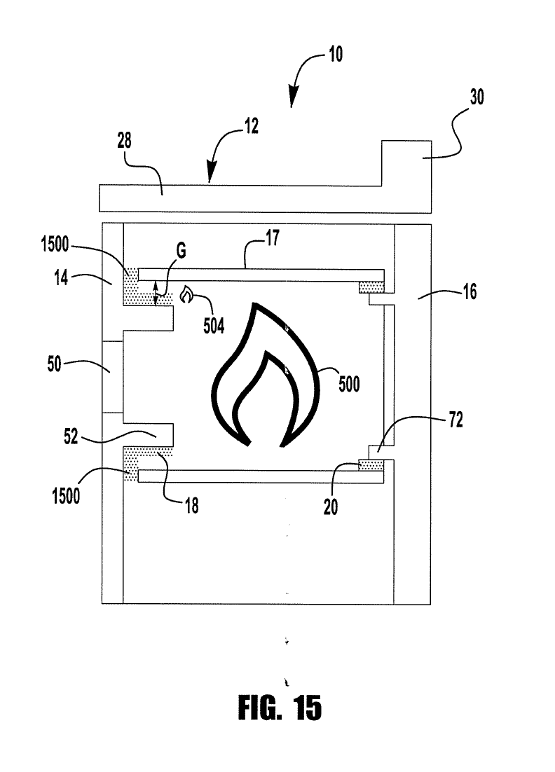

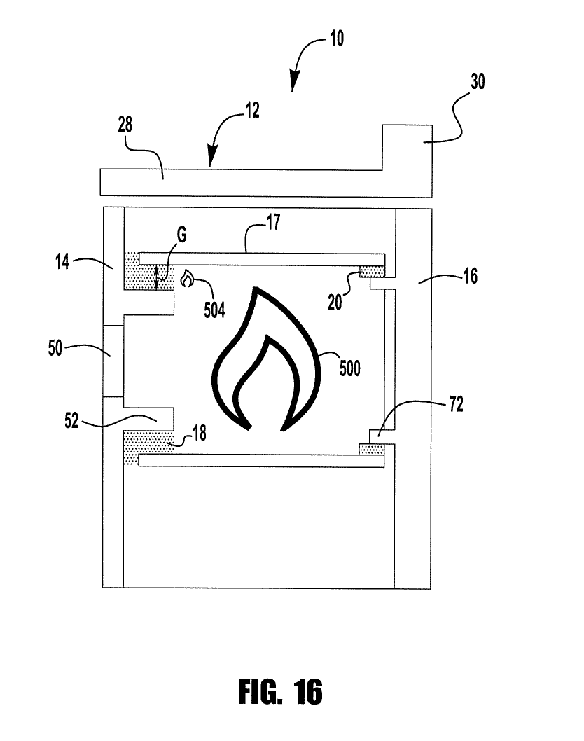

FIGS. 15 and 16 are similar to FIGS. 13 and 14, except the front seal member 18 includes a flange or tab 1500 that extends into a space between the plastic ring 800 and the front bulkhead 14. In this illustrated example, the flange or tab 1500 of the front seal member 18 extends past the plastic ring 800 into a space between the front bulkhead 14 and the drum 17. In an exemplary embodiment, the flange or tab 1500 is made from a material that is able to withstand high temperatures, such as 800 degrees F. and/or prevent flame penetration. In one exemplary embodiment, the flange or tab 1500 is made from the same material as the rest of the front seal member 18. As such, the flange or tab 1500 may also be configured to expand to fill the space between the front bulkhead 14 and the front of the drum 17. In another embodiment, the flange or tab 1500 is made from a material that is different than the material the rest of the front seal member 18 is made from. FIG. 16 illustrates that if the plastic liner or ring 800 ignites, the flange or tab 1500 blocks the additional source of heat 504 from leaving the drum 17 and entering the cabinet 12. FIG. 16 also illustrates that the front seal member is at least partially made from an expandable material. The front seal member 18 expands to prevent the radial gap G from being substantially reduced, and thereby inhibit the drum 17 from tilting forward. The front seal member 18 may be made from any of the materials and have any of the configurations of the front seal member shown and described with respect to FIGS. 13 and 14. In one exemplary embodiment, the flange or tab 1500 or the entire seal 18 illustrated by FIGS. 15 and 16 is made from the material 3800 described below.

As stated above, the front seal member 18 and the rear seal member 20 can have a wide variety of different configurations. Any of the described front seal member configurations described herein can be used for the rear seal member 20 and any of the described rear seal member configurations can be used for the front seal member. FIGS. 22A-27C illustrate additional examples of seal configurations that can be used as the front seal member 18 and/or the rear seal member 20. Any of the exemplary seals shown and described in this application may be adapted to be attached to the drum or the bulkhead and may be inside the drum/outside the bulkhead or outside the drum/inside the bulkhead.

In the example illustrated by FIGS. 22A-22C, the seal member 18, 20 includes a center layer 2280 and two outer layers 2282. However, the seal member 18, 20 may have any number of layers. For example, the seal member 18, 20 may have only a single layer, have two layers, or four or more layers. The center layer 2280 of the illustrated three layer seal member may be made from a material that provides good support for the drum. In one exemplary embodiment, the central layer 2280 is made from a material that is able to withstand elevated temperatures, such as 800 degrees F. Acceptable materials for the center layer that are able to withstand elevated temperatures, such as those seen during UL 2158 static and/or dynamic load fire tests of the dryer include, but are not limited to, fire retardant materials, such as fire retardant nylon, melamine fibers, PAN fibers, any of the fibers listed in Table 1, blends of PAN fibers (or any of the fibers listed in Table 1) and other materials, such as polyester, nylon, bi-component fibers, PET, PET blends, Rayon, any of the materials listed in Table 2, and the like fiberglass, which may be woven or non-woven, blends of fiberglass and other materials, such as polyester, nylon, bi-component fibers, PET, PET blends, Rayon, any of the materials listed in Table 2, and the like, flame resistant cotton shoddy, intamescent material (or other material that swells or expands when heated), blends of intamescent material and other materials, such as polyester, nylon, bi-component fibers, PET, PET blends, Rayon, any of the materials listed in Tables 1 and 2, and the like, and any combination or subcombination of these materials. In another embodiment, the central layer 2280 is made from a material that degrades and/or is consumed when heated to an elevated temperature. One example of an acceptable material for the central layer 2280 that degrades when exposed to elevated temperature is high density polyester, such as non-woven, high density polyester. The center layer may also be made from one or more of the materials listed in Table 2. In one exemplary embodiment, the center layer 2280 of the seal 18, 20 illustrated by FIGS. 22A and 22B is made from the material 3800 described below.

The material of the outer layers 2282 may be selected to minimize friction between the drum 17 and bulkheads 14, 16. In one exemplary embodiment, the outer layers layer 2282 are made from a material that is able to withstand elevated temperatures, such as 800 degrees F. Acceptable materials for the outer layers 2282 that are able to withstand elevated temperatures, such as those seen during UL 2158 static and/or dynamic load fire tests of the dryer include, but are not limited to, fire retardant materials, such as fire retardant nylon, melamine fibers, PAN fibers, any of the materials listed in Table 1, blends of PAN fibers (or any of the materials listed in Table 1) and other materials, such as polyester, nylon, bi-component fibers, PET, PET blends, Rayon, any of the materials listed in Table 2 and the like, fiberglass, which may be woven or non-woven, blends of fiberglass and other materials, such as polyester, nylon, bi-component fibers, PET, PET blends, Rayon, any of the materials listed in Table 2, and the like, flame resistant cotton shoddy, intamescent material (or other material that swells or expands when heated), blends of intamescent material and other materials, such as polyester, nylon, bi-component fibers, PET, PET blends, Rayon, any of the materials listed in Tables 1 and 2, and the like, and any combination or subcombination of these materials. In one exemplary embodiment, the one or both of the outer layers of the seal 18, 20 illustrated by FIGS. 22A and 22B are made from the material 3800 described below.

In another embodiment, the outer layers 2282 are made from a material that degrades and/or is consumed when heated to an elevated temperature. The outer layers 2282 can be made from two different materials. For example, one of the outer layers can be made from a material that is capable of withstanding elevated temperatures, such as 800 degrees F. while the other layer degrades or is consumed when exposed to elevated temperatures, such as 800 degrees F. Either layer can be made of a material that is capable of withstanding high temperatures, such as 800 degrees F. In another exemplary embodiment, the material of the center layer 2280 and/or two outer layers 2282 expands when exposed to elevated temperatures. Examples of suitable materials that can be configured to expand and are able to withstand high temperatures, such as 800 degrees F. include, but are not limited to, polyacrylonitrile (PAN), PAN and nylon blends, PAN and polyester blends, blends of materials listed in Table 1 with materials listed in Table 2.

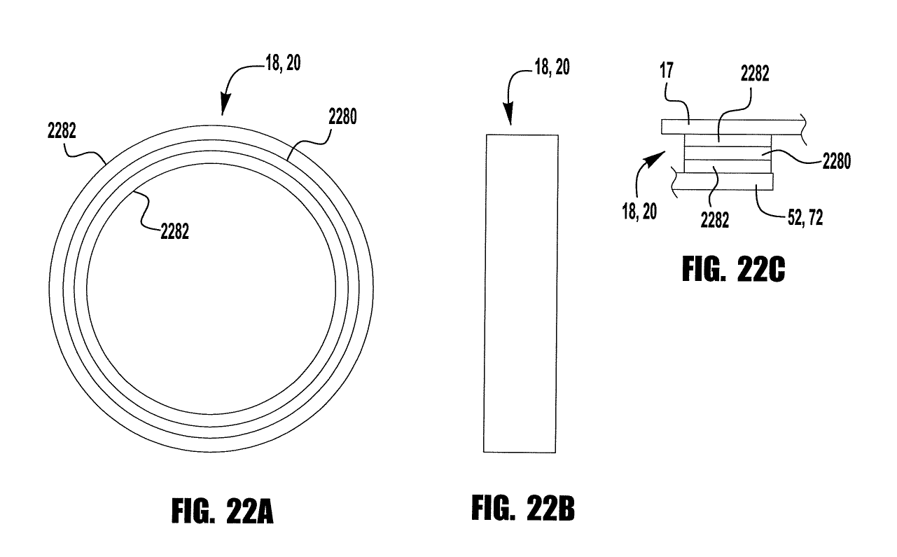

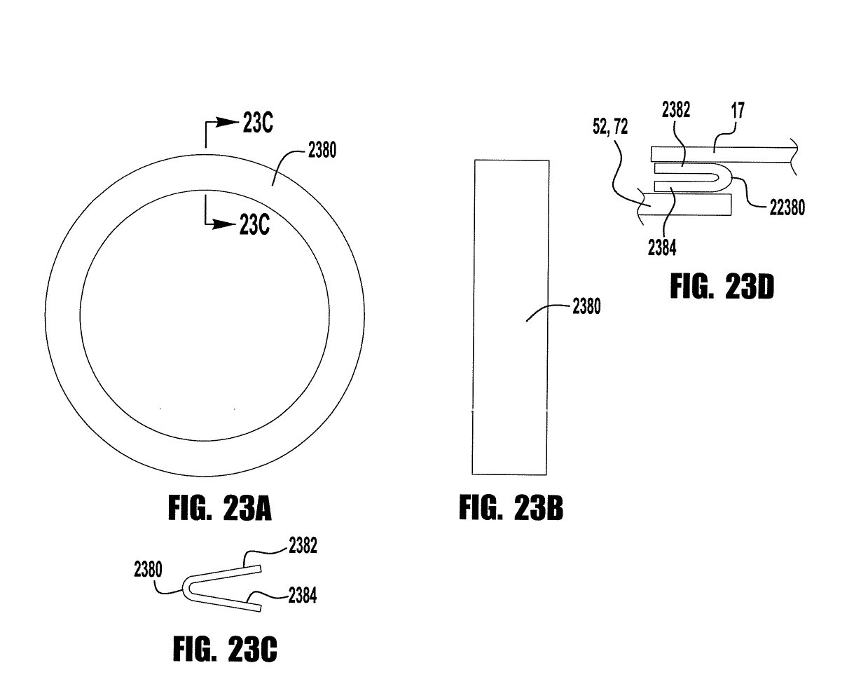

In the example illustrated by FIGS. 23A-23D, the seal member 18, 20 includes a single layer 2380 that is folded into two halves 2382, 2384. However, the seal member 18, 20 may be folded into any number of layers. FIG. 23D shows the seal member 18, 20 installed on a bulkhead support 52 or 72 inside a drum 17. The layer 2380 of the illustrated folded seal member may be made from a material that provides good support for the drum. In one exemplary embodiment, the layer 2380 is made from a material that is able to withstand elevated temperatures, such as 800 degrees F. Acceptable materials for the layer 2380 that are able to withstand elevated temperatures, such as those seen during UL 2158 static and/or dynamic load fire tests of the dryer include, but are not limited to, fire retardant materials, such as fire retardant nylon, melamine fibers, PAN fibers, any of the materials listed in Table 1, blends of PAN fibers (or any of the materials listed in Table 1) and other materials, such as polyester, nylon, bi-component fibers, PET, PET blends, Rayon, any of the materials listed in Table 2, and the like, fiberglass, which may be woven or non-woven, blends of fiberglass and other materials, such as polyester, nylon, bi-component fibers, PET, PET blends, Rayon, any of the materials listed in Table 2, and the like, flame resistant cotton shoddy, intamescent material (or other material that swells or expands when heated), blends of intamescent material and other materials, such as polyester, nylon, bi-component fibers, PET, PET blends, Rayon, any of the materials listed in Tables 1 and 2, and the like, and any combination or subcombination of these materials. In one exemplary embodiment, the layer 2380 of the seal 18, 20 illustrated by FIGS. 23A-23D is made from the material 3800 described below.

In another embodiment, the layer 2380 is made from a material that degrades and/or is consumed when heated to an elevated temperature. One example of an acceptable material for the layer 2380 that degrades when exposed to elevated temperature is high density polyester, such as non-woven, high density polyester. In one exemplary embodiment, the material for the layer comprises one or more of the materials listed in Table 2. The material of the layer 2380 may be selected to minimize friction between the drum 17 and bulkhead support 52, 72. In another embodiment the two halves 2382, 2384 can be made from two different materials. For example, one of the halves can be made from a material that is capable of withstanding elevated temperatures, such as 800 degrees F., while the other half degrades or is consumed when exposed to elevated temperatures, such as 800 degrees F. Either half can be made of a material that is capable of withstanding high temperatures, such as 800 degrees F. In another exemplary embodiment, the material of the layer 2380 expands when exposed to elevated temperatures. Examples of suitable materials that can be configured to expand and are able to withstand high temperatures, such as 800 degrees F. include, but are not limited to, polyacrylonitrile (PAN), any of the materials listed in Table 1, PAN and nylon blends, PAN and polyester blends, blends of any one or more of the materials listed in Table 1 with any one or more of the materials listed in Table 2.

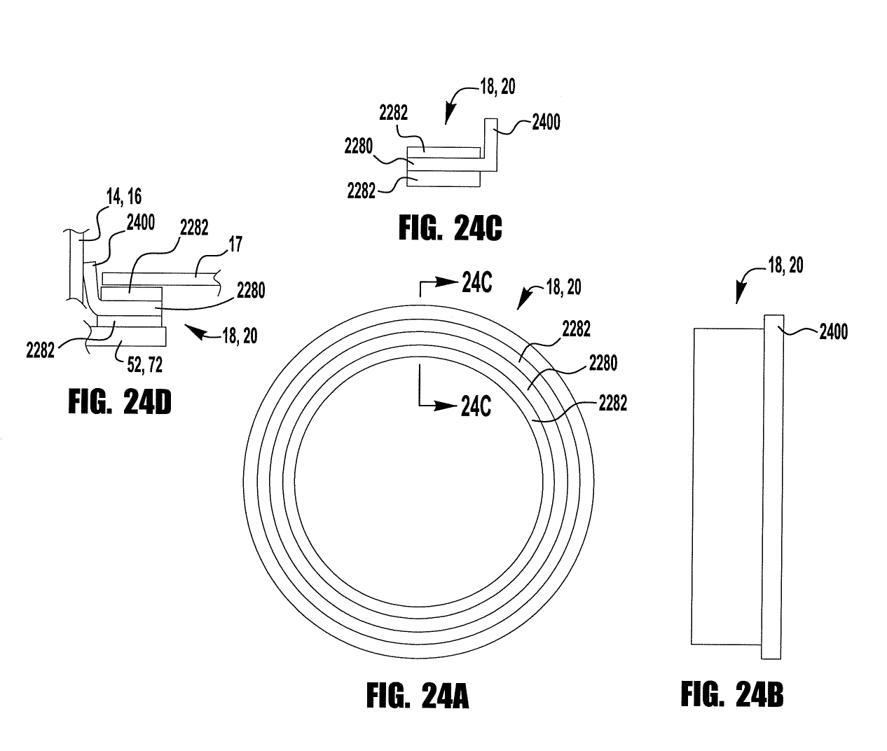

The embodiment of FIGS. 24A-24C is similar to the embodiment of FIGS. 22A-22C, except the seal member 18, 20 includes a flange or tab 2400 that extends into a space between the bulkhead 14 or 16 and the drum 17. In the illustrated embodiment, the flange or tab 2400 is an extension of the center layer 2280. However, the flange or tab 2400 could be an extension of one of the outer layers 2282, an extension of more than one of the layers 2280, 2282, or the tab 2400 could be a separate piece that is connected or coupled to the layers 2280, 2282. In an exemplary embodiment, the flange or tab 2400 is made from a material that is able to withstand high temperatures, such as 800 degrees F. and/or prevents flame penetration. For example, the flange or tab may be made from the material 3800 described below. In one exemplary embodiment, the flange or tab 2400 is made from the same material as one or more of the layers 2280, 2282. In another embodiment, the flange or tab 2400 is made from a material that is different than the materials the rest of the front seal member 18 is made from. For example, the flange or tab 2400 may be made from a material that is capable of withstanding high temperatures, such as 800 degrees F., while the remainder of the seal member 18, 20 is made from a material that degrades and/or is consumed when exposed to high temperatures, such as 800 degrees F. The flange or tab 2400 blocks the source of heat 500 from leaving the drum 17 and entering the cabinet 12. In one exemplary embodiment, the flange or tab 2400 of the seal 18, 20 illustrated by FIGS. 24A-24D is made from the material 3800 described below.

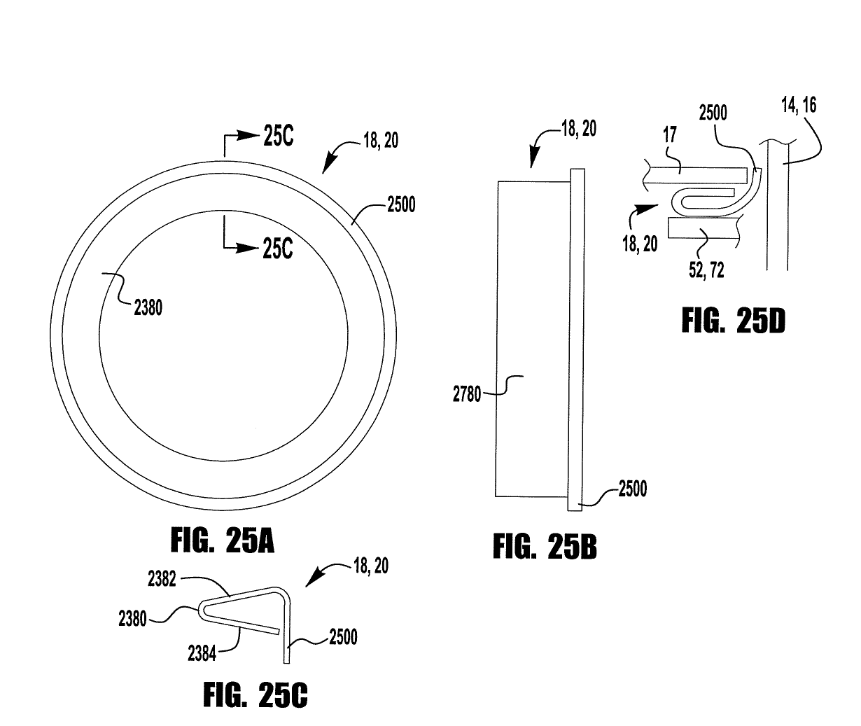

The embodiment of FIGS. 25A-25C is similar to the embodiment of FIGS. 23A-23C, except the seal member 18, 20 includes a flange or tab 2500 that extends into a space between the bulkhead 14 or 16 and the drum 17. In the illustrated embodiment, the flange or tab 2500 is an extension of the half 2382. However, the flange or tab 2500 could comprise extensions of both halves, or the tab 2500 could be a separate piece that is connected or coupled to the layer 2380. In an exemplary embodiment, the flange or tab 2500 is made from a material that is able to withstand high temperatures, such as 800 degrees F. In one exemplary embodiment, the flange or tab 2500 of the seal 18, 20 illustrated by FIGS. 25A-25D is made from the material 3800 described below. In one exemplary embodiment, the flange or tab 2500 is made from the same material as one or more of the halves 2382, 2384. In another embodiment, the flange or tab 2500 is made from a material that is different than the material the layer 2380 is made from. For example, the flange or tab 2500 may be made from a material that is capable of withstanding high temperatures, such as 800 degrees F. and/or prevents flame penetration, while the layer 2380 is made from a material that degrades and/or is consumed when exposed to high temperatures, such as 800 degrees F. The flange or tab 2500 blocks the source of heat 500 from leaving the drum 17 and entering the cabinet 12.

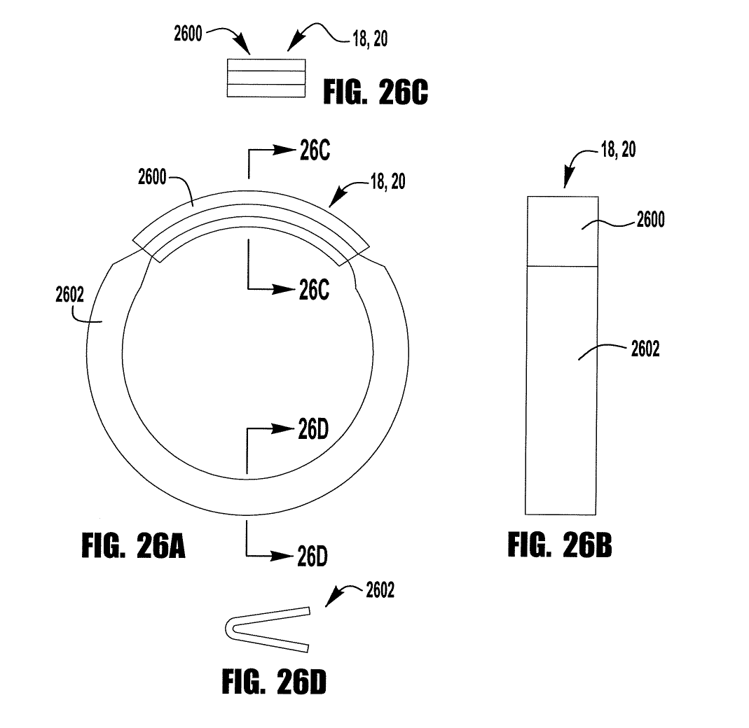

In the example illustrated by FIGS. 26A-26D, the seal member 18, 20 has a first portion 2600 having a first configuration and a second portion 2602 having a second configuration. Each portion 2600, 2602 can have a wide variety of different configurations. For example each portion can have any of the seal configurations disclosed by this patent application. In addition, the seal member 18, 20 may have any number of portions.

The seal members 18, 20 having more than one portion may be attached to a non-moving part of the dryer, such as the support portion 52 of the front bulkhead 14 or the support portion 72 of the rear bulkhead 16. As such, the seal members 52, 72 do not rotate and each portion can be configured to perform a specific task at a specific location. For example, when the drum 17 is positioned outside the support portion 52, 72, most of the weight and resulting friction is applied to the support portion 52, 72 of the bulkhead 14, 16 at the top of the bulkhead. The opposite would be the case if the drum 17 is positioned inside the support portion 52, 72. The first portion 2600 is constructed to be fixedly positioned at the top 2604 of the front or rear bulkhead 14, 16. When the drum is configured to ride on the outside of a bulkhead support portion, the first portion may be configured to have a high strength and low coefficient of friction to support the drum and allow the drum to rotate smoothly. In this example, the second portion 2602 may be constructed to be positioned around the bottom and sides of the front or rear bulkhead 14, 16. Air is more likely to escape from the sides and bottom than at the top 2604, since the weight is supported at the top of the drum when the drum is configured to ride on the outside of a bulkhead support portion. In this example, the second portion 2602 is configured to provide a good seal between the bulkhead and the drum, but may not need to be configured to support a significant amount of weight.

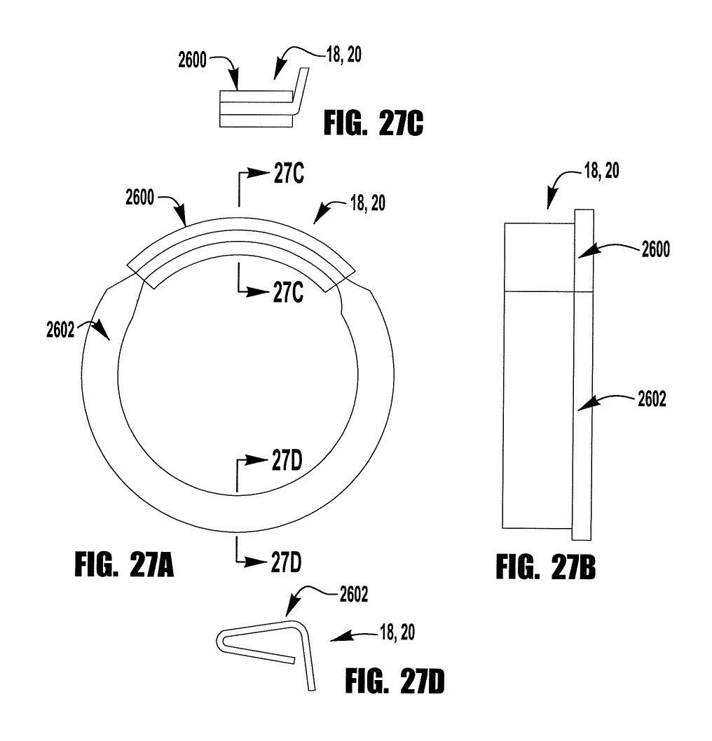

In the example illustrated by FIGS. 26A-26D, the first portion 2600 has the configuration of the seal embodiment illustrated by FIGS. 22A-22C and the second portion has the configuration of the seal illustrated by FIGS. 23A-23D. FIGS. 27A-27D illustrate a similar embodiment where the first portion 2600 has the configuration of the seal embodiment illustrated by FIGS. 24A-24D and the second portion has the configuration of the seal illustrated by FIGS. 25A-25D. In one exemplary embodiment, the first portion 2600 and/or the second portion 2602 of the seals 18, 20 illustrated by FIGS. 26A-26D and FIGS. 27A-27D are made from the material 3800 described below.

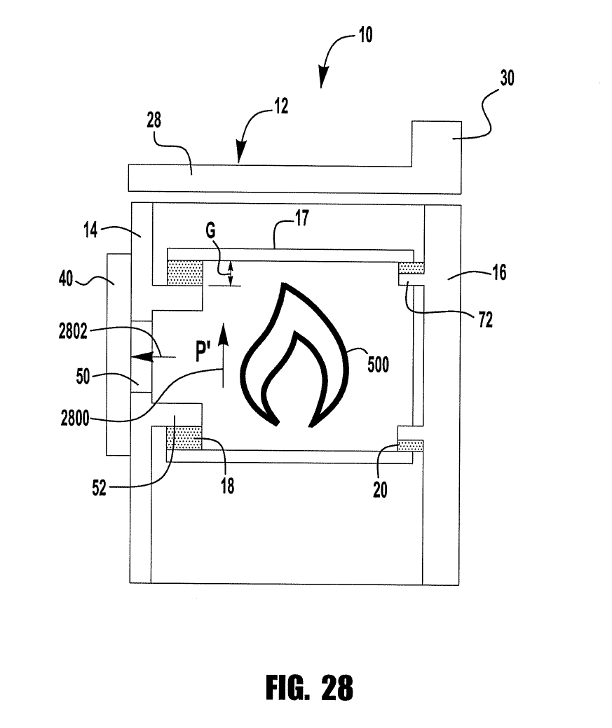

As mentioned above, under some circumstances, a source of heat 500, other than the normal drying heat, may heat the internal volume of the drum to a very high temperature, such as 800 degrees F. For example, a source of heat 500 is provided inside the drum 17 during UL 2158 static and/or dynamic load fire tests. FIG. 28 illustrates that as the internal temperature of the drum is increased by the source of heat 500, the internal pressure P′, if contained in the drum, may also increase as indicated by arrow 2800. This contained pressure P′ may act against the door 40 as indicated by arrow 2802.

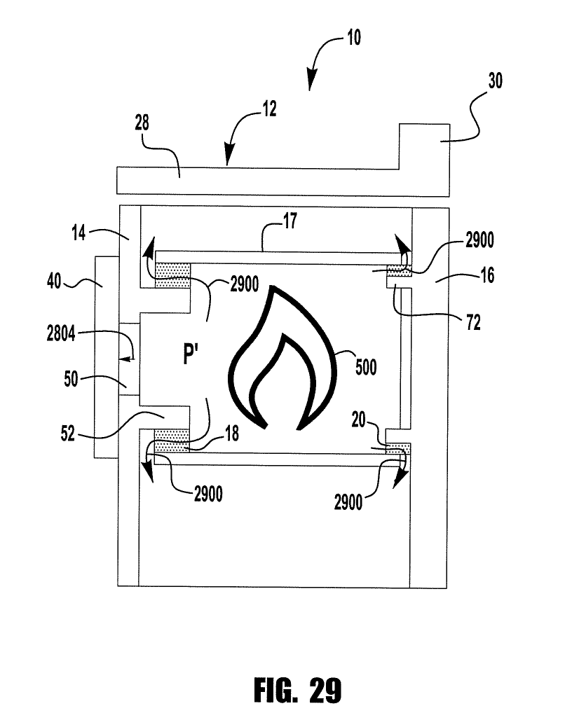

FIG. 29 illustrates one exemplary embodiment, where one or more of the seals 18, 20 are configured to vent, but prevent flame penetration. That is, the seal(s) 18, 20 are configured to allow air under increased pressure (as compared to the pressure inside the drum during normal operation) to escape from the drum 17 into the cabinet 12 through the seal(s) as indicated by arrows 2900. This reduces the pressure applied to the inside of the door as indicated by the smaller arrow 2804 (as compared to arrow 2802 where the pressure P′ is contained in the drum). In an exemplary embodiment, the seal(s) allow the air under increased pressure to escape from the drum 17, while preventing the source of heat 500 from escaping the drum through the seal.

The seal(s) 18, 20 may be configured to allow air under increased pressure to escape from the drum 17 in a wide variety of different ways. In one exemplary embodiment, the seal is constructed from a material that, when exposed to pressures that typically occur inside the drum when the dryer is operated under normal conditions, substantially prevents air inside the dryer from passing through the seal(s) 18, 20. But, when the seal is exposed to pressures that are higher than the pressure inside the dryer under normal conditions, the seal vents air inside the drum 17 into the cabinet. In one exemplary embodiment, the seal may be configured to vent when exposed to pressures that are higher than the pressure inside the dryer under normal conditions, even though the temperature inside the drum is a normal operating temperature. A wide variety of different materials can be used to provide this venting function. One example is a PAN material or a blend of PAN fibers and other components. In one exemplary embodiment, the venting function is provided by one or more of the materials listed in Table 1 or by one or more of the materials listed in Table 1 combined with one or more of the materials listed in Table 2.

In another exemplary embodiment, the seal is constructed from a material that, when exposed to normal operating pressures and substantially increased pressures, air inside the dryer is substantially prevented from passing through the seal(s) 18, 20, as long as the seals are at a normal operating temperature. But, when the seal is exposed to temperatures that are higher than normal operating temperatures, the seal vents air inside the drum 17 into the cabinet. For example, the seals may be configured to vent air when the temperature inside the drum reaches 300 degrees F., 400 degrees F., 500 degrees F., or 600 degrees F. For example, the seals 18 and/or 20 can be made from the material 3800 described below.

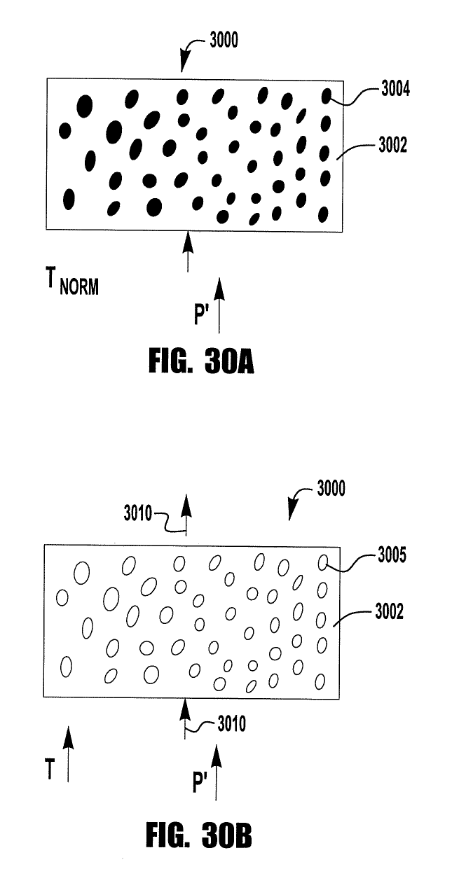

FIGS. 30A and 30B illustrate a seal material 3000 that is made from a first component 3002 and a second component 3004. In FIG. 30A, the seal material 3000 prevents air from flowing through it, even though the pressure P′applied to the seal material is elevated as compared to the normal operating pressure. This is because the second component 3004 substantially fills in the voids 3005 (see FIG. 30 B) of the first component 3002. In FIG. 30A, the material is exposed to the normal operating temperatures Tₙₒᵣₘ of the dryer.

In FIG. 30B, the seal material 3000 is exposed to a substantially higher temperature T as indicated by arrow 3006. When the temperature is substantially increased above the normal operating temperature Tₙₒᵣₘ, the second component no longer substantially fills in the voids 3005 of the first component 3002. For example, the second component 3004 may shrink, be consumed, and/or melt and/or the voids may increase in size. When the voids 3005 are no longer substantially filled, air under pressure can flow through the material 3000 as indicated by arrows 3010, while preventing the source of heat 500 from escaping the drum through the seal. As such, pressure previously contained by the material 3000 is allowed to vent, while containing the source of heat 500 in the drum. The seal material 3000 may be made from a wide variety of different materials. Examples include, but are not limited to, PAN and nylon blends, PAN and polyester blends, and blends of one or more of the materials listed in Table 1 with one or more of the materials listed in Table 2. The material may be configured to change from the state illustrated by FIG. 30A to the state illustrated by FIG. 30B when the temperature inside the drum reaches 300 degrees F., 400 degrees F., 500 degrees F., or 600 degrees F.

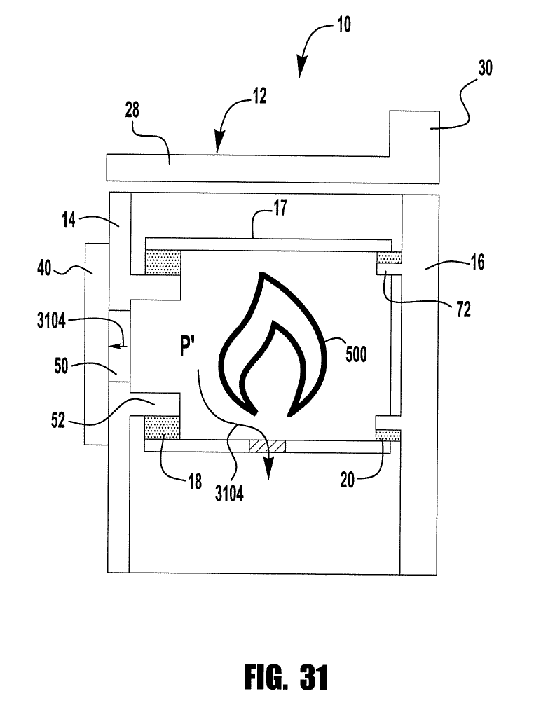

FIG. 31 illustrates an embodiment similar to the embodiment of FIG. 29, except in addition to or instead of seals 18, 20 that are configured to vent, the dryer 10 includes a vent device 3100 that allows air to exhaust from the drum 17 if the pressure P′inside the drum rises. The vent device 3100 is configured to allow air under increased pressure (as compared to the pressure inside the drum during normal operation) to escape from the drum 17 into the cabinet 12 through the vent device 3100 as indicated by arrow 3102, while preventing the source of heat 500 from escaping the drum through the seal or the vent device. This reduces the pressure applied to the inside of the door as indicated by the smaller arrow 3104.

In an exemplary embodiment, the vent device 3100 allows the air under increased pressure to escape from the drum 17, while preventing the source of heat 500 from escaping the drum. The vent device can take a wide variety of different forms. In the example illustrated by FIG. 31, the vent device 3100 allows air under pressure to escape into the cabinet through the wall of the drum 17. However, in other embodiments, the vent device may allow the air under pressure to escape through the front bulkhead 14, the rear bulkhead 16, and/or past the seal(s) 18, 20.

The vent device 3100 can have any configuration that allows air under increased pressure to escape from the drum 17. In one exemplary embodiment, the vent device 3100 is constructed such that, when exposed to pressures that typically occur inside the drum when the dryer is operated under normal conditions, the vent device 3100 substantially prevents air inside the dryer from exiting the drum 17. But, when the vent device 3100 is exposed to pressures that are higher than the pressure inside the dryer under normal conditions, the vent device vents air inside the drum 17 into the cabinet and/or out of the dryer. In one exemplary embodiment, the vent device 3100 may be configured to vent when exposed to pressures that are higher than the pressure inside the dryer drum under normal conditions, even though the temperature inside the drum is a normal operating temperature.

In another exemplary embodiment, the vent device is constructed such that, when exposed to normal operating pressures and substantially increased pressures, the vent device 3100 substantially prevents air inside the dryer from passing out of the drum 17. But, when the vent device 3100 is exposed to temperatures that are higher than normal operating temperatures, the vent device 3100 vents air inside the drum 17 into the cabinet 12 and/or out of the dryer, while preventing the source of heat 500 from escaping the drum through the seal.

The vent device can be a mechanical device that opens and/or closes when exposed to elevated temperatures and/or pressures. In one exemplary embodiment, the vent device 3100 may comprise the material of the embodiment illustrated by FIGS. 30A and 30B or the material 3800 described below. A wide variety of different devices and/or material can be configured to open a vent automatically when a temperature inside the drum 17 is raised to a temperature that is higher than the normal operating temperature. For example, the vent can be configured to vent air when the temperature inside the drum reaches 300 degrees F., 400 degrees F., 500 degrees F., 600 degrees F., 700 degrees F., 800 degrees F., 900 degrees F. or 1000 degrees F.

Referring to FIG. 32, the dryer 10 includes wiring 600, electrical control components 602, such as the control unit 36, and other components that could potentially be damaged by exposure to heat 502 from the source of heat 500. The wiring 600 provides electrical power to and/or from a variety of different components of the dryer 10. For example, the wiring 600 may provide electrical power to and/or from one or more of a power input (not shown), the control panel 30, the motor 86 that rotates the drum 17, a heater 204, and a blower 214.

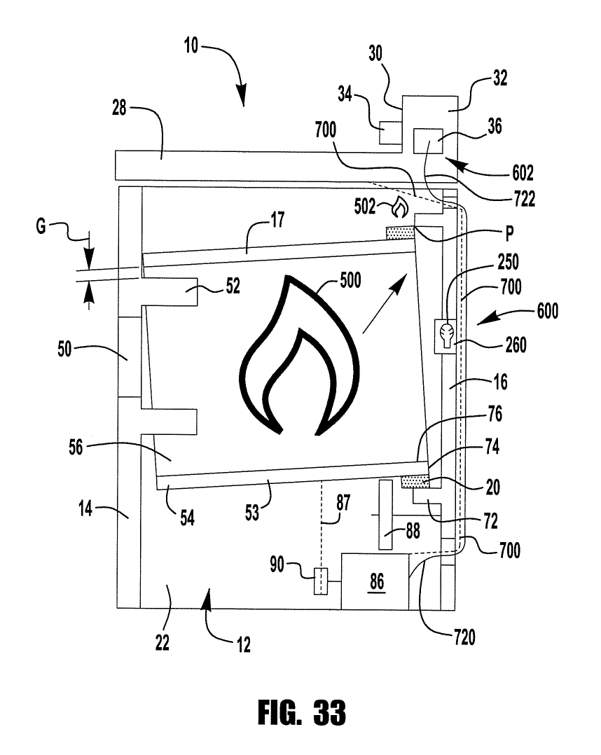

FIG. 33 illustrates an exemplary embodiment where one or more heat shields 700 are provided to shield the wiring 600, electrical control components 602, and/or other components from heat 502 from the source of heat 500. This embodiment, where one or more heat shields 700 are provided, can be implemented with the embodiments where the dryer is configured to substantially maintain the radial gap G and thereby prevent the tilting of the drum shown in FIG. 5 when the front seal member 18 is exposed to high temperatures and/or the dryer is put through UL 2158 static and/or dynamic load fire tests and the exemplary embodiment where the front seal member 18 is configured to deteriorate when the temperature inside the drum is high.

The heat shields 700 can take a wide variety of different forms, can be placed at a variety of different locations in the dryer 10, and can be made from a wide variety of different materials. The heat shields 700 may be in tubular, sheet, or any other form that allows the heat shields to be placed between the heat 502 from the source of heat 500 and the wiring 600, electrical control components 602, and/or other components. The heat shields 700 can be any material that provides a temperature difference between metal components of the dryer, such as the rear bulkhead 16, the drum 17, a housing 260 of the light 250, etc., and the wiring 600, electrical control components 602, etc. The heat shields prevent the heat source 500 from passing through the heat shield and consuming components shielded by the heat shield. Any material that keeps the wiring 600, electrical control components 602, etc. from touching metal components of the dryer can be used. In one exemplary embodiment, the heat shields 700 are made from a lofted material to provide a gap between the wiring 600, electrical control components 602, etc. and the metal components. In one exemplary embodiment, the heat shield 700 is made from a material that does not melt when exposed to high temperatures, such as 800 degrees F. In one exemplary embodiment, the heat shields 700 are made from a material that allows airflow through the material, unlike metal walls or solid panels, but prevent flame penetration. The use of materials that “breathe” provides for better airflow in the cabinet. In one exemplary embodiment, the heat shields are soft, which prevents the heat shields from causing acoustic issues due to vibration. Examples of materials that the heat shields can be made from include, but are not limited to, fire retardant materials, such as fire retardant nylon, melamine fibers, PAN fibers, any of the materials listed in Table 1, blends of PAN fibers and other materials, such as polyester, nylon, bi-component fibers, PET, PET blends, Rayon, any of the materials that are listed in Table 2, and the like, fiberglass, which may be woven or non-woven, blends of fiberglass and other materials, such as polyester, nylon, bi-component fibers, PET, PET blends, Rayon, any of the materials listed in Table 2, and the like, flame resistant cotton shoddy, intamescent material (or other material that swells or expands when heated and/or prevents flame penetration), blends of intamescent material and other materials, such as polyester, nylon, bi-component fibers, PET, PET blends, Rayon, any of the materials listed in Tables 1 and 2, and the like, and any combination or subcombination of these materials. In one exemplary embodiment, the expandable material is configured to at least double in thickness when exposed to high temperatures and/or the dryer is put through UL 2158 static and/or dynamic load fire tests. For example, a 3/16″ thick expandable material may expand to a 1″ thickness or more.

In one exemplary embodiment, one or more of the heat shields 700 are made from fibers that can be exposed to a high temperature for a long duration before drawing of the fibers. If the fiber draws back in response to the application of a flame, a hole could form in the material of the seal member and the flame could pass through the hole. In one exemplary embodiment, the seal member 18 is made from fibers that can be exposed to a 1000° F. or higher temperature for several hours, such as eight or more hours, before drawing of the fibers. One type of fiber that does not draw when exposed to a high temperature for a long period of time is PAN fibers that have been oxidized, so that the PAN fiber will not burn. In one exemplary embodiment, one or more of the heat shields 700 are made from the material 3800 described below. Any material capable of preventing heat 502 from the source of heat 500 from damaging and/or burning the wiring 600, electrical control components 602, and/or other components when the temperature in the drum 17 is high and/or the dryer is put through UL 2158 static and/or dynamic load fire tests can be used.

One or more heat shields 700 may be provided between the drum and the wiring harness that prevents melting and/or burning of wire insulation of the wiring harness when a temperature inside the drum is high. For example, in the embodiment illustrated by FIG. 33, a heat shield 700 is positioned between the drum 17 and wires 722 that are disposed inside the cabinet 12 and extend above the top/rear of the drum 17, near the possible heat 502 from the heat source 500. In the example illustrated by FIG. 33, a heat shield 700 is provided between the housing 260 of the light 250 and the wiring 600. In the example illustrated by FIG. 33, a heat shield 700 is positioned between the wires 722 that are connected to the motor 86 and the drum 17 and rear bulkhead 16. In the example illustrated by FIG. 33, a heat shield 700 is provided between the break in the seal 20 that provides the exit path P and the top panel 28 that includes the control unit 36. This heat shield may or may not also act to shield wires of the wiring harness 600. By including the heat shield(s) 700, the wiring 600, electrical control components 602, and/or other components are protected even though the radial gap G substantially diminishes and the drum 17 tilts forward.

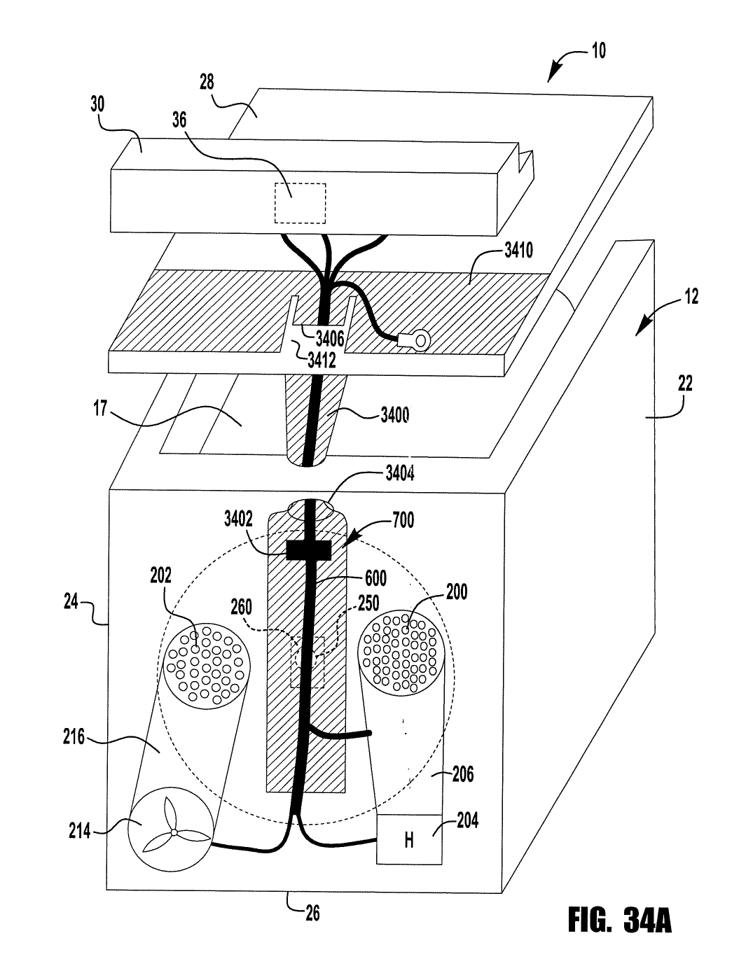

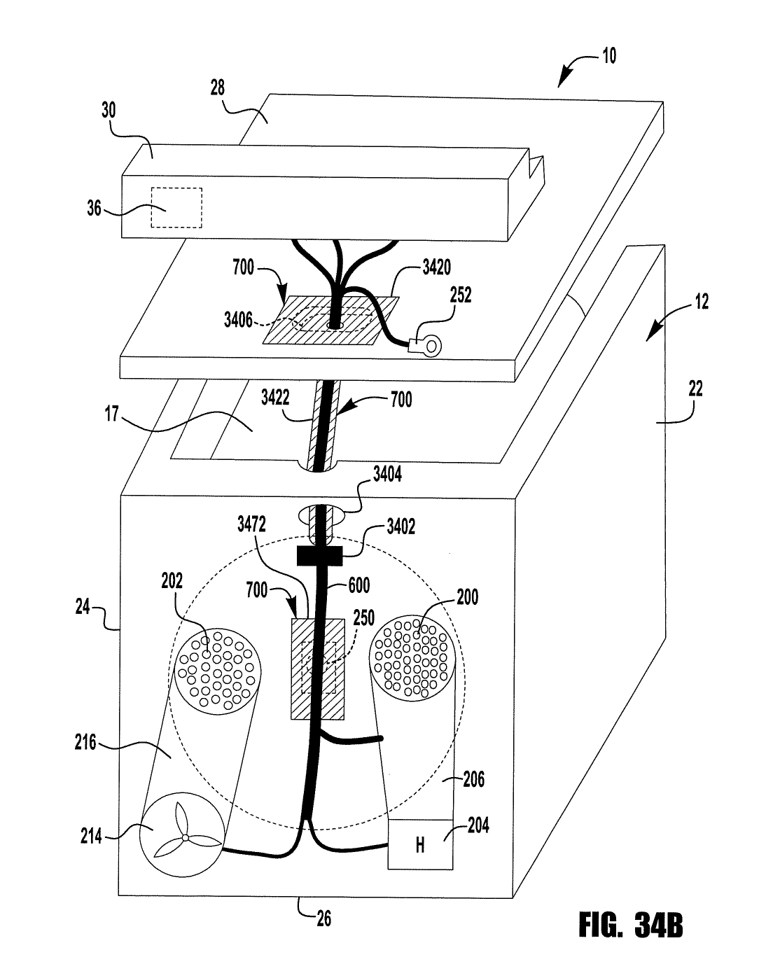

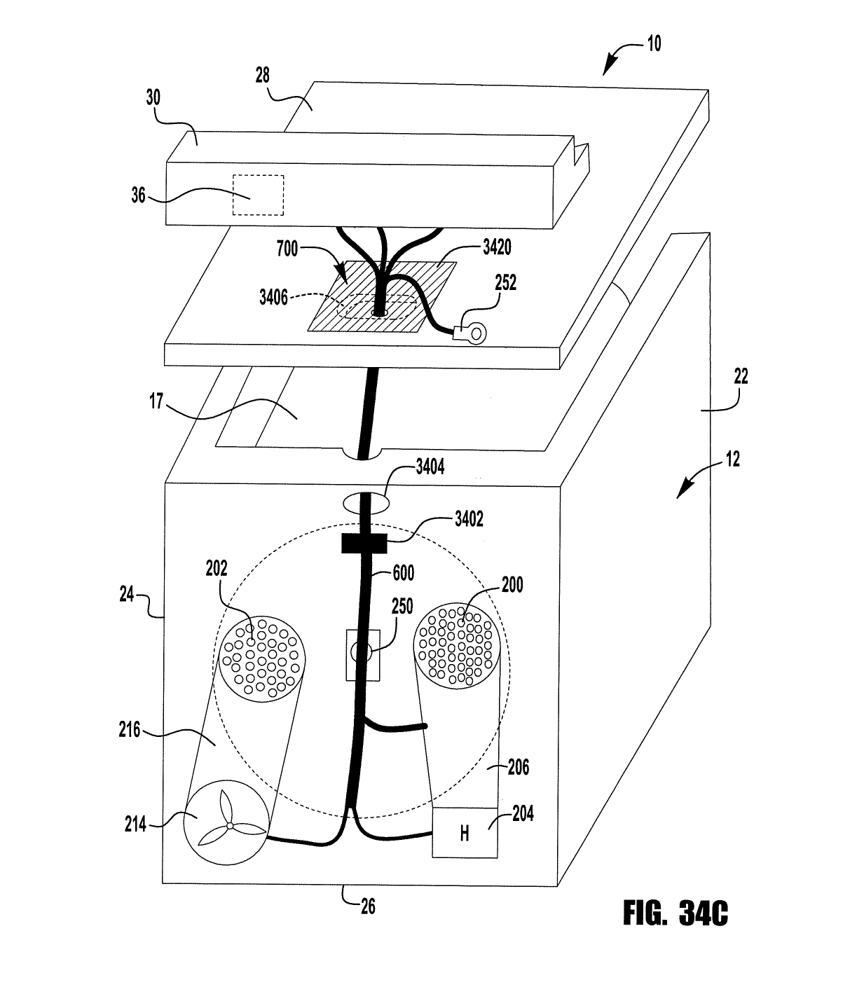

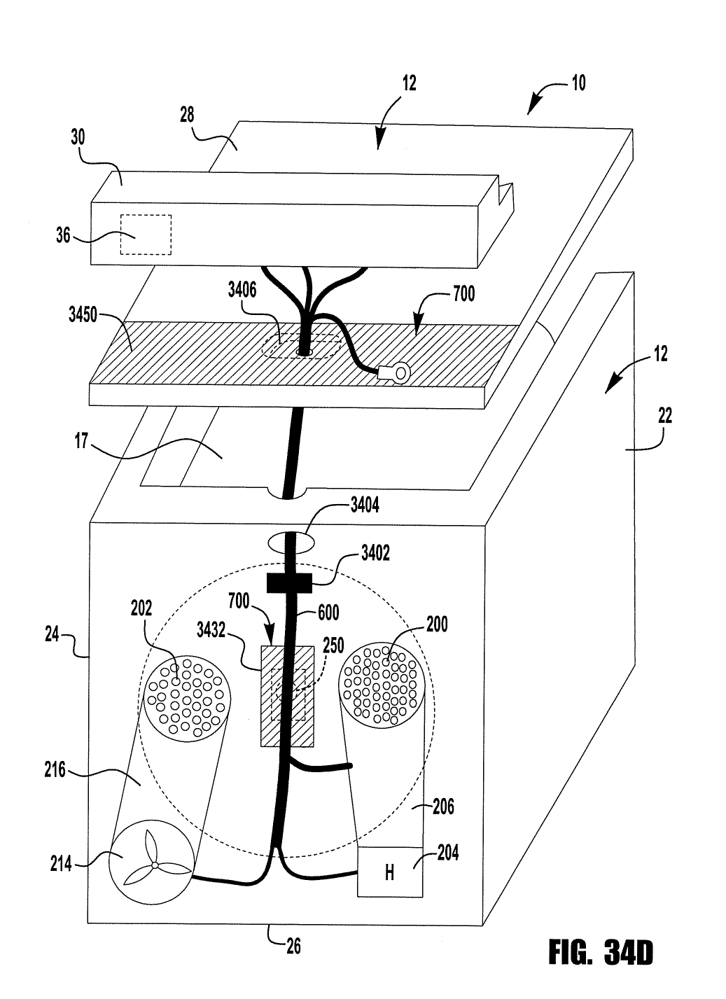

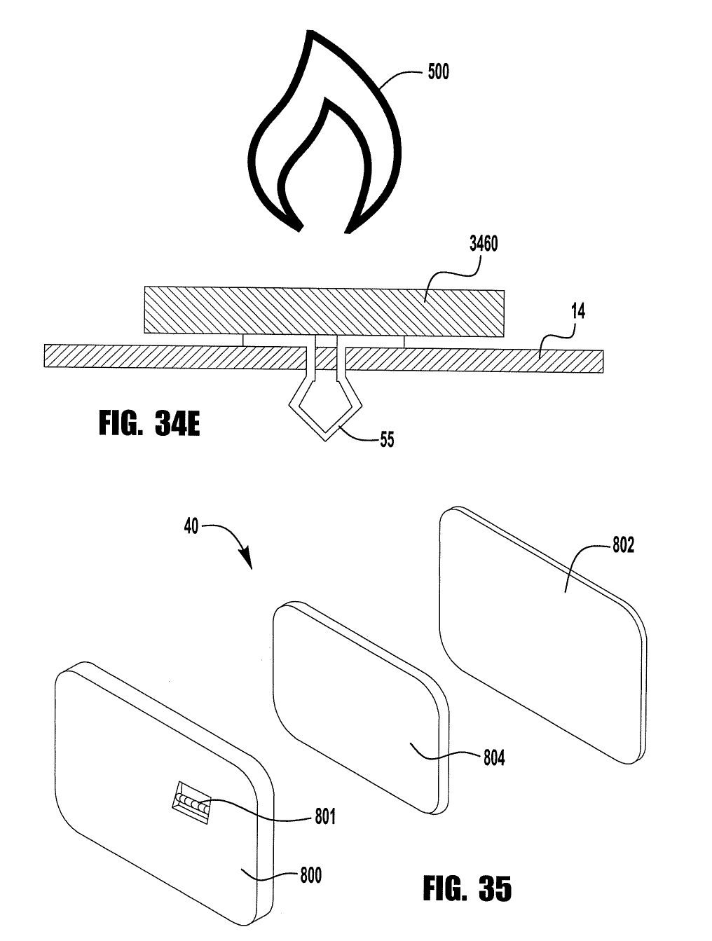

Referring to FIGS. 34A-34E, the heat shields 700 can be positioned and configured in a wide variety of different ways. In the example illustrated by FIG. 34A, the heat shield 700 has a “T” shape. The leg 3400 of the “T” extends between the rear bulkhead 16 and the wiring 600. The leg 3400 of the “T” is also positioned between the housing 260 of the drum light 250 and the wiring 600. The leg 3400 of the “T” may be positioned between a terminal block 3402 and the rear bulkhead 16. The leg 3400 of the “T” is between the duct 206 and the duct 216. The leg of the “T” is extends through a wall of the rear bulkhead 16 and into the cabinet 12 at an opening 3404. Inside the cabinet 12, the leg 3400 of the “T” is positioned between the upper, rear end of the drum 17 and the wiring 600 (see also FIG. 33). The leg 3400 of the “T” extends through a wall of the top panel 28 and out the cabinet 12 at an opening 3406, where the leg 3400 meets the top 3410 of the “T”. The top 3410 of the “T” substantially covers a rear area of the top panel 28 where the control panel or console 30 meets the top panel 28.

In the illustrated embodiment, a small area 3412 is not covered in the area of overlap between the top panel 28 and the console 30. In other embodiments, the entire area of overlap between the top panel 28 and the console 30 is covered by the heat shield 700 and/or the opening 3406 is substantially or completely filled by the heat shield 700. By substantially covering or completely covering the area of overlap between the top panel 28 and the console 30, the control panel or console 30 is protected from the source of heat 500. This allows the console 30 to be made from a plastic material, which may make it easier to match the design of the console 30 with the design of a console of a washing machine intended to be used with the dryer 10. The control panel or console 30 is protected even if there are holes or other openings in the top panel 28 in the area of overlap between the top panel 28 and the console 30. In the illustrated embodiment, the top 3410 is positioned on top of the top panel 28. It should be understood that the top 3410 of the “T” can be secured to the bottom of the top panel 28 and have substantially the same effect.

In the examples illustrated by FIG. 34B-34E, discrete heat shields 700 are used. It should be apparent that any number of discrete heat shields can be used and any one or more of the heat shields 700 shown in FIGS. 34B-34E or any of the embodiments of the application can be used in any combination or sub-combination. In the example illustrated by FIGS. 34B and 34C, a top opening heat shield 3420 covers, fills, and/or plugs the opening 3406 and/or surrounds, clamps against, and/or restrains the wiring 600. The top opening heat shield may be configured to expand or swell to completely fill the opening 3406 when exposed to high temperature. In the example illustrated by FIG. 34B, a wiring wrap heat shield 3422 surrounds a portion of the wiring 600. The wiring wrap heat shield 3422 may have a tubular form that is disposed around the wiring or the wiring wrap heat shield 3422 may be wrapped around the wiring 600. The wiring wrap heat shield 3422 may be connected to the top opening heat shield 3420 to eliminate any chance that the source of heat 500 can escape through the opening 3406. In one embodiment, an end of the wiring wrap heat shield 3422 is expanded at the opening 3406 to fill or cover the opening to eliminate the need for a top opening heat shield 3420. In the examples illustrated by FIGS. 34B and 34D, a drum light heat shield 3432 is positioned between the housing 260 of the drum light 250 and the wiring 600.

In the example illustrated by FIG. 34D, a top panel heat shield 3450 covers a rear area of the top panel 28 where the control panel or console 30 meets the top panel. In the illustrated embodiment, the entire area of overlap between the top panel 28 and the console 30 is covered by the top panel heat shield 3450 and/or the opening 3406 is substantially or completely filled by the top panel heat shield 3450. By substantially covering or completely covering the area of overlap between the top panel 28 and the console 30, the control panel or console 30 is protected from the source of heat 500. This allows the console 30 to be made from a plastic material, which may make it easier to match the design of the console 30 with the design of a console of a washing machine intended to be used with the dryer 10. The control panel or console 30 is protected even if there are holes or other openings in the top panel 28 in the area of overlap between the top panel 28 and the console 30. In the illustrated embodiment, the top panel heat shield 3450 is positioned on top of the top panel 28. It should be understood that the top panel heat shield 3450 can be secured to the bottom of the top panel 28 and have substantially the same effect.

In the example illustrated by FIG. 34E, a door latch component heat shield 3460 covers the door latch component 55 from behind the front bulkhead 14. By substantially covering or completely covering the door latch component, the door latch component 55 is protected from the source of heat 500. By protecting the door latch component 55 from the source of heat 500, the door (FIG. 1) is prevented from inadvertently opening. In one exemplary embodiment, the latch component 55 is made from steel and the heat shield 3460 prevents the steel from reaching its transition temperature. In another exemplary embodiment, the latch component 55 is made from plastic and the heat shield 3460 prevents the plastic from melting.

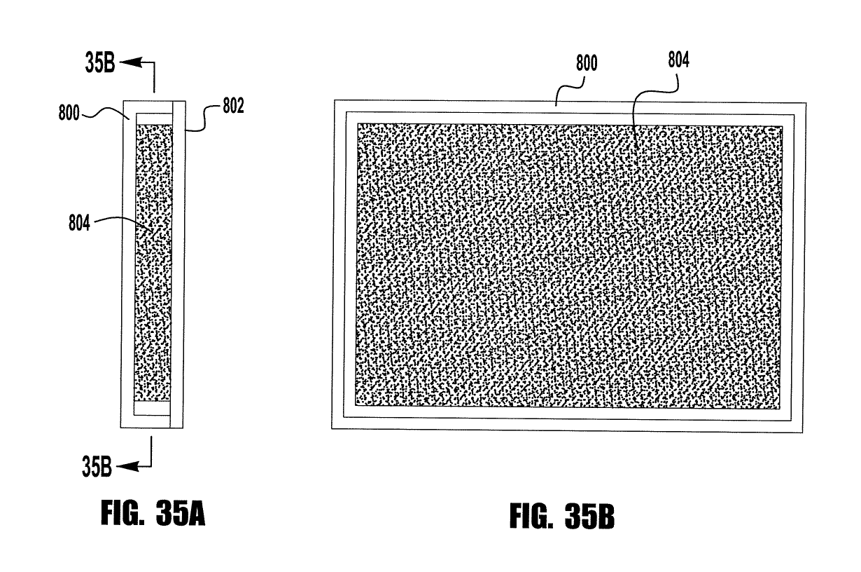

The door 40 can have a wide variety of different configurations. In the example illustrated by FIG. 35, the door 40 includes an outer panel 800 with an optional handle 801, an inner panel 802 attached to the outer panel, and a thermal and/or acoustic insulator 804 disposed between the inner panel and the outer panel. Referring to FIG. 35A, in one exemplary embodiment, the insulator 804 contacts the outer panel 800 and the inner panel 802. Without the insulator, if a heavy object in the drum 17, such as a shoe, were to impact the inner panel 802, the inner panel would generate a significant amount of noise. The insulator 804 that is in contact with the inner panel 800 and the inner panel 802 significantly reduces the sound caused by the impact

The insulator 804 can take a wide variety of different forms. The insulator 804 may be a board, batting, a sheet, loose fill, have an expandable die cut configuration or have any other form that allows the insulator 804 to be placed between the outer panel 800 and the outer panel 802. In one exemplary embodiment, the insulator 804 is made from a material that does not burn when the door 40 is closed and a temperature inside the drum is high and/or the dryer is put through UL 2158 static and/or dynamic load fire tests. Examples of materials that the insulator 804 can be made from include, but are not limited to, fire retardant materials, such as fire retardant nylon, melamine fibers, PAN fibers, any of the materials listed in Table 1, blends of PAN fibers (or any of the materials listed in Table 1) and other materials, such as polyester, nylon, bi-component fibers, PET, PET blends, Rayon, any of the materials listed in Table 2, and the like fiberglass, which may be woven or non-woven, blends of fiberglass and other materials, such as polyester, nylon, bi-component fibers, PET, PET blends, Rayon, any of the materials listed in Table 2, and the like, flame resistant cotton shoddy, intamescent material (or other material that swells or expands when heated), blends of intamescent material and other materials, such as polyester, nylon, bi-component fibers, PET, PET blends, Rayon, any of the materials listed in Tables 1 and 2, and the like, and any combination or subcombination of these materials.

In one exemplary embodiment, the insulator 804 is made from fibers that can be exposed to a high temperature for a long duration before drawing of the fibers. This drawing refers to pulling back or shrinking of the fibers due to exposure to the high temperature. If the fiber draws back in response to the application of a flame, a hole could form in the material of the insulator 804 and the flame could pass through the hole. In one exemplary embodiment, the insulator 804 is made from fibers that can be exposed to a 1000° F. or higher temperature for several hours, such as eight or more hours, before drawing of the fibers. In one exemplary embodiment, the insulator 804 is made from the material 3800 described below.

In the example illustrated by FIGS. 35A and 35B, the insulator 804 is in the form of a blanket. The blanket illustrated by FIGS. 35A and 35B has a uniform, continuous cross-section across the width of the blanket. That is, there are no gaps, cutout, or openings defined in the blanket. In other embodiments, the insulator 804 is a blanket having an open or honeycomb configuration. That is, there are multiple cutouts or openings defined throughout the blanket. Insulators having an open or honeycomb configuration can be formed in a wide variety of different manners. For example, openings can be cut into a blanket having a uniform, continuous cross-section, a blanket can be formed with the openings in the blanket, such as by molding, or the blanket may be a die cut expandable member. In yet another embodiment, the insulator 804 may be a blanket having both a uniform, continuous cross-section portion and a portion having cutouts or openings.

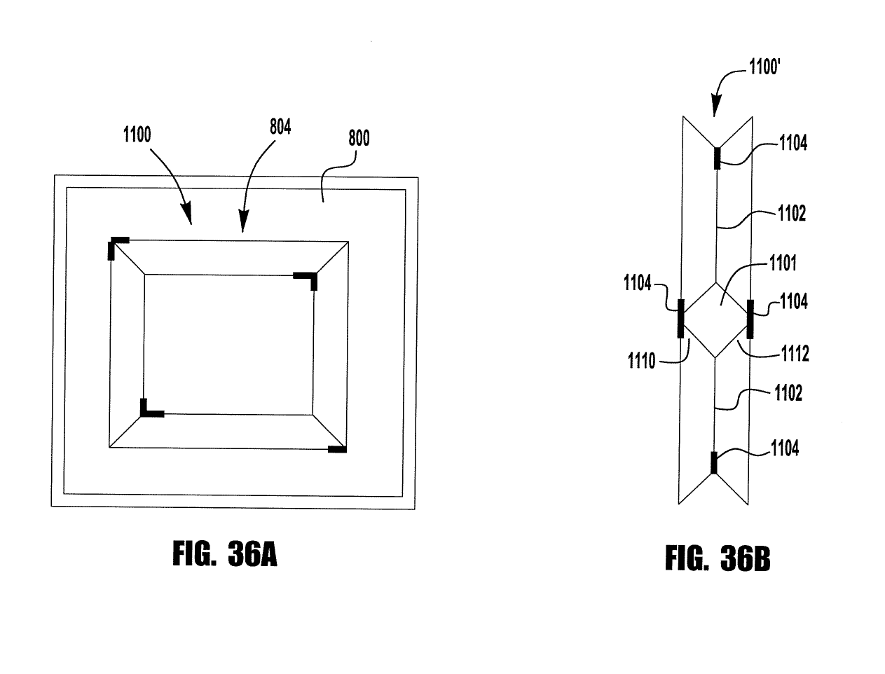

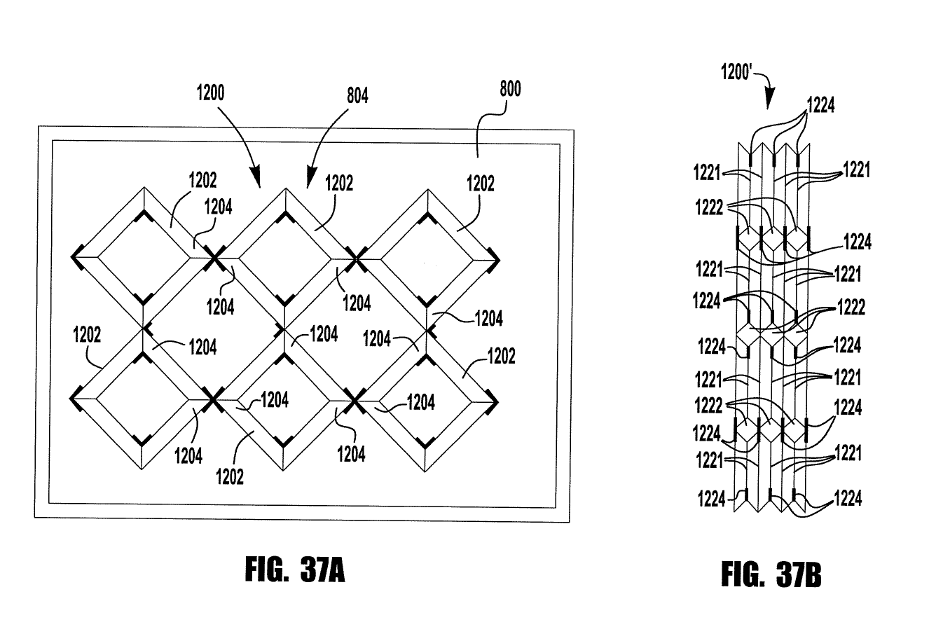

FIGS. 36A, 36B, 37A, and 37B, illustrate two examples of die cut expandable members 1100, 1200 that can be used as the insulator 804. The expandable members 1100, 1200 are illustrated as being positioned on one of the door panels 800. The expandable members 1100, 1200 may be sandwiched between and contact both of the door panels as described above to significantly reduce noise. The die cut expandable members 1100, 1200 can have a wide variety of different configurations. FIGS. 36A, 36B, 37A, and 37B illustrate two of the many possibilities. In the example, illustrated by FIGS. 36A, 36B, the die cut expandable member has a rectangular or “picture frame” configuration. The configuration illustrated by FIG. 36A is produced by cutting the member 1100′ shown in FIG. 36B to form the square opening 1101 and along the thin lines 1102 and not cutting the areas indicated by the thick lines 1104. The corners 1110, 1112 of the member 1100′ shown in FIG. 11B can be pulled apart to produce the picture frame configuration shown in FIG. 36A. The insulator 804 may be produced using other methods to have the “picture frame” configuration shown in FIG. 11A.

In the example, illustrated by FIGS. 37A, 37B, the die cut expandable member has a plurality of interconnected rectangular portions 1202. Corners 1204 of each rectangular portion 1202 are connected to other rectangular portions to form a grid or honeycomb configuration. The configuration illustrated by FIG. 37A is produced by cutting the member 1200′ shown in FIG. 37B to form the square openings 1222 and along the thin lines 1221 and not cutting the areas indicated by the thick lines 1224. Sides of the member 1200′ shown in FIG. 12B can be pulled apart to form the member 1200 shown in FIG. 37A. The insulator 804 may be produced using other methods to have the configuration shown in FIG. 37A. Further details of die cut expandable members can be found in U.S. Pat. No. 7,923,092, and US Published Patent Application Pub. Nos. 2008/0317996 and 2006/0008614 which are incorporated herein by reference in its entirety.

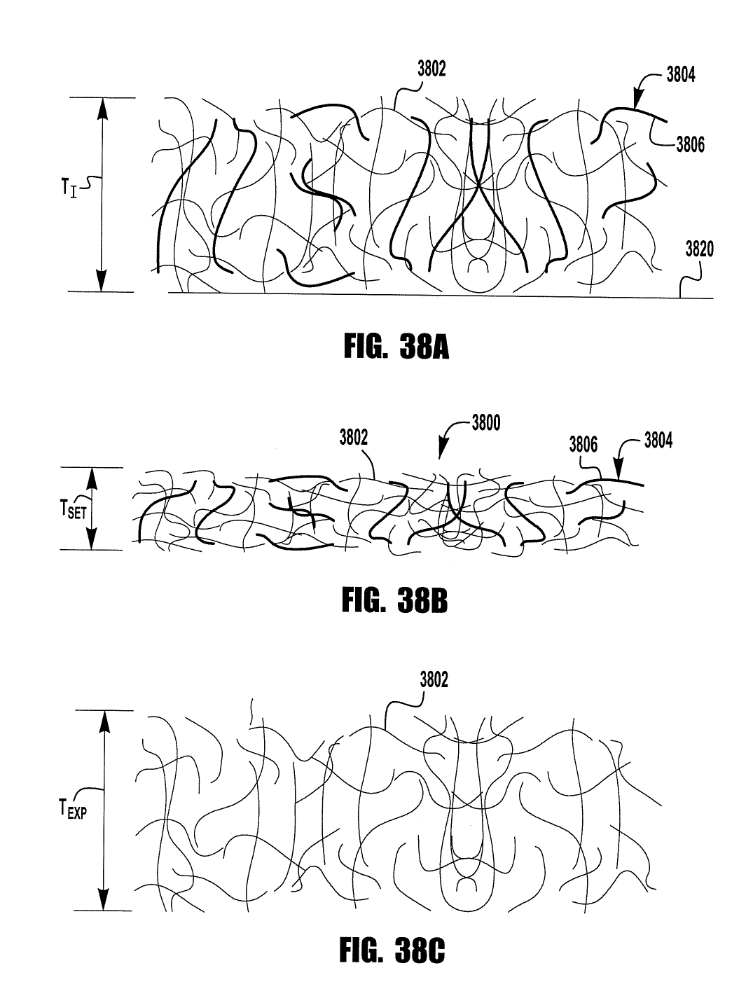

FIGS. 38B, 41B, 45 schematically illustrate exemplary embodiments of non-woven fabrics 3800. The non-woven fabrics 3800 can be used in a wide variety of different applications. For example, the non-woven fabrics can be used in any of the components of the dryer 10 that include or could include fabric. For example, any of the dryer seals, vent devices, heat shields, or insulators disclosed by this application can be made from the non-woven fabrics 3800 or can have parts or portions made from the non-woven fabrics 3800. The front and/or rear seals 18, 20, the vent device 3100, the heat shields 700, and/or the insulators 804 can be made from the non-woven fabrics 3800 or can have parts or portions made from the non-woven fabrics 3800. The non-woven fabrics 3800 may also be used in a wide variety of other applications.

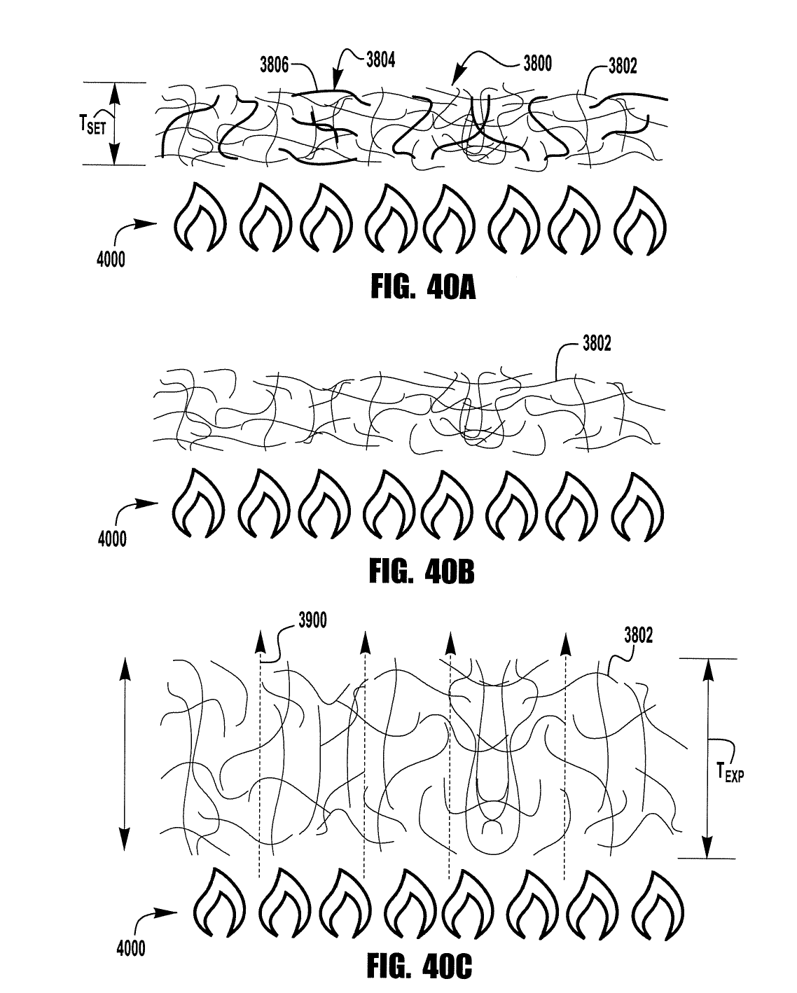

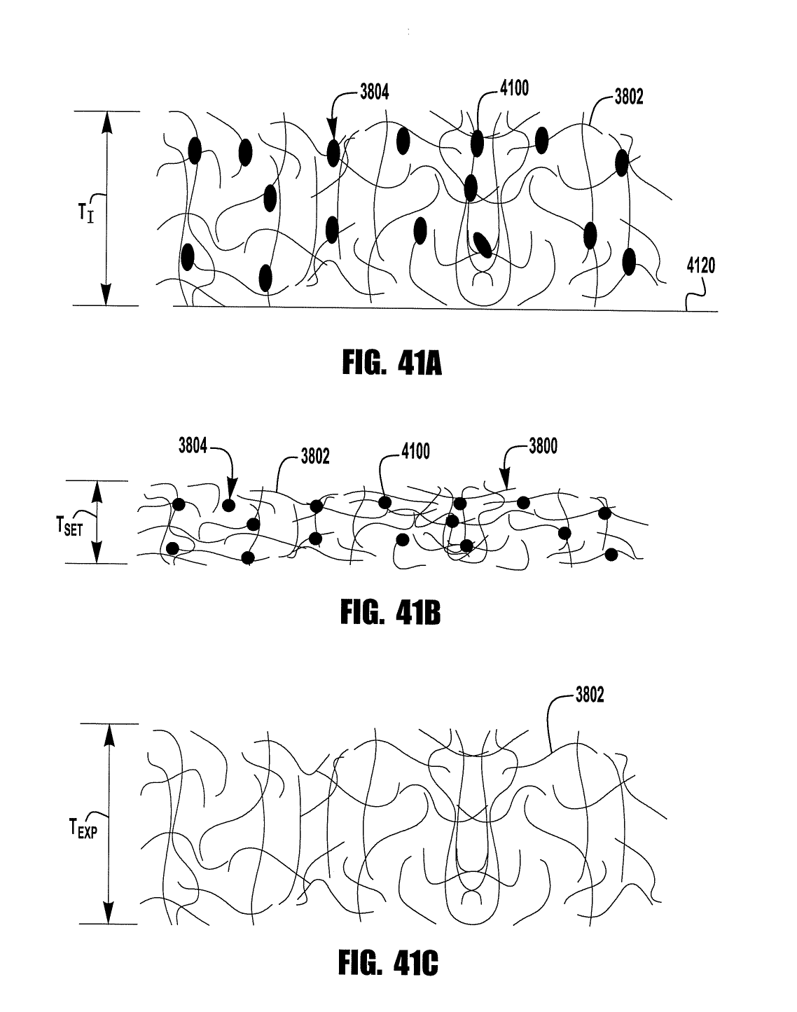

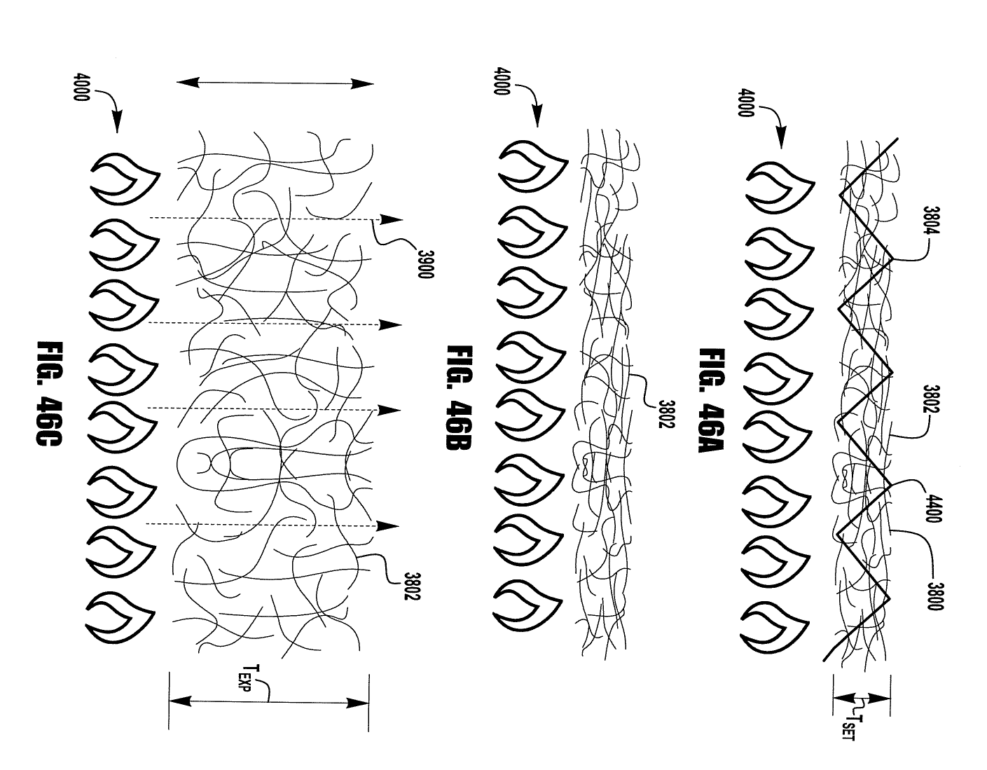

The non-woven fabrics can take a wide variety of different forms. FIGS. 38B and 41B illustrate two exemplary embodiments of non-woven fabrics 3800. The non-woven fabrics 3800 illustrated by FIGS. 38B and 41B include flame retardant fibers 3802 (thinner fibers in the drawings for illustrative purposes only) and binding material 3804 mixed with the flame retardant fibers. The binding material 3802 is cured or otherwise processed to set the thickness T_{Set} of the fabric 3800 as will be described in more detail below. The binding material 3804 can take a wide variety of different forms. In the example illustrated by FIG. 28B, the binding material 3804 is a binding fiber 3806 (thicker/darker fibers in the drawings for illustrative purposes only). In the example illustrated by FIG. 41B, the binding material 3804 is a material 4100 other than a fiber. For example, the binding material 4100 may be a powder, or a liquid adhesive material. FIG. 45 illustrates an exemplary embodiment of a fabric 3800 made from non-woven flame retardant fibers 3802 and stitches 4400 made from binding material. In this application, this fabric is also referred to as a non-woven fabric, since the flame retardant fibers are non-woven. In another exemplary embodiment, the binding material 3804 may be a combination of binding fibers 3806, other binding materials 4100, such as powders and/or liquids, and/or stitches 4400.

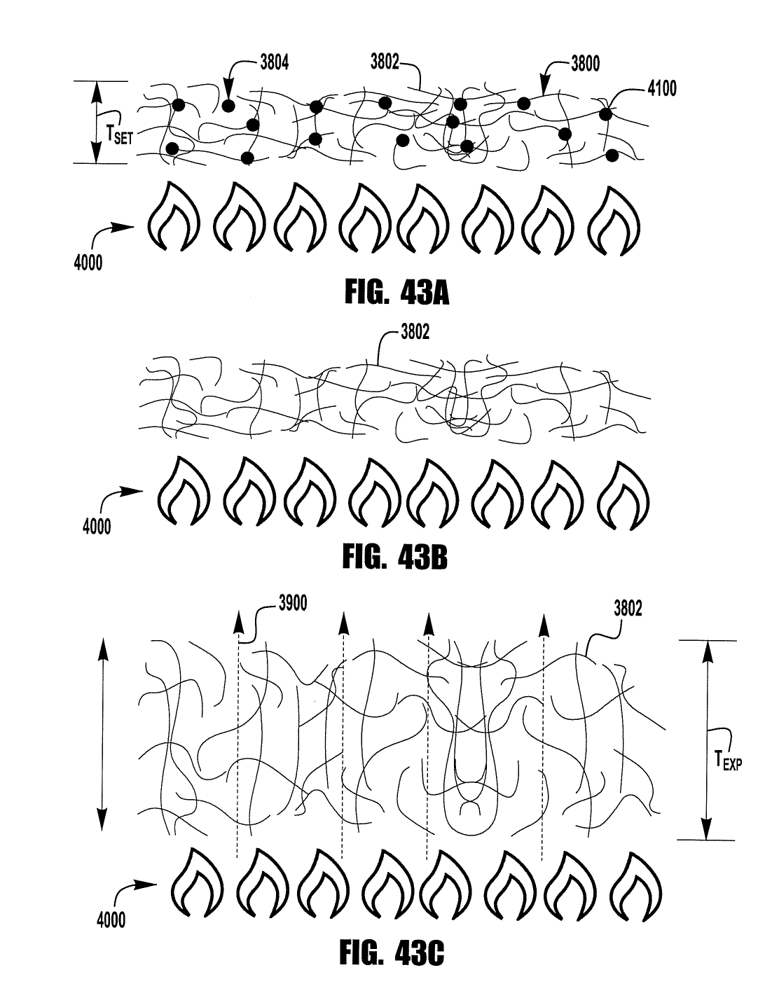

Referring to FIGS. 40A-40C, 43A-43C, and 46A-46C, in an exemplary embodiment, the non-woven fabric is configured such that application of a source 4000 of high heat, such as a flame, to the fabric 3800 causes the fabric to expand. In the example illustrated by FIGS. 40A and 43A, the source of high heat 4000 is a flame applied to the fabric. For example, the flame may be a 1000° F. flame, a 1500° F. flame or a 1000° F. to 1500° F. flame. Referring to FIGS. 40B, 43B and 46C, the application of the flame causes the binding material 3804 to degrade (for example, burn, melt, transition to a gas phase, or otherwise deteriorate), but the flame retardant fibers 3802 remain intact or substantially intact. In one exemplary embodiment, in addition to remaining intact or substantially intact, the flame retardant fibers can be exposed to a high temperature for a long duration before drawing of the fibers. This drawing refers to pulling back or shrinking of the fibers due to exposure to the high temperature. If the fiber draws back in response to the application of a flame, a hole could form in the fabric and the flame could pass through the hole. In one exemplary embodiment, the flame retardant fibers 3802 can be exposed to a 1000° F. or higher temperature for several hours, such as eight or more hours, before drawing of the fibers. One type of fiber that does not draw when exposed to a high temperature for a long period of time is PAN fibers that have been oxidized, so that the PAN fiber will not burn.

In one exemplary embodiment, the binding material 3804 is selected to melt and transition to a gas phase, without burning or substantial burning, when a 1000° F. to 1500° F. flame is applied to the fabric. Referring to FIGS. 40C, 43C, and 46C, when the binding material 3804 degrades due to the application of the flame 4000, the flame retardant fibers 3802 expand such that the thickness T_{Set} of the non-woven material increases by a factor of at least 1½ or two to an expanded thickness T_{Exp}. In one exemplary embodiment, the ratio of the expanded thickness T_{Exp} to the initial or set thickness T_{Set} is about 1.5 or two to about six. In an exemplary embodiment, the expanded thickness T_{Exp} is closer to the initial air laid thickness T₁ than the set thickness T_{Set}. In an exemplary embodiment, the expanded thickness T_{Exp} is from about 40% to about 100% of the initial air laid thickness T₁. In an exemplary embodiment, the expanded thickness T_{Exp} is from about 60% to about 100% of the initial air laid thickness T₁. In an exemplary embodiment, the expanded thickness T_{Exp} is about the same as the initial air laid thickness T₁. The airflow resistance decreases as the thickness increases from the set thickness T_{Set} to the thickness T_{Exp}.

Table 3, provided below, lists examples of fabrics 3800 configured such that when the binding material 3804 degrades due to the application of the flame 4000, the flame retardant fibers 3802 expand such that the thickness T_{Set} increases to an expanded thickness T_{Exp}. In each of the examples provided in Table 1, the material is made up of a 65/35 ratio of oxidized Polyacrylonitrile fibers to polyester bi-component fibers. The oxidized Polyacrylonitrile fibers and the polyester bi-component fibers are air laid at 12 mm loft, and then surface treated (i.e. compressed and heated) to form the fabric with the set thickness T_{Set}. In the examples provided by Table 1, the samples are exposed to a 500° F. heat source or flame for 30 minutes, which causes the fabrics to swell.

TABLE 3
Examples of Fabrics and Expansion Properties

| | | | | | Reloft | |
|---|---|---|---|---|---|---|
| Sample | | | | | (T_{Exp}/ | Reloft |
| No. | Weight | T_{Set} | T_{Exp} | T_{I} | T_{Set}) | (T_{Exp}/T_{I}) |
| 1 | 250 GSM | 1.6 mm | 4.91 mm | 12 mm | 3.07 | 0.41 |
| 2 | 250 GSM | 3.0 mm | 7.125 mm | 12 mm | 2.37 | 0.59 |
| 3 | 400 GSM | 4 mm | 11.75 mm | 12 mm | 2.94 | 0.98 |

The fabrics 3800 may be configured to expand upon the application of a source 4000 of high heat in a variety of different ways. For example, referring to FIG. 38A, flame retardant fibers 3802 and binding fibers 3806 may be deposited onto a substrate 3820 at an initial thickness T₁. The flame retardant fibers 3802 and the binding fibers 3806 may be deposited on the substrate at the initial thickness T₁ by one or a combination of non-woven manufacturing techniques, such as drylaid, airlaid, and/or spunlaid/meltblown techniques. However, any technique for depositing the flame retardant fibers 3802 and/or the binding fibers 3806 an initial thickness T₁. may be used.

Referring to FIGS. 38A and 38B, the thickness is reduced from the initial thickness T₁ (FIG. 38A) to the set thickness T_{Set} (FIG. 38B) and the binding fibers 3806 are set to set the thickness T_{Set}. The airflow resistance increases as the thickness decreases from the initial thickness T₁ to the set thickness T_{Set}. This thickness reduction and setting can be accomplished in a variety of different ways. For example, a laminator type process that densifies the surfaces of the deposited flame retardant fibers 3802 and binding fibers 3806 can be used. Or, the thickness reduction and setting can comprise compressing the deposited flame retardant fibers 3802 and binding fibers 3806 and then setting the binding fibers (See FIGS. 48-50). The binding fibers may be set in a variety of different ways. For example, the binding fibers 3806 may be set by heating and then cooling and/or chemical reaction.

Referring to FIGS. 38B and 38C, the properties of the flame retardant fibers 3802, the manner in which the flame retardant fibers are deposited on the substrate, and the amount of reduction from the initial thickness TI to the set thickness TSet are selected such that when the binding fibers deteriorate, the flame retardant fibers 3802 expand from the set thickness TSet by a factor of at least two to the expanded thickness TExp. In an exemplary embodiment, the expanded thickness TExp is closer to the initial thickness TI than the set thickness TSet. In an exemplary embodiment, the expanded thickness TExp is substantially the same as the thickness TI.

The resiliency or ability of the fabric 3800 is determined by a variety of different characteristics of the fibers. One characteristic of the fibers is whether, to what extent, and how the fibers are crimped. In one exemplary embodiment, any of the fibers of any of the materials described in this application may be crimped. For example, the flame retardant fibers 3802 and/or binding fibers 3806 of the fabric 3800 may be crimped. In one exemplary embodiment, the flame retardant fibers 3802 are crimped and the binding fibers 3806 are not crimped or the fabric 3800 includes a non-fiber type (i.e. aqueous or powder type) binding material 3804. In another embodiment, the fabric 3800 includes crimped binding fibers 3806, but the flame retardant fibers 3802 are not crimped. In another exemplary embodiment, the fabric 3800 includes both crimped binding fibers and crimped flame retardant fibers.

A fiber crimp is a bend, kink, curl, or wave of a fiber that gives the fiber the ability to provide more loft and resiliency to a fabric. Crimp is the waviness of the fiber. That is, crimp is the condition in which the axis of a fiber under minimum external stress departs from a straight line and follows a simple or a complex or an irregular wavy path. In its simplest form, crimp is uniplanar and regular. That is, the crimped fiber resembles a sine wave, but the crimped fiber is frequently much more complicated and irregular. An example of three-dimensional crimp is helical or spiral. Crimp may be expressed numerically as the number of waves (crimps) per unit length, or as the difference between the distance between two points on the fiber when it is relaxed and when it is straightened under suitable tension, expressed as a percentage of the relaxed distance. The crimping of the fibers provides increased swelling or expansion of the material when heat is applied to the material.

When a fabric 3800 having fire retardant fibers 3802 that are crimped are exposed to a flame, the binding material 3804 degrades. When the binding material 3804 degrades, the flame retardant fibers 3802 are released by the binding material 3804. The crimp of the released flame retardant fibers 3802 causes the flame retardant fibers to spring back to their relaxed state and cause the fabric to expand to a greater extent than if the flame retardant fibers were not crimped.

When a fabric 3800 having binding fibers 3806 that are crimped are exposed to a flame, the bonds of the binding fibers 3806 to the flame retardant fibers degrades before the binding fibers are consumed. The crimp of the heated binding fibers 3806 causes the binding fibers to tend to spring to their relaxed state and cause the fabric to expand to a greater extent than if the binding fibers were not crimped.

FIG. 40A schematically illustrates the application of a source of high heat 4000, such as a flame, to the fabric 3800. FIG. 40B illustrates that the binding fibers 3806 melt, transition to a gas state, burn, and/or otherwise deteriorate. However, in the exemplary embodiment, the flame retardant fibers 3806 do not burn, melt, or otherwise significantly deteriorate as a result of the application of the source of high heat 4000. FIG. 40C illustrates that, as a result of the burning, melting, transitioning to a gas phase, and/or other deterioration of the binding fibers 3806, the flame retardant fibers 3806 expand from the initial thickness to the expanded thickness TExp. The airflow resistance decreases as the thickness increases from the set thickness TSet to the thickness TExp. In an exemplary embodiment, the airflow resistance at the expanded thickness TExp is lower than the airflow resistance of the initial thickness T₁, since some or all of the binding material 3804 melts, transitions to a gas state, burns, and/or otherwise deteriorates when the source of high heat 4000 is applied to the fabric.

FIGS. 41A-41C illustrate fabrics 3800 containing binding materials 4100 other than binding fibers 3806. Referring to FIG. 41A, flame retardant fibers 3802 may be deposited on a substrate 4120 at an initial thickness T₁. A binding material 4100, such as particulate adhesive and/or liquid adhesive may be deposited with the flame retardant fibers 3802 on the substrate 4120. Or, the flame retardant fibers 3802 may first be deposited on to a substrate 4120 and then the binding material 4100 is applied to the flame retardant fibers 3802. The flame retardant fibers 3802 and the binding material 4100 may be deposited on the substrate at the initial thickness T₁ by one or a combination of non-woven manufacturing techniques, such as drylaid, airlaid, and wetlaid techniques. However, any technique for depositing the flame retardant fibers 3802 and binding material 4100 an initial thickness T₁. may be used.

Referring to FIGS. 41A and 41B, the thickness is reduced from the initial thickness T₁ (FIG. 41A) to the thickness T_{Set} (FIG. 41B) and the binding material 4100 is set to set the thickness T_{Set}. The airflow resistance increases as the thickness is reduced from the initial thickness T (FIG. 41A) to the thickness T_{Set} (FIG. 41B). This thickness reduction and setting can be accomplished in a variety of different ways. For example, a laminator type process that densifies the surfaces of the deposited flame retardant fibers 3802 and binding material 4100 can be used. The thickness reduction and setting can comprise compressing the deposited flame retardant fibers 3802 and then setting the binding material 3804. For example, the thickness reduction and setting can be performed by molding, such as compression molding, or laminating. The binding material may be set in a variety of different ways. For example, the binding material 4100 may be set by heating and then cooling, drying, and/or chemical reaction.

Referring to FIGS. 41B and 41C, the properties of the flame retardant fibers 3802, the manner in which the flame retardant fibers are deposited on the substrate, and the amount of reduction from the initial thickness T₁ to the set thickness T_{Set} are selected such that when the binding material deteriorates (for example, melt, transition to a gas phase, and/or burn), the flame retardant fibers 3802 expand from the set thickness T_{Set} by a factor of at least two to the expanded thickness T_{Exp}. In an exemplary embodiment, the expanded thickness T_{Exp} is closer to the initial thickness T₁ than the set thickness T_{Set}. In an exemplary embodiment, the expanded thickness T_{Exp} is substantially the same as the thickness T₁. FIG. 43A schematically illustrates the application of a source of high heat 4000, such as a flame, to the fabric 3800. FIG. 43B illustrates that the binding material 3806 melts, transitions to a gas phase, burns and/or otherwise deteriorates. However, in the exemplary embodiment, the flame retardant fibers 3802 do not burn, melt, or otherwise significantly deteriorate as a result of the application of the source of high heat 4000. FIG. 43C illustrates that, as a result of the melting, transitioning to gas phase, burning, and/or other deterioration of the binding material 3806, the flame retardant material 3802 expands from the initial thickness to the expanded thickness T_{Exp}.

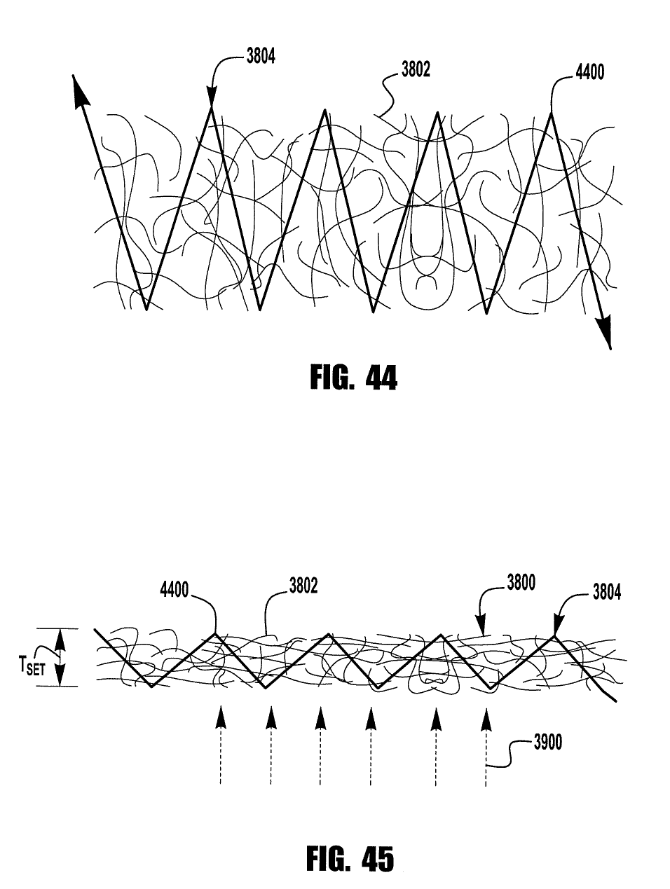

FIGS. 44 and 45 illustrate another exemplary embodiment of a fabric 3800 that is configured to expand upon the application of a source 4000 of high heat. Referring to FIG. 44, flame retardant fibers 3802 may be deposited on a substrate at an initial thickness T₁. A binding thread 4400, which may be made from any of the materials that the binding fibers 3806 are made from, are stitched or sewn through the flame retardant fibers. The binding threads 4400 are tightened to reduce the thickness from the initial thickness T₁ (FIG. 44) to the thickness T_{Set} (FIG. 45). While FIGS. 44 and 45 schematically illustrate a single thread or stitch, any number, type, or configuration of threads or stitches can be used to reduce the thickness from the initial thickness T₁ (FIG. 44) to the thickness T_{Set} (FIG. 45). Further, any combination of the manners of reducing the thickness from the initial thickness T₁ (FIG. 44) to the set thickness T_{Set} (FIG. 45) disclosed in this application can be used.

Referring to FIGS. 46A-46C, the properties of the flame retardant fibers 3802, the manner in which the flame retardant fibers are deposited on the substrate, and the amount of reduction from the initial thickness T₁ to the set thickness T_{Set} are selected such that when the binding material deteriorates (for example, melt, transition to a gas phase, and/or burn), the flame retardant fibers 3802 expand from the set thickness T_{Set} by a factor of at least two to the expanded thickness TExp. In an exemplary embodiment, the expanded thickness TExp is closer to the initial thickness T₁ than the set thickness T_{Set}. In an exemplary embodiment, the expanded thickness T_{Exp} is substantially the same as the thickness T₁. FIG. 46A schematically illustrates the application of a source of high heat 4000, such as a flame, to the fabric 3800. FIG. 46B illustrates that the threads 4400 melt, transition to a gas phase, or otherwise deteriorate. However, in the exemplary embodiment, the flame retardant fibers 3802 do not burn, melt, or otherwise significantly deteriorate as a result of the application of the source of high heat 4000. FIG. 46C illustrates that, as a result of the melting, transition to a gas phase, burning and/or other deterioration of the threads 4400, the flame retardant fibers 3802 expand from the initial thickness to the expanded thickness TExp.

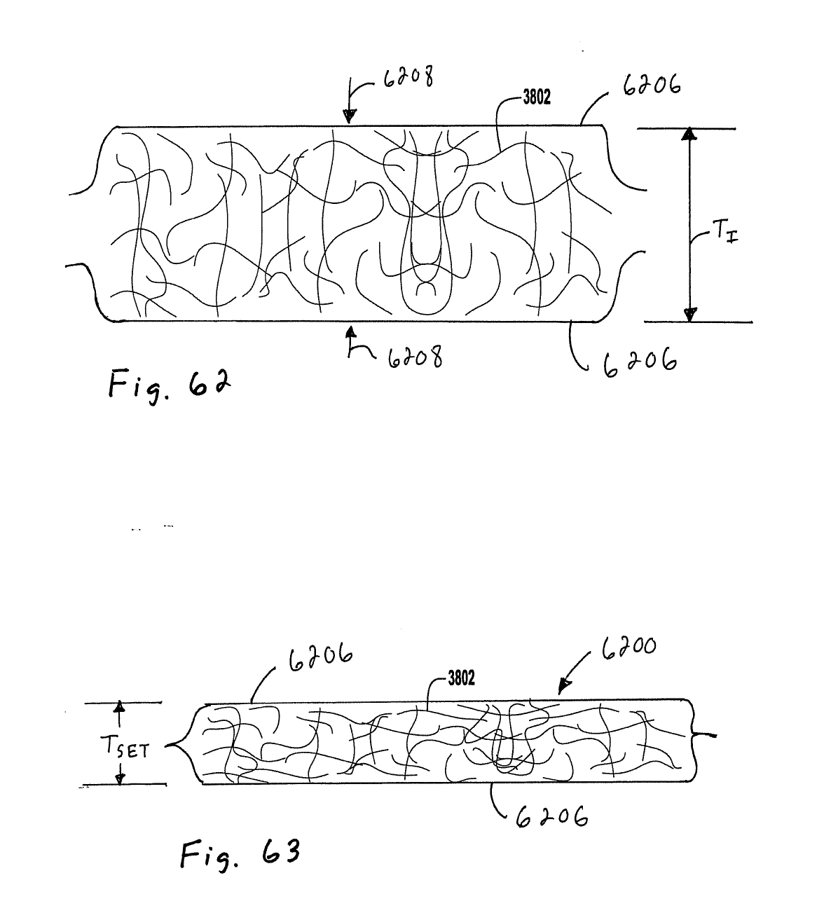

FIGS. 62 and 63 illustrate another exemplary embodiment of a material 6200 with properties that are similar to the fabric 3800. The material 6200 is configured to expand upon the application of a source 4000 of high heat. Referring to FIG. 62, flame retardant fibers 3802 may be deposited in a bag or between two layers 6206 of material at an initial thickness T₁. The bag or layers 6206 may be made from any of the materials that the binding fibers 3806 are made from. The bag or layers 6206 are compressed as indicated by arrows 6208, for example by applying a vacuum or pressing the layers together, to reduce the thickness from the initial thickness T₁ (FIG. 62) to the thickness T_{Set} (FIG. 63). While FIGS. 62 and 63 schematically illustrate a two layers 6206, any number, type, or configuration of layers of material or bags can be used to reduce the thickness from the initial thickness T₁ (FIG. 62) to the thickness T_{Set} (FIG. 63). Further, any combination of the manners of reducing the thickness from the initial thickness T₁ (FIG. 62) to the set thickness T_{Set} (FIG. 63) disclosed in this application can be used.

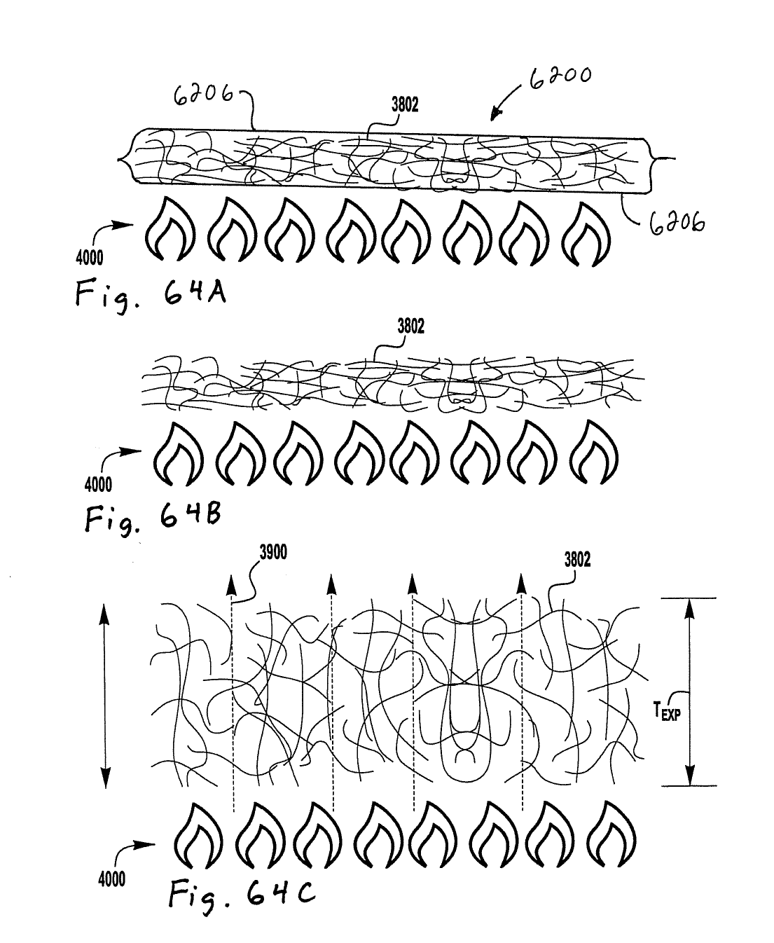

Referring to FIGS. 64A-64C, the properties of the flame retardant fibers 3802, the manner in which the flame retardant fibers are deposited between the layers 6206, and the amount of reduction from the initial thickness T₁ to the set thickness T_{Set} are selected such that when the layers 6206 deteriorate (for example, melt, transition to a gas phase, and/or burn), the flame retardant fibers 3802 expand from the set thickness T_{Set} by a factor of at least two to the expanded thickness T_{Exp}. In an exemplary embodiment, the expanded thickness T_{Exp} is closer to the initial thickness T₁ than the set thickness T_{Set}. In an exemplary embodiment, the expanded thickness T_{Exp}, is substantially the same as the thickness T₁. FIG. 64A schematically illustrates the application of a source of high heat 4000, such as a flame, to the material 6200. FIG. 64B illustrates that one or both of the layers 6206 melt, transition to a gas phase, or otherwise deteriorate. FIG. 64C illustrates that, as a result of the melting, transition to a gas phase, burning and/or other deterioration of the layers 6206, the flame retardant fibers 3802 expand from the initial thickness to the expanded thickness T_{Exp}.

In one exemplary embodiment, the concepts of the fabric illustrated by FIGS. 44 and 45 and the concepts of the material 6200 illustrated by FIGS. 62 and 63 are combined. For example, the flame retardant fibers 3802 may be deposited in a bag or between two layers 6206 of material at an initial thickness T₁. Then, the bag or layers 6206 may be compressed with stitches 4400 through the bag or layers 6206. The result is that the material 6200 is quilted, with the stitches 4400 both compressing the flame retardant fibers 3802 and holding the flame retardant fibers in place relative to the layers 6206. This material expands as described above when the stitches 4400 and/or layers 6206 melt, transition to a gas phase, burn and/or otherwise deteriorate as a result of exposure to a flame 4000.

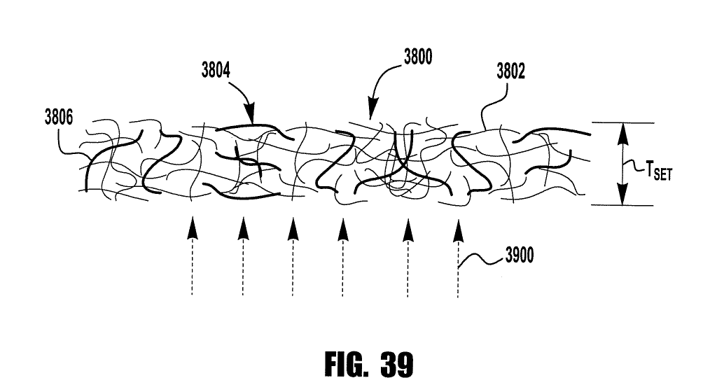

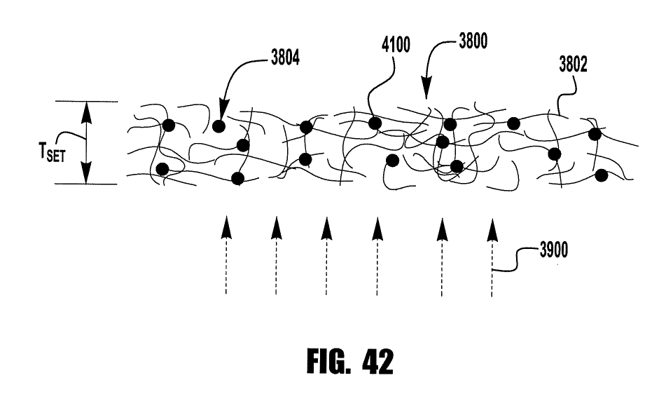

Comparing FIGS. 39 and 40C, comparing FIGS. 42 and 43C, comparing FIGS. 45 and 46C, and comparing FIGS. 63 and 64C, in one exemplary embodiment, the fabric 3800 or material 6200 is has a very high airflow resistance prior to the application of the flame, when the fabric is at the set thickness T_{Set}. In FIGS. 39, 42, 45, and 63 arrows 3900 represent airflow. The airflow 3900 is substantially blocked by the fabric prior to the application of the flame, when the fabric is at the set thickness T_{Set}.

The airflow resistance of the non-woven fabric decreases after the application of a 1000° F. flame, a 1500° F. flame, or a flame between 1000° F. and 1500° F. to cause the binding material or layers to degrade (for example, burn, offgas, and/or melt) and the flame retardant fibers to expand. The airflow resistance of the fabric 3800 is substantially reduced after the application of the flame and the expansion of the flame retardant fibers 3802. In FIGS. 40C, 43C, and 46C, arrows 3900 represent airflow. The airflow 3900 is substantially allowed to pass through the fabric after the application of the flame and the expansion of the flame retardant fibers 3802, when the fabric is at the expanded thickness T_{Exp}. In one exemplary embodiment, the airflow resistance of the fabric, after the application of the flame and the expansion of the flame retardant fibers 3802 to the expanded thickness TExp, is less than %, less than ⅔, less than ½, or less than ⅓ the airflow resistance of the fabric having the set thickness T_{Set} prior to the application of the flame.

The following table provides examples of fabrics that have a high airflow resistance prior to the application of the flame, when the fabric is at the set thickness T_{Set}, and a substantially reduced airflow resistance after the application of the flame and the expansion of the flame retardant fibers 3802 to the expanded thickness T_{Exp}. In each of the examples provided in Table 4, the material is made up of a 65/35 ratio of oxidized Polyacrylonitrile fibers to polyester bi-component fibers. The oxidized Polyacrylonitrile fibers and the polyester bi-component fibers are air laid at 12 mm loft, and then surface treated (i.e. compressed and heated) to form the fabric with the set thickness T_{Set}. Airflow resistance is the resistance to movement of air through the fabric 3800. The inverse of airflow resistance, i.e. airflow, is illustrated by Table 4. In the examples provided by Table 4, an air pressure of 0.5 inches of water is applied to a first side of the fabric 3800 and the air flow per unit area is measured on the opposite side of the fabric 3800. In the examples illustrated by Table 4, the airflow units are cubic feet per minute per square foot.

TABLE 4
Examples of Fabrics and Airflow Properties

| | | | | | Airflow |
|---|---|---|---|---|---|
| | | | Airflow | | Through |
| | | | Through | | Fabric After |
| | | | Fabric | | 500° F. |
| | | | Before | | Flame for |
| Sam- | | | Flame | | 30 Minutes |
| ple | | | (Fabric | | (Fabric at |
| No. | Weight | T_{Set} | at T_{Set}) | T_{Exp} | T_{Exp}) |
| 1 | 250 GSM | 1.6 mm | 182 CFM/ft² | 4.91 mm | 399 CEM/ft² |
| 2 | 250 GSM | 3.0 mm | 204 CFM/ft² | 7.125 mm | 425 CFM/ft² |
| 3 | 400 GSM | 4 mm | 167 CFM/ft² | 11.75 mm | 276 CFM/ft² |

As can be seen from the examples provided by Table 2, the airflow for samples 1 and 2 more than doubled. As such, samples 1 and 2 provide examples where the airflow resistance of the fabric, after the application of the flame and the expansion of the flame retardant fibers 3802 to the expanded thickness T_{Exp}, is less than ½, the airflow resistance of the fabric having the set thickness T_{Set} prior to the application of the flame. The airflow for sample 3 increased by more than 150%. As such, sample 3 provides an example where the airflow resistance of the fabric, after the application of the flame and the expansion of the flame retardant fibers 3802 to the expanded thickness T_{Exp} is less than ⅔, the airflow resistance of the fabric having the set thickness T_{Set} prior to the application of the flame. In an exemplary embodiment, the airflow through expanded fabric having the thickness T_{Exp} is greater than the airflow through the air laid material having thickness T₁. That is, the airflow resistance is lower for the expanded fabric having the thickness T_{Exp} than the air laid material having thickness T₁. This is due to the deterioration of the binding material 3804 in the expanded fabric due to the application of the heat source 500. For example, for sample numbers 1 and 2, the airflow through the corresponding air laid, 250 GSM, 12 mm thick (T₁) material is 335 cubic feet per minute per square foot (same testing air pressure of 0.5 inches of water), For sample number 3, the airflow through the corresponding air laid, 400 GSM, 12 mm thick (T₁) material is 199 cubic feet per minute per square foot (same testing air pressure of 0.5 inches of water).

In an exemplary embodiment, although the fabric 3800 or material 6200 expands to the thickness T_{Exp} and the airflow resistance through the fabric 3800 or material 6200 decreases, the flame retardant fibers 3802 are configured to preventing propagation of the flame through the expanded fabric. In addition, the flame retardant fibers 3802 are configured such that the thermal resistance across the thickness of the fabric 3800 increases as a result of the application of the flame and the expansion from the set thickness T_{Set} to the expanded thickness T_{Exp}. For example, the thermal resistance may increase as a factor of between 1.25 and 1.5, more than 1.5, more than 2, more than 2.5 or even more than 3.

The flame retardant fibers 3802 may take a wide variety of different forms. For example, the flame retardant fibers 3802 may be any fiber that does not burn when a high temperature flame is applied to the fiber. In one exemplary embodiment, the flame retardant fibers do not burn when a 1000° F. flame is applied to the fabric 3800. In one exemplary embodiment, the flame retardant fibers do not burn when a 1500° F. flame is applied to the fabric. In one exemplary embodiment, in addition to not burning, the flame retardant fibers 3803 can be exposed to a high temperature for a long duration before drawing of the fibers. This drawing refers to pulling back or shrinking of the fibers due to exposure to the high temperature. If the fiber draws back in response to the application of a flame, a hole could form in the fabric 3800, even though the fabric does not burn, and the flame could pass through the hole. In one exemplary embodiment, the flame retardant fibers 3802 can be exposed to a 1000° F. or higher temperature for several hours, such as eight or more hours, before drawing of the fibers. One type of fiber that does not draw when exposed to a high temperature for a long period of time is PAN fibers that have been oxidized, so that the PAN fiber will not burn. In one exemplary embodiment, the flame retardant fibers comprise oxidized Polyacrylonitrile (PAN) fibers and/or oxidized Polyacrylonitrile carbon fibers. The flame retardant fibers 3802 may also be made of or comprise other materials, including, but not limited to aramid, fire resistant polyester, fire retardant nylon, melamine fibers, and/or any other fire or heat resistant fiber disclosed in this application. In one exemplary embodiment, the flame retardant fibers 3802 comprise one or more of the materials listed in Table 1.

The binding material 3804, such as the binding fibers 3806, binding material 4100, and threads or stitches 4400, used in the embodiments described above can take a wide variety of different forms. For example, the binding material 3804 may be a self-extinguishing material, such as a self-extinguishing fibers. That is, the binding material 3804 melts, transitions to a gas phase, and/or burns when a high temperature flame is applied to the material. Further, if the self extinguishing binding material burns, the self extinguishing binding material 3804 does not continue to burn after the high temperature flame is removed. In one exemplary embodiment, the binding material preferably transitions to a gas phase and may partially burn and partially transition to a gas phase when a 600° F. flame is applied to the fabric 3800, but the binding material 3804 does not continue to burn (if a portion of the binding material burned) after the flame is removed. In one exemplary embodiment, the binding material preferably transitions to a gas phase and may partially burn and partially transition to a gas phase when a 1000° F. flame is applied to the fabric 3800, but the binding material 3804 does not continue to burn (if a portion of the binding material burned) after the flame is removed. In one exemplary embodiment, the binding material preferably transitions to a gas phase and may partially burn and partially transition to a gas phase when a 1500° F. flame is applied to the fabric 3800, but the binding material 3804 does not continue to burn (if a portion of the binding material burned) after the flame is removed. In one exemplary embodiment, the material 3804 is polyester or comprises polyester. For example, when the binding material 3804 is a binding fiber 3806 or a thread or stitch, the binding fibers or stitches may be or comprise polyester fibers, such as polyester bi-component fibers. In one exemplary embodiment, the binding material 3804, which may be a binding fiber 3806, softens at 200°-250° F., melts at about 450° F., and turns to a gas phase or off gasses when exposed to temperatures or flames at or above 650° F. In one exemplary embodiment, the binding material comprises one or more of the materials listed in Table 2.

The flame retardant fibers 3802 and the binding material 3804, such as the binding fibers 3806, binding material 4100, and threads or stitches 4400, may be combined in a variety of different of weight ratios. In one exemplary embodiment, a weight percentage of the flame retardant fibers 3802 is between 55% and 75% and the weight percentage of binding material is between 25% and 45% of the weight of the fabric. In one exemplary embodiment, the weight percentage of the flame retardant fibers is between 60% and 70% and the weight percentage of binding material is between 30% and 40% of the weight of the fabric. In one exemplary embodiment, the weight percentage of the flame retardant fibers is about 65% and the weight percentage of binding fibers is about 35% of the weight of the fabric.

In an exemplary embodiment, the fabric 3800 is formed in a manner that allows the fabric to return from the set thickness T_{Set} to the expanded thickness T_{EXP}. For example, fabric formation steps that result in mechanical setting or entanglement of the flame retardant fibers 3802 are avoided in an exemplary embodiment. For example, in one exemplary embodiment, the flame retardant fibers 3802 are not needled together during the production of the fabric 3800.

The fabric 3800 may be formed in a variety of different configurations. In an exemplary embodiment, the set thickness T_{Set} of the fabric is less than ½″ or 8 mm. In one exemplary embodiment, the T_{Set} thickness is between about 1 mm and about 6 mm. In one exemplary embodiment, the T_{Set} thickness is between about 4 mm and about 6 mm. In one exemplary embodiment, the T_{Set} thickness is less than 8 mm and a weight of the fabric is greater than 50 grams per square meter, such as between 50 and 100 grams per square meter, between 50 and 65 grams per square meter, or about 65 grams per square meter. In one exemplary embodiment, the T_{Set} thickness is between about 1 mm and about 6 mm and a weight of the fabric is greater than 50 grams per square meter, such as between 50 and 100 grams per square meter, between 50 and 65 grams per square meter, or about 65 grams per square meter. In one exemplary embodiment, the T_{Set} thickness is less than 8 mm and a weight of the fabric is greater than 200 grams per square meter. In one exemplary embodiment, the T_{Set} thickness is between about 1 mm and about 6 mm and a weight of the fabric is greater than 200 grams per square meter. In one exemplary embodiment, the T_{Set} thickness is between about 4 mm and about 6 mm and a weight of the fabric is greater than 200 grams per square meter. In one exemplary embodiment, the T_{Set} thickness is less than 8 mm and a weight of the fabric is between about 200 and about 800 grams per square meter. In one exemplary embodiment, the T_{Set} thickness is between about 1 mm and about 6 mm and a weight of the fabric is between about 200 and about 800 grams per square meter. In one exemplary embodiment, the T_{Set} thickness is between about 4 mm and about 6 mm and a weight of the fabric is between about 200 and about 800 grams per square meter. In one exemplary embodiment, the T_{Set} thickness is less than 8 mm and a weight of the fabric is about 250 grams per square meter. In one exemplary embodiment, the T_{Set} thickness is between about 1 mm and about 6 mm and a weight of the fabric is about 250 grams per square meter. In one exemplary embodiment, the T_{Set} thickness is between about 4 mm and about 6 mm and a weight of the fabric is about 250 grams per square meter. In one exemplary embodiment, the T_{Set} thickness is less than 8 mm and a weight of the fabric is about 400 grams per square meter. In one exemplary embodiment, the thickness T_{Set} is between about 1 mm and about 6 mm and a weight of the fabric is about 400 grams per square meter. In one exemplary embodiment, the T_{Set} thickness is between about 4 mm and about 6 mm and a weight of the fabric is about 400 grams per square meter.

In another exemplary embodiment, the set thickness T_{Set} of the fabric may be greater than ½″ or 8 mm. For example, the T_{Set} thickness may be between about 8 mm and about 12 mm. In one exemplary embodiment, the T_{Set} thickness is greater than 8 mm and a weight of the fabric is greater than 400 grams per square meter. In one exemplary embodiment, the thickness T_{Set} is between about 8 mm and about 12 mm and a weight of the fabric is about 400-800 grams per square meter.

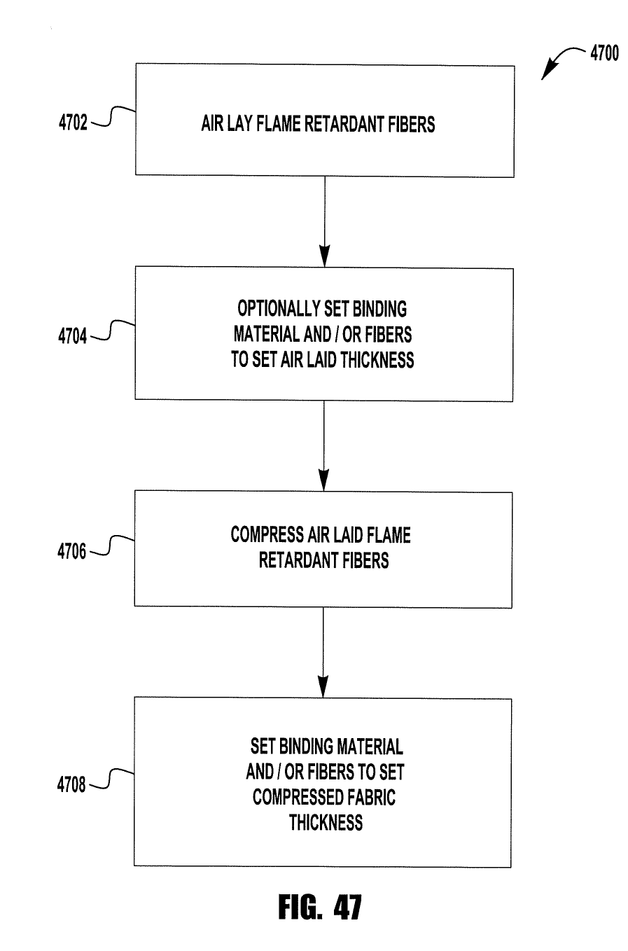

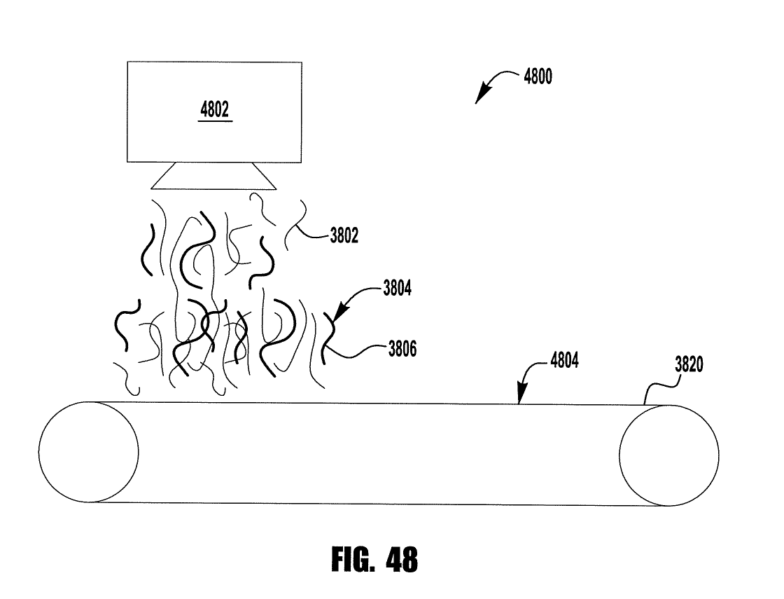

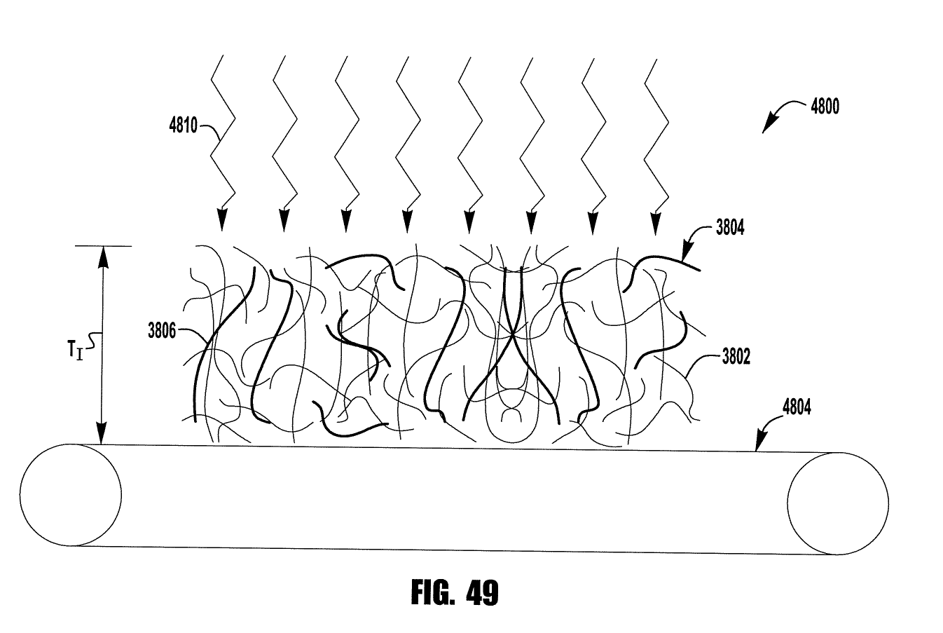

The fabric 3800 can be made in a wide variety of different ways. FIG. 47 is a flowchart that illustrates and exemplary embodiment of a method 4700 of making a non-woven fabric 3800. In the method 4700, flame retardant fibers 3800 are air laid 4702. The flame retardant fibers 3800 may be air laid with binding fibers 3806 or other binding material 4100 or the flame retardant fibers 3800 may be air laid by themselves and binding material 4100 or binding fibers 3806 may then be applied to the air laid flame retardant fibers 3802. Optionally, the binding material 3804, which may be a binding fiber 3806 or other material 4100, is set 4704 to set the initial thickness T₁ of the fabric. For example, the binding fibers 3806 or binding material 4100 may be applied in a hot, partially melted state and then allowed to set, to set the initial thickness T₁ of the fabric. In another embodiment, the optional setting step 4704 is omitted. The air laid flame retardant fibers are compressed 4706. In one exemplary embodiment, the air laid flame retardant fibers 3802 are heated as they are compressed. For example, the binding fibers 3806 or binding material 4100 may be melted or partially melted by applying heat as the air laid flame retardant fibers 3802 are compressed. In one exemplary embodiment, the air laid flame retardant fibers 3802 are not heated as they are compressed. For example, the binding fibers 3806 or binding material 4100 may already be melted or partially melted when the air laid flame retardant fibers 3802 are compressed. The binding fibers 3806 and/or the binding material 4100 are then set 4708 to set the thickness T_{Set} of the fabric 3800. The binding fibers 3806 and/or the binding material 4100 may be set in a variety of different ways. For example, the binding fibers 3806 and/or the binding material 4100 may be cooled to set the binding fibers 3806, the binding fibers 3806 and/or the binding material 4100 may be dried to set the binding fibers 3806 and/or the binding material 4100 and/or a chemical reaction may set the binding fibers 3806 and/or the binding material 4100. Once the binding fibers 3806 and/or the binding material 4100 is set, the fabric 3800 is complete and retains the set thickness T_{Set} when the fabric 3800 is removed from an apparatus that applied the compression.

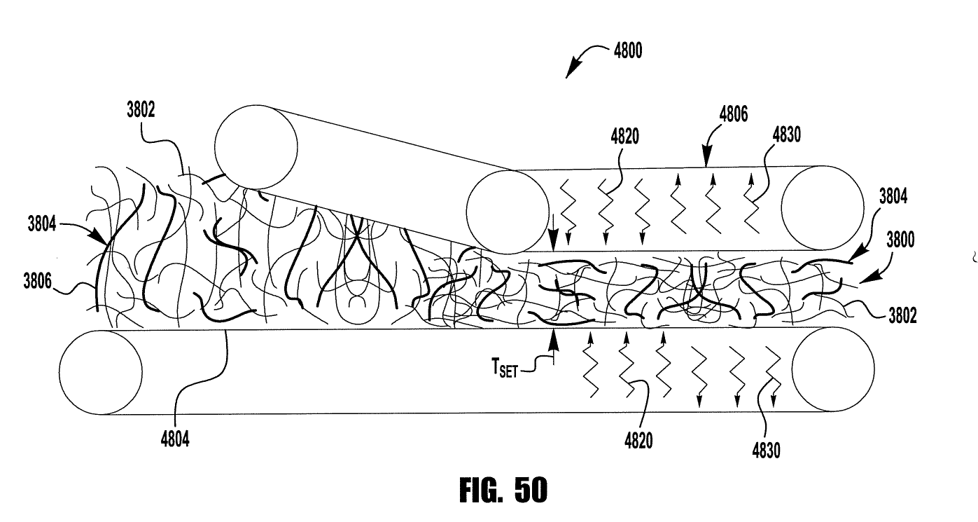

A variety of different apparatus may be used to make the fabric. FIGS. 48-50 illustrate one exemplary embodiment of an apparatus 4800 for making the fabric 3800. In the example illustrated by FIGS. 48-50, the apparatus 4800 includes one or more fiber dispensers 4802, a fiber collection belt 4804, and compression belts 4806. The one or more fiber dispensers 4802 deposits the flame retardant fibers 3802 and the binding fibers 3806 on the fiber collection belt 4804. For example, the one or more fiber dispensers 4802 may air lay the flame retardant fibers 3802 and the binding fibers 3806 on the fiber collection belt 4804 in a mixed fashion. The binding fibers 3806 may optionally be applied in a hot, melted or partially melted state or in a cooled, set state. Referring to FIG. 49, the flame retardant fibers 3802 and the binding fibers 3806 are deposited on the collection belt to the initial thickness T₁. Heat indicated by arrows 4810 may be applied to the flame retardant fibers 3802 and the binding fibers 3806 as the fiber collection belt 4804 transports the collected fibers to the compression belt. For example, the heat may be applied to keep the binding fibers 3806 in a melted or partially melted state or to melt or partially melt the binding fibers. Referring to FIG. 50, the compression belts 4806 compress the flame retardant fibers 3802 and the binding fibers 3806 from the initial thickness T₁ to the set thickness T_{Set}. In one exemplary embodiment, the fibers 3802, 3806 are heated as they are compressed as indicated by arrow 4820. For example, the binding fibers 3806 may be melted or partially melted by applying heat as the air laid flame retardant fibers 3802 are compressed. In one exemplary embodiment, the air laid flame retardant fibers 3802 are not heated as they are compressed. For example, the binding fibers 3806 may already be melted or partially melted when the air laid flame retardant fibers 3802 are compressed. In the exemplary embodiment, the fibers 3802, 3806 are also cooled while compressed by the compression belts 4806 as indicated by arrows 4830 to set the binding fibers 3806. Once the binding fibers 3806 are set, the fabric 3800 is transported out of the compression belts 3806 and retains the set thickness T_{Set}.

The fabric 3800 can be used in a wide variety of different applications. Examples of applications where the fabric can be used include, but are not limited to, preventing flame spread along wires, such as along wires in buildings, automobiles, and appliances, preventing flames from passing through openings in a wall, such as openings through which wires, ducts or conduits pass in a building wall, automobile panel or appliance panel, and insulating a wall from flames, such as a building wall, automobile panel, or an appliance panel, and containing flames in an enclosure, such as an electrical box of a building, a housing of an appliance, or a compartment of an automobile. The fabric 3800 may be used in a range hood or as a back panel of an appliance, such as a refrigerator.

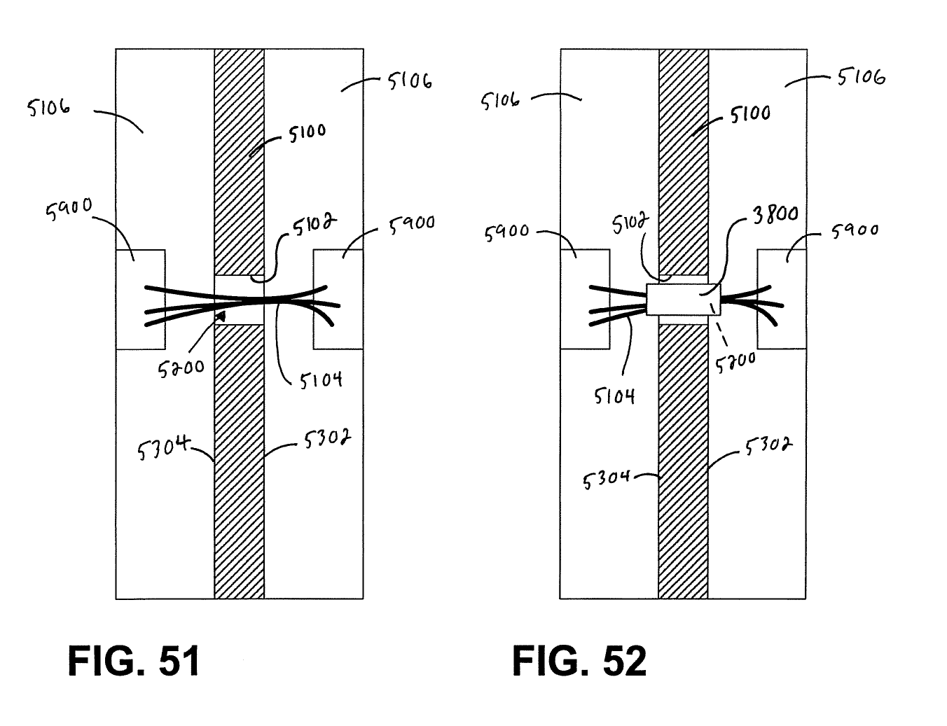

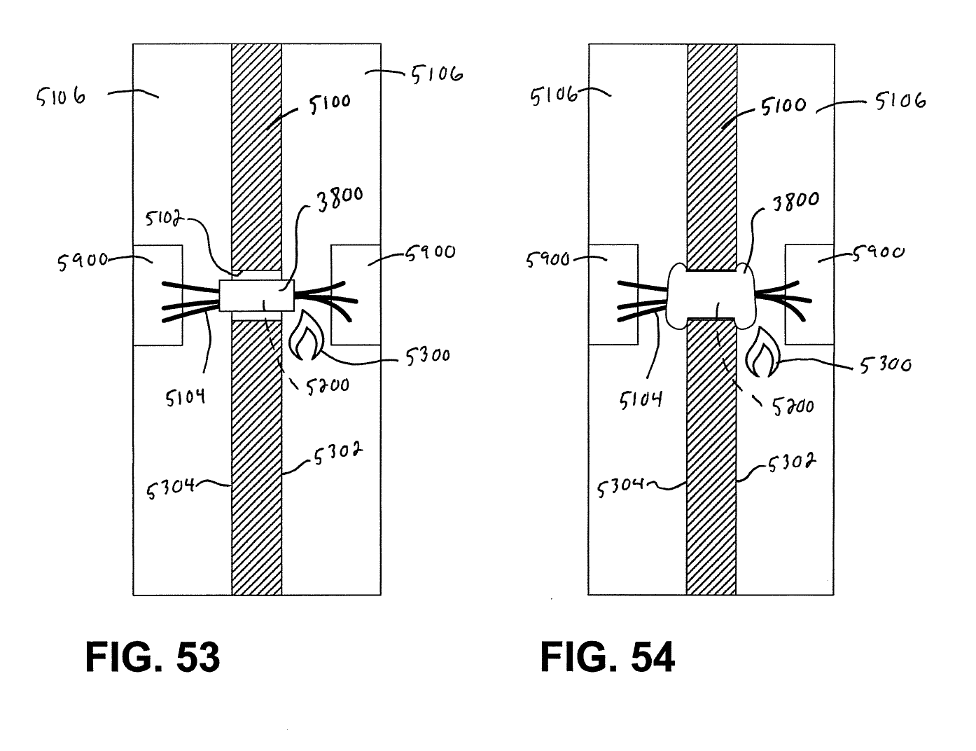

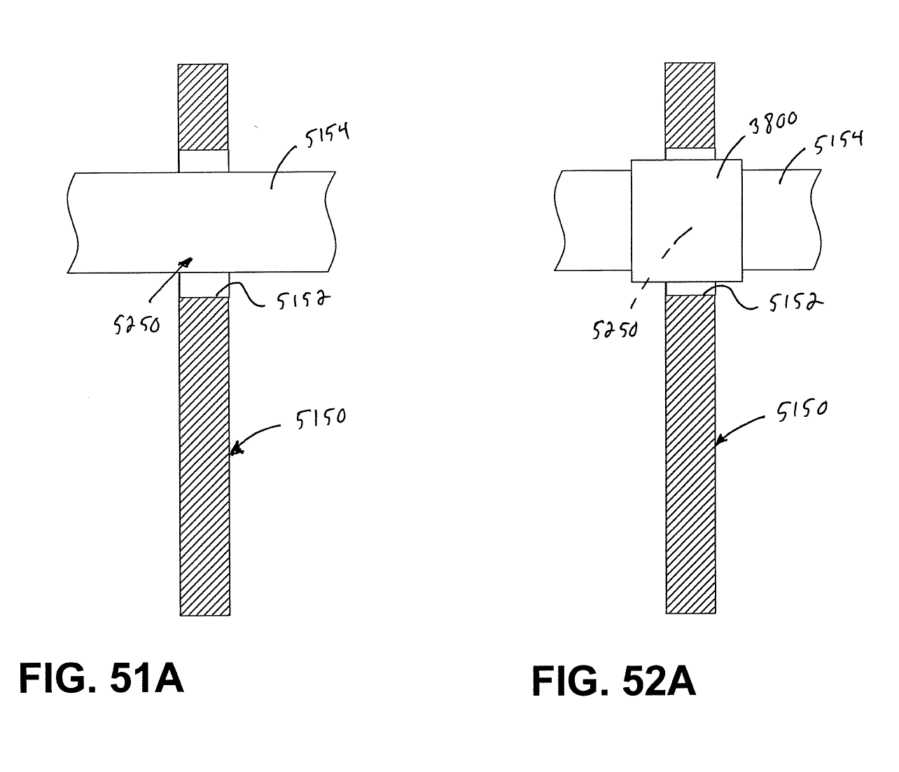

FIG. 51 schematically illustrates an example of a wall 5100 with a hole 5102 that wires 5104 pass through. In the example illustrated by FIG. 51, spaces 5106 are disposed on each side of the wall 5100 that the wires 5104 are disposed in. When the application is a building, the spaces 5106 may be space behind drywall or other paneling. For example, the wall 5100 may be a firewall between two apartments or between two rooms of a building and the spaces 5106 are areas behind interior drywall. The wires 5104 extend behind the drywall or other paneling to electrical boxes 5900, such as junction boxes, outlet boxes, and switch boxes. When the application is an appliance or an automobile, the wall 5100 may be a metal wall, such as a firewall. The wires in appliances and automobiles may extend between electrical devices, instead of between electrical boxes.

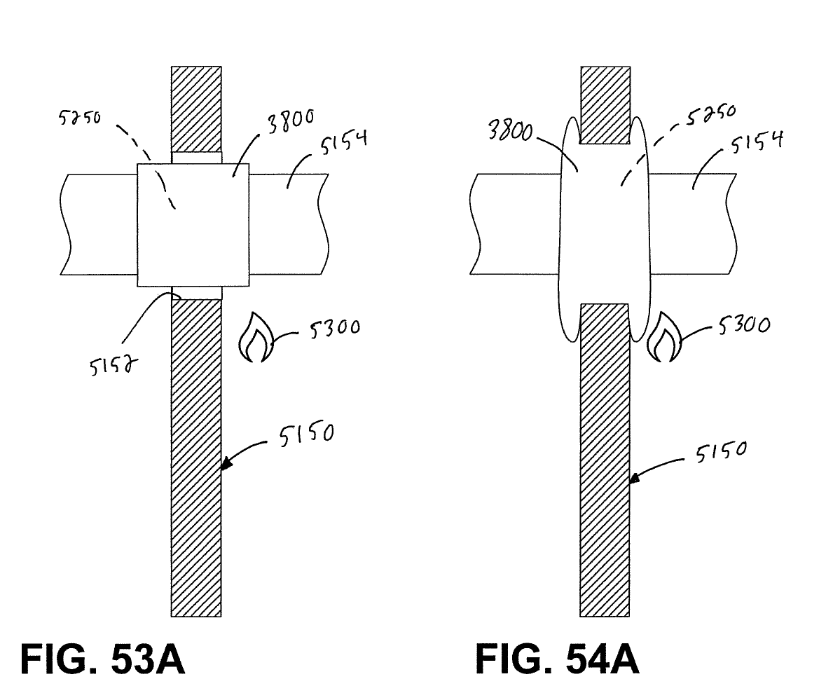

FIG. 52 illustrates an exemplary embodiment where a portion 5200 of the wires 5104 that are in the hole 5102 are wrapped or sleeved with the material 3800. FIGS. 53 and 54 illustrate a flame 5300 applied to the wires 5104 on one side 5302 of the wall 5100 or generally on the side 5302 of the wall 5100. The flame 5300 causes the material 3800 to expand, fill the hole 5102, and press against the wires 5104. This inhibits the flame 5300 from passing through the hole 5102 from the side 5302 to an other side 5304 of the wall 5100.

FIG. 51A schematically illustrates an example of a wall 5150 with a hole 5152 that a duct or other conduit 5154 passes through. In the example illustrated by FIG. 51A, the wall 5150 may be between two apartments or between two rooms of a building. When the application is an appliance or an automobile, the wall 5150 may be a metal wall, such as a firewall that a duct or other conduit passes through.

FIG. 52 illustrates an exemplary embodiment where a portion 5250 of the duct or conduit 5154 that is in the hole 5152 is wrapped or sleeved with the material 3800. FIGS. 53A and 54A illustrate a flame 5300 applied to one side 5352 of the wall 5150. The flame 5300 causes the material 3800 to expand, fill the hole 5152, and press against the duct or conduit 5154. This inhibits the flame 5300 from passing through the hole 5152 from the side 5352 to another side 5354 of the wall 5100.

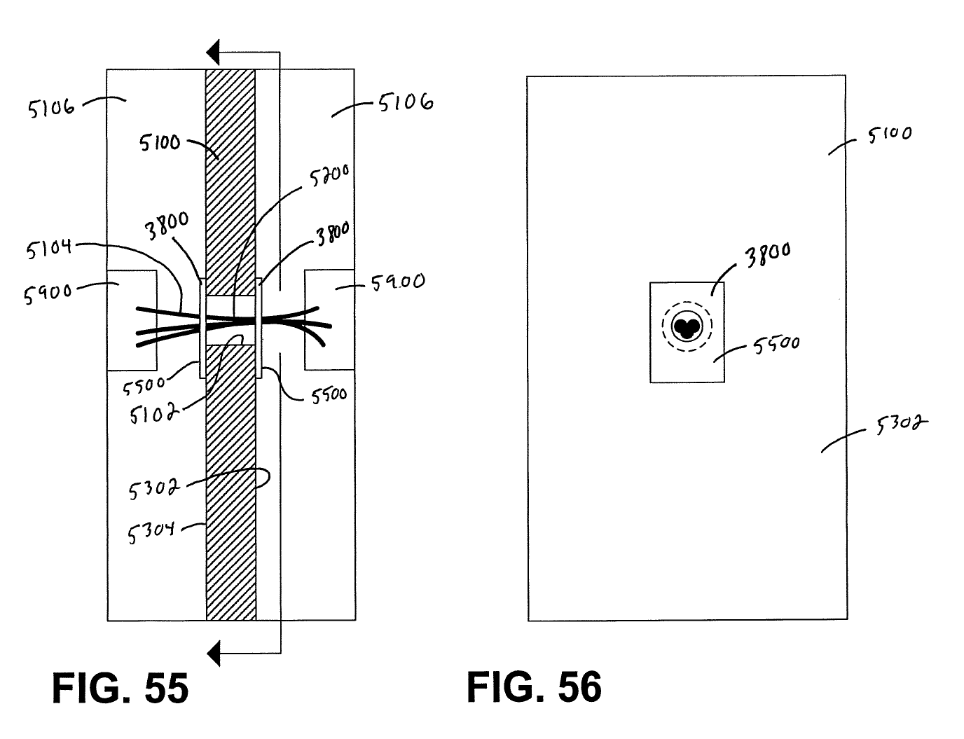

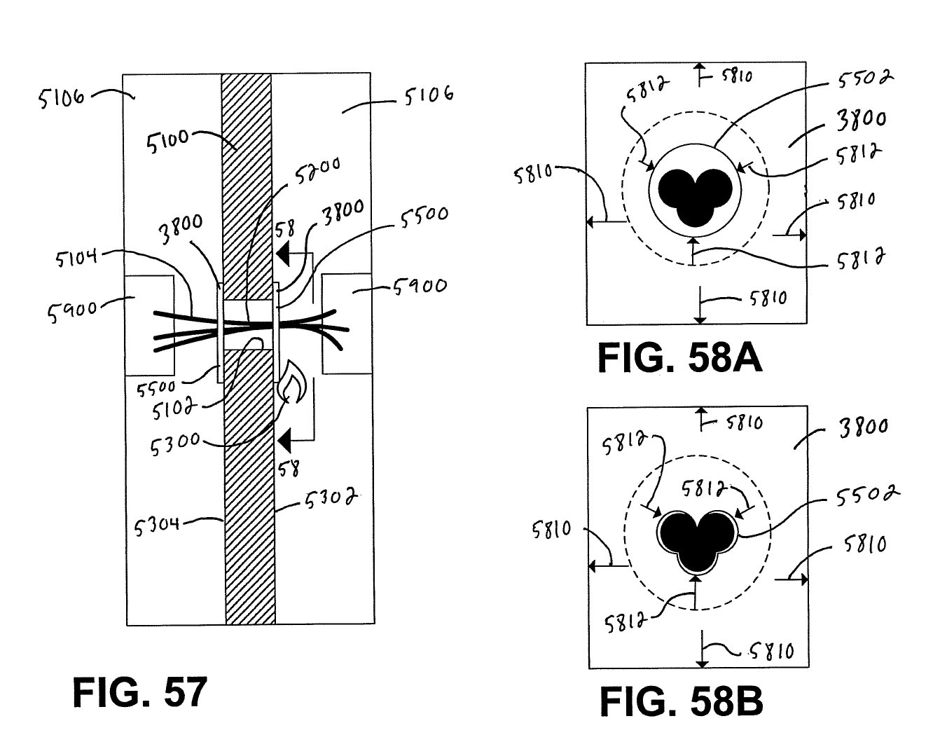

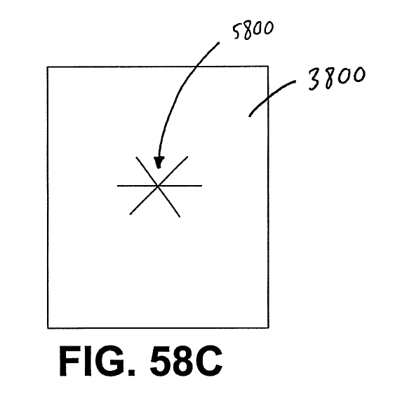

FIGS. 55 and 56 illustrate an exemplary embodiment of a pad 5500 or pads 5500 disposed on the wall 5100 over the hole 5102. In the example illustrated by FIG. 55, a pad 5500 is included on each side 5302, 5304 of the wall. However, in another exemplary embodiment, only one pad on one side of the wall is included. The wires 5104 pass through an opening 5502 in the pad(s) 5500. The opening 5502 may be a circular hole 5600 as illustrated by FIG. 56, a plurality of crossing cuts 5800 as illustrated by FIG. 58, a slit, or any other cut through the pad 5500 that allows passage of the wires 5104. Alternatively, the pad 5500 is not cut until the wires are installed through the pad. FIGS. 57, 58A, and 58B illustrate a flame 5300 applied to the wires 5104 on one side 5302 of the wall 5100 or generally on the side 5302 of the wall 5100. Referring to FIGS. 58A and 58B, the flame 5300 causes the material 3800 to expand (indicated by arrows 5810) and press (indicated by arrows 5812) against the wires 5104. This inhibits the flame 5300 from passing into the hole 5102.

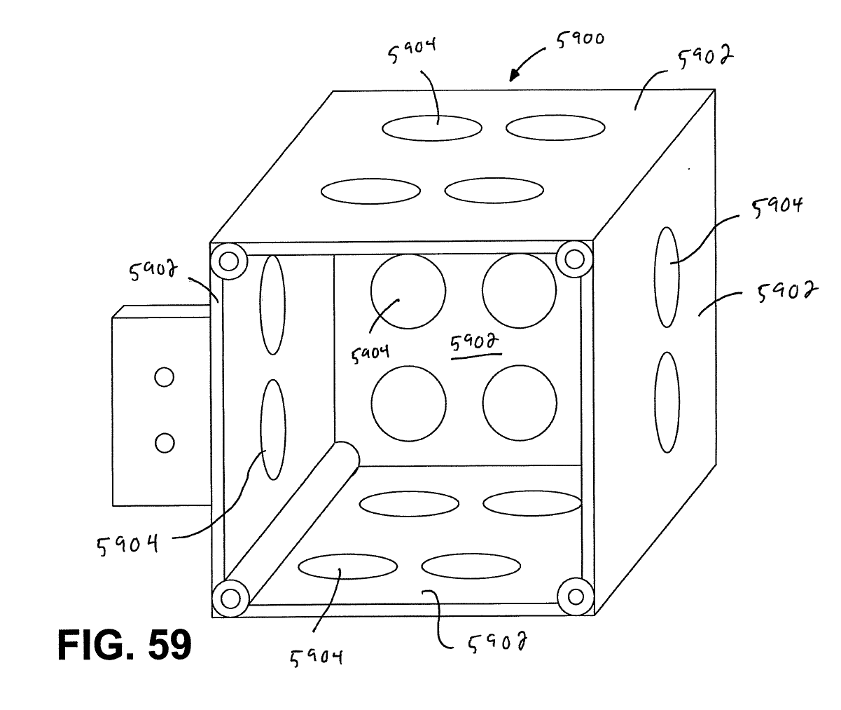

FIG. 59 illustrates an electrical box 5900. The electrical box includes walls 5902 with knockouts 5904 or partial knockouts that can be pushed in or out to provide openings that allow wires to be routed into the electrical box. Electrical boxes are well known in the art. Electrical boxes 5900 may be used as junction boxes where wires are connected, switch boxes where wires are connected to switches, outlet boxes where wires are connected to electrical outlets, and the like.

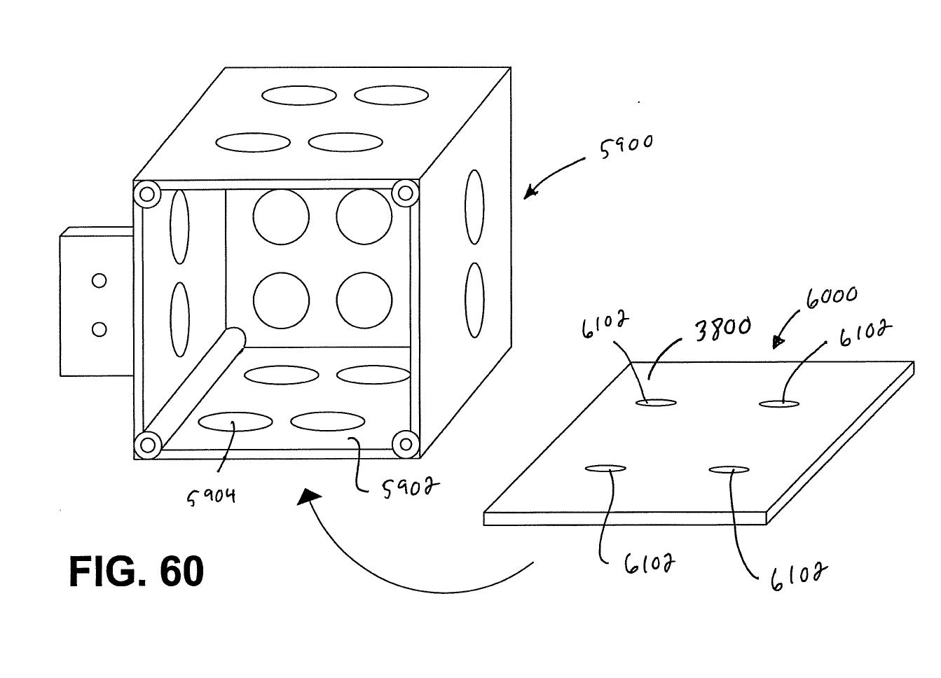

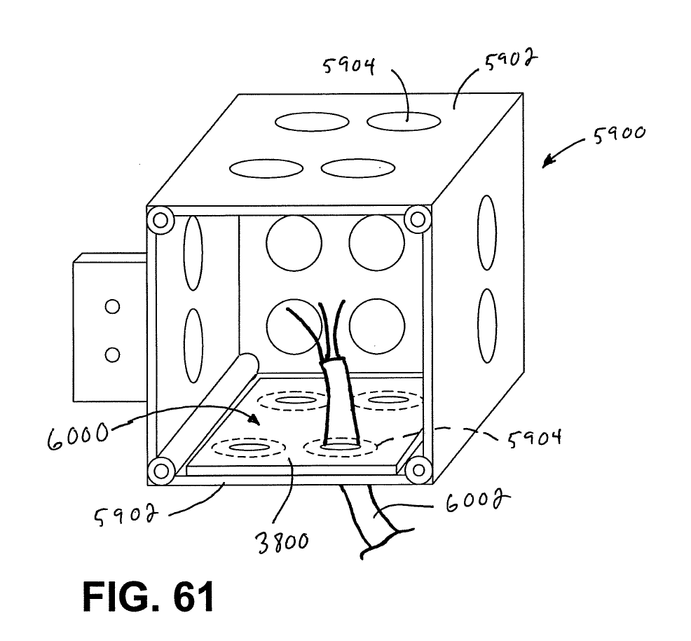

FIG. 60 illustrates one or more pads 6000 made of the flame resistant material being installed in the electrical box 5900. Referring to FIG. 61, the pad 6000 is disposed on one or more of the walls 5902 over one or more of the knockouts 5904. Referring to FIG. 62, a wire bundle 6002 passes through an opening 6102 in the pad 6000. The opening 6102 may be a circular hole as illustrated by FIG. 60, a plurality of crossing cuts 5800 as illustrated by FIG. 58, a slit, or any other cut through the pad 5500 that allows passage of the wires 5104. Further, the pads 5500, 600 may be cut to form the holes that the wires pass through when the pad and wiring is installed. A flame causes the material 3800 to expand and press against the wire bundle 6002 in the same manner as described with respect to FIGS. 58A and 58B. This inhibits a any flame in the electrical box 5900 from passing out of the box through the wiring hole.

In one exemplary embodiment, the fabric 3800 is installed in any of the applications described in this patent specification using an adhesive that is not fire resistant. In an exemplary embodiment, the non-fire resistant adhesive is applied to the fabric 3800 on the side of the fabric that faces away from an area where a flame could be present. Since the fabric expands when exposed to a flame, the temperature drop across the fabric (ΔT) is very high. As such, the non-fire resistant adhesive is exposed to a much lower temperature than the side of the fabric that is exposed to a flame. For example, a pressure sensitive adhesive (PSA) may burn at 400 degrees Fahrenheit. When the PSA is applied to one side of the fabric 3800 and the other side of the fabric is exposed to one of the flames and temperatures described herein, the PSA does not burn. This is because the temperature drop across the expanded material is high enough to drop the temperature that the PSA adhesive is exposed to below the burn temperature of the PSA.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions-such as alternative materials, structures, configurations, methods, circuits, devices and components, hardware, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

While the present invention has been illustrated by the description of embodiments thereof, and while the embodiments have been described in considerable detail, it is not the intention of the applicant to restrict or in any way limit the scope of the invention to such detail. Additional advantages and modifications will readily appear to those skilled in the art. For example, the specific locations of the component connections and interplacements can be modified. Therefore, the invention, in its broader aspects, is not limited to the specific details, the representative apparatus, and illustrative examples shown and described. Accordingly, departures can be made from such details without departing from the spirit or scope of the applicant's general inventive concept.

1-25. (canceled)

26. A clothes dryer comprising:
a bulkhead having a drum mounting surface;
a drum rotatably mounted to the bulkhead;
a seal member positioned between the drum and the bulkhead, wherein the seal member comprises:
a center layer that comprises flame retardant fibers and an intumescent material;
first and second outer layers disposed on opposite sides of the center layer,
wherein the first and second outer layers are made from polyester fibers
wherein the first outer layer contacts the bulkhead;
wherein the second outer layer contacts the drum;
wherein application of a 1000° F. flame to the seal member causes the polyester fibers of the first and second layers to degrade and the intumescent material to expand.

27. The clothes dryer of claim 26 wherein a thickness of said intumescent material increases by a factor of at least two.

28. The clothes dryer of claim 26 wherein application of a 1000° F. flame to the seal causes the polyester fibers of the first and second outer layers to transition to a gas state.

29. The clothes dryer of claim 26 wherein the flame retardant fibers do not burn when the 1000° F. flame is applied to the fabric.

30. The clothes dryer of claim 26 wherein the flame retardant fibers comprise oxidized Polyacrylonitrile fibers.

31. The clothes dryer of claim 26 wherein the flame retardant fibers are carbon fibers.

32. The clothes dryer of claim 26 wherein the bulkhead comprises a front bulkhead with a front drum mounting surface and the drum is disposed around the outside of the front drum mounting surface and wherein the seal member is positioned between the outside of the front drum mounting surface and an inside of the drum.

33. The clothes dryer of claim 26 wherein the bulkhead comprises a rear bulkhead with a rear drum mounting surface and the drum is disposed around the outside of the rear drum mounting surface and wherein the seal member is positioned between the outside of the rear drum mounting surface and an inside of the drum.

34. The clothes dryer of claim 26 wherein the first and second outer layers are formed by folding a single layer.

35. A clothes dryer comprising:
a bulkhead having a drum mounting surface;
a drum rotatably mounted to the bulkhead;
a seal member positioned between the drum and the bulkhead, wherein the seal member comprises:
a non-woven polyester fabric layer having a first side that is fixed to the drum; and
a second layer that is connected to a second side of the non-woven polyester fabric layer,
wherein the second layer includes:
flame retardant fibers;
intumescent material;
wherein application of a 1000° F. flame to the seal member causes the non-woven polyester fabric layer to degrade and the intumescent material to expand.

36. The clothes dryer of claim 35 wherein a thickness of said intumescent material increases by a factor of at least two 6.

37. The clothes dryer of claim 35 wherein application of a 1000° F. flame to the seal member causes the non-woven polyester fabric to transition to a gas state.

38. The clothes dryer of claim 35 wherein the flame retardant fibers do not burn when the 1000° F. flame is applied to the seal member.

39. The clothes dryer of claim 35 wherein the flame retardant fibers do not burn when a 1500° F. flame is applied to the seal member.

40. The clothes dryer of claim 35 wherein the flame retardant fibers comprise oxidized Polyacrylonitrile fibers.

41. The clothes dryer of claim 35 wherein the flame retardant fibers are carbon fibers.

42. The clothes dryer of claim 35 wherein non-woven polyester fabric layer has a loop that extends away from the second layer.

43. The clothes dryer of claim 42 wherein the loop extends radially inward behind a rear end of the drum.

44. The clothes dryer of claim 35 wherein the bulkhead comprises a front bulkhead with a front drum mounting surface and the drum is disposed around the outside of the front drum mounting surface and wherein the seal member is positioned between the outside of the front drum mounting surface and an inside of the drum.

45. The clothes dryer of claim 35 wherein the bulkhead comprises a rear bulkhead with a rear drum mounting surface and the drum is disposed around the outside of the rear drum mounting surface and wherein the seal member is positioned between the outside of the rear drum mounting surface and an inside of the drum.

46. A clothes dryer comprising:
a front bulkhead having a drum mounting surface;
a drum having a front end disposed around the drum mounting surface of the front bulkhead;
a seal member positioned between the front end of the drum and the drum mounting surface of the front bulkhead, wherein the seal member comprises:
a center layer that comprises flame retardant fibers and an intumescent material;
first and second outer layers disposed on opposite sides of the center layer,
wherein the second outer layer contacts the drum;
wherein application of a 1000° F. flame to the seal member causes the first and second outer layers to degrade and the intumescent material to expand by a factor of at least two.

47. The clothes dryer of claim 46 wherein application of a 1000° F. flame to the seal member causes the polyester fibers of the first and second outer layers to transition to a gas state.

48. The clothes dryer of claim 46 wherein the flame retardant fibers do not burn when the 1000° F. flame is applied to the fabric.

49. The clothes dryer of claim 46 wherein the flame retardant fibers comprise oxidized Polyacrylonitrile fibers.

50. The clothes dryer of claim 46 wherein the flame retardant fibers comprise carbon fibers.

51. A clothes dryer comprising:
a front bulkhead having a front drum mounting surface;
a rear bulkhead having a rear drum mounting surface;
a drum having a front end disposed around the front drum mounting surface and a rear end disposed around the rear drum mounting surface;
a front seal member positioned between the front end of the drum and the front bulkhead, wherein the front seal member comprises:
a center layer that comprises flame retardant fibers and an intumescent material;
first and second outer polyester fiber layers disposed on opposite sides of the center layer,
wherein the first outer layer contacts the bulkhead;
wherein the second outer layer contacts the drum;
wherein application of a 1000° F. flame to the front seal member causes the polyester fibers of the first and second layers to degrade and the intumescent material to expand;
a rear seal member positioned between the rear end of the drum and the rear bulkhead, wherein the rear seal member comprises:
a non-woven polyester fabric layer having a first side that is fixed to the drum; and
a second layer that comprises flame retardant fibers and intumescent material;
wherein the second layer of the rear seal member is connected to a second side of the non-woven polyester fabric layer,
wherein application of a 1000° F. flame to the seal member causes the non-woven polyester fabric layer to degrade and the intumescent material to expand.
